(19) United States
(12) Patent Application Publication
(10) Pub. No.: US 2003/0024132 A1
(43) Pub. Date: Feb. 6, 2003

(54) Cargo handling vehicle

(75) Inventors: Kazumasa Kokura, Osaka (JP); Tsutomu Fujita, Shiga (JP); Toshihiro Suzuki, Osaka (JP)

Correspondence Address: SUGHRUE, MION, ZINN, MACPEAK & SEAS, PLLC, 2100 Pennsylvania Avenue, N.W., Washington, DC, 20037, US

(73) Assignee: NIPPON YUSOKI CO., LTD.

(21) Appl. No.: 09/879,995

(22) Filed: Jun. 14, 2001

(30) Foreign Application Priority Data
Jun. 14, 2000 (JP) P. 2000-178336
Jul. 14, 2000 (JP) P. 2000-213626
Jul. 14, 2000 (JP) P. 2000-213627
Jul. 14, 2000 (JP) P. 2000-213628
Jul. 14, 2000 (JP) P. 2000-213629
Jul. 14, 2000 (JP) P. 2000-213630
Jul. 14, 2000 (JP) P. 2000-213631
Jul. 14, 2000 (JP) P. 2000-213754
Jul. 14, 2000 (JP) P. 2000-213755
Sep. 7, 2000 (JP) P. 2000-272111

(51) Int. Cl. G01B 5/14

(52) U.S. Cl. 33/712; 33/701

(57) ABSTRACT

A cargo handling vehicle comprises cargo carriers 21, a lift unit 1, a vehicle main body 24, and a running system 3, and the cargo handling vehicle further comprises a lift height detecting section 2 for detecting the vertical position of the cargo carriers 21, a traveling distance measuring section 4 for measuring a forward distance S1 covered by the vehicle main body 24 which starts its forward movement after the cargo carriers 21 are started to be raised and a rearward distance S2 covered by the vehicle main body 24 which starts its rearward movement after having completed its forward movement, and a movement control section 9 for prohibiting the lowering movement of the cargo carriers 21 until a rearward distance to be covered by the vehicle main body 24 which starts its rearward movement in a state in which the vertical position H2 of the raised cargo carriers 21 exceeds a preset reference height H1 becomes equal to or greater than the forward distance covered by the vehicle main body 24.

### BACKGROUND OF THE INVENTION

1. Field of the Invention

The present invention relates to a cargo handling vehicle such as a forklift truck.

2. Description of the Related Art

There are various forklift trucks used for a cargo handling vehicle. Giving a few examples, a counter balance forklift truck, a reach forklift truck, a picking forklift truck, etc. exist. A brief description of each forklift truck follows.

First, a counterbalance forklift truck will be described below. FIG. 4 shows a counterbalance forklift truck. The forklift truck of this type has a vehicle main body 24 having forks 21 as cargo carriers for carrying a cargo thereon and masts 22 as supporting masts for guiding rising and lowering movements of the forks 21 which are both disposed at forward positions of the vehicle main body 24 and a counterweight 23 which is disposed at a rearward position thereof. Then, hydraulic cylinders 25 are provided so as to erect along the masts 22 which support the forks 21 vertically movably, whereby the forks 21 are constructed so as to be raised and/or lowered by a lift unit (not shown) disposed on the vehicle main body 24 with the hydraulic cylinders 25 functioning as actuators.

In addition, a running motor 26 is installed in the vehicle main body 24, and the vehicle main body 24 itself or the forklift truck itself is constructed so as to be moved forward and backward along longitudinal directions and turned by a running system (not shown) using the running motor 26 as an actuator. Moreover, a controller 28 configured using a microcomputer is provided in the interior of an operator's instrument panel 27 disposed on the vehicle main body 24, and this controller 28 controls in a united fashion individual and coordinated operations between devices such as the lift unit and the running system.

In using a forklift truck of this type, cargoes are loaded and/or unloaded to and/or from shelves of a pallet rack (not shown) by raising the forks 21, and, for example, in unloading a cargo, the following procedure is executed: a cargo (not shown) set on a pallet is set on the forks 21 which are inserted in a rack shelf as the vehicle main body 24 moves forward, and thereafter, the forks 21 are moved rearward until they get out of the rack shelf as the vehicle main body 24 moves rearward, then the forks 21 being lowered.

Second, a reach forklift truck will be described below. FIG. 33 shows a reach forklift truck. In the reach forklift truck of this type, drive tires 802 and caster tires 803 are disposed at a rear portion of a vehicle body where an operator gets in, and a pair of straddle arms 804 horizontally extend forward from a front portion of the vehicle body 801, load tires 805 being disposed at distal end positions of the respective straddle arms 804. In addition, masts 808 for guiding rising and lowering (lift) movements of forks 807 are provided so as to erect at inner positions of the respective straddle arms 804.

Then, the forks 807 together with the masts 808 are raised and lowered by using as actuators hydraulic cylinders 810 provided so as to erect along the masts 808 for lifting, while the masts 808 are moved forward and rearward along the straddle arms 804 by using as actuators hydraulic cylinders 811 installed in the vehicle body 801 for reaching.

Furthermore, the forks 807 are tiltably mounted via a support shaft 813 on a lift bracket 812 provided on the masts 808 vertically movably, and the forks 807 are adapted to tilt by using as actuators hydraulic cylinders 814 fixed to the lift bracket 812 for tilting.

Additionally, a running motor 816 is disposed in the interior of the vehicle body 801, and the drive tires 802 are driven to rotate by the running motor 816, in association with which the vehicle body 801 is adapted not only to move forward and rearward but also to be turned.

Moreover, a controller 817 is installed in the vehicle body 801. This controller 817 is constituted by a microcomputer or the like and controls individual and coordinated movements of various types of devices in a united fashion.

A control panel 818 is secured in the vicinity of an operator's seat on which the operator is seated, and a plurality of operation levers 820 for operating the respective hydraulic cylinders 810, 811, 814 are disposed on the control panel 818.

For example, when unloading a cargo 806 set on a shelf of a rack 821 by using a reach forklift truck constructed as described above, first of all, the forks 807 are raised to the height of the cargo 806 by operating the operation levers 820, the cargo 806 is then picked up by the forks 807, the forks 807 are moved rearward together with the masts 808, and the forks 807 are lowered.

Third, a picking forklift truck which lifts up and down an operator's seat together with forks will be described. FIG. 40 shows a picking lift truck. The forklift truck 930 has an operator's stand on which an operator can ride and fork portions 901 for carrying a cargo thereon on a lift bracket 910 which is integrally raised and lowered or lifted up and down by a mast 903 provided on a vehicle main body 904. In addition, a pedal 908 and a lever 909 are provided on an control portion 907 provided so as to erect on a mast 903 side on the operator's stand 912, and additionally a head cover 905 is provided at an upper end of the lift bracket 910. A running motor (running device) is installed in the vehicle main body 904, so that the vehicle main body 904 is caused to move forward and rearward and turn by this running motor. In addition, individual and coordinated operations of the lift unit, the running device and the like are controlled in a united fashion by a controller constituted by a microcomputer disposed in the vehicle main body 904.

When these forklift trucks are used, a cargo set on a shelf of a rack being at a high position is loaded or unloaded after the forks are raised. When the cargo on the shelf of the rack at a high position is unloaded, it is necessary to move the forks rearward until the forks having a cargo are moved outside of the shelf of the rack.

Usually, the rack is mostly set in a dimly lit warehouse, it is remarkably difficult for the operator to visually confirm that the forks have completely got out of the shelf of the rack. Therefore, if the operator misunderstand that the forks are moved outside of the rack and lowers the forks, the forks may hit the rack to tilt largely, resulting in the cargo on the pallet falling to pieces.

Moreover, in case of the reach fork lift or counterbalance forklift truck, various members such as a lift bracket or backrests are interposed between the operator seated on the vehicle main body and the forks, which makes it difficult for the operator to visually confirm the rearward movement of the forks.

Moreover, even in case of the picking fork lift truck, a load mounted on the forks makes it difficult for the operators to confirm the ends of the forks by his or her eyes.

In particular, with the reach forklift truck in which the forks move forward and rearward relative to the vehicle body, there is caused a problem that the operator has difficulty in grasping by sense the positional relationship between the forks and the rack.

In addition, there is another problem that the operator mistakenly operates the forklift truck to lower the forks on the cargo or shelf of the rack, which results in breakage of the cargo or shelf of the rack. In particular, in the picking forklift truck, if the forks are lowered on the rack and the forks are moved rearward while the forks are being left riding on the rack, since the slack chains get tight immediately the forks are moved away from the cargo or the rack, there may be caused a risk that the operator's stand drops abruptly together with the forks, this causing in turn a problem with working properties of the forklift truck.

Moreover, in case of the picking forklift truck, since the operator's seat lifts up and down together with the forks, the operator's seat is inclined if the forks are inclined by collision with the rack, which might give rise to a possibility of falling the operator down from the operator's seat.

### SUMMARY OF THE INVENTION

The present invention has been made to consider the above problems. It is an object of the invention to provide a cargo handling vehicle such as a forklift truck which prevents the occurrence of a problem that when unloading a cargo using a forklift truck, the cargo falls to pieces when lowering forks of the forklift truck abruptly come into contact with a rack from which the forks are being removed by a misjudgment made by the operator.

Another object of the invention is to provide a cargo handling vehicle which can minimize the failure of cargoes or a rack even when cargo carriers (forks) in lowering movement ride on the cargoes or the rack and which can improve the safety as well as the working properties thereof.

According to the invention, there is provided a cargo handling vehicle comprising cargo carriers for carrying a cargo thereon, a lift unit for raising and/or lowering the cargo carriers along supporting masts, a vehicle main body on which the cargo carriers, the supporting masts and the lift unit are disposed, the cargo carriers and the supporting masts being disposed at forward positions thereon, and a running system disposed on the vehicle main body for moving the vehicle main body itself forward and backward, the cargo handling vehicle being characterized by further provision thereon of a lift height detecting section for detecting the vertical position of the cargo carriers, a traveling distance measuring section for measuring a forward distance covered by the vehicle main body which starts its forward movement after the cargo carriers are raised and a rearward distance covered by the vehicle main body which starts its rearward movement after the vehicle main body completes its forward movement, and a movement control section for prohibiting the lowering movement of the cargo carriers until a rearward distance to be covered by the vehicle main body which starts its rearward movement under a state in which the vertical position of the raised cargo carriers exceeds a preset reference position becomes equal to or greater than the forward distance covered by the vehicle main body.

According to the invention, there is provided a cargo handling vehicle as set forth in the first aspect of the invention, wherein the movement control section is adapted to permit the cargo carriers which are being at a vertical position which exceeds the preset reference position to be raised and lowered until the cargo carriers go beyond predetermined upper and lower allowable limits, respectively.

According to the invention, there is provided a cargo handling vehicle wherein the movement control section is adapted to stop the rearward movement of the vehicle main body at a point in time where a rearward distance which is being covered by the vehicle main body becomes equal to or greater than the forward distance which has already been covered by the vehicle main body.

According to the invention, there is provided a cargo handling vehicle wherein the movement control section is adapted to start the lowering movement of the cargo carriers at a point in time where a rearward distance which is being covered by the vehicle main body becomes equal to or greater than the forward distance which has already been covered by the vehicle main body.

According to the invention, there is provided a cargo handling vehicle, further comprising operation selecting section for selecting either the execution of operation of the movement control section or the prohibition of operation thereof.

According to the invention, there is provided a cargo handling vehicle, further comprising an information or alarm section for notifying the operating condition of the movement control section to the outside.

According to the invention, there is provided a cargo handling vehicle comprising cargo carriers for carrying a cargo thereon, a lift unit for raising and/or lowering the cargo carriers along supporting masts, a vehicle main body on which the cargo carriers, the supporting masts and the lift unit are disposed, the cargo carriers and the supporting masts being disposed at forward positions thereon, and a running system disposed on the vehicle main body for moving the vehicle main body itself forward and backward, the cargo handling vehicle being characterized by further provision thereon of a traveling distance measuring section for measuring a forward distance covered by the vehicle main body which starts its forward movement after the cargo carriers are raised and a rearward distance covered by the vehicle main body which starts its rearward movement after the vehicle main body completes its forward movement, a measurement execution designating section for designating the execution of measurement of forward and reward distances, and a movement control section for prohibiting the lowering movement of the cargo carriers until a rearward distance to be covered by the vehicle main body which starts its rearward movement becomes equal to or greater than the forward distance covered by the vehicle main body.

According to the invention, there is provided a cargo handling vehicle, further comprising a lift height detecting section for detecting the vertical position of the cargo carriers, and wherein the movement control section is adapted to permit the cargo carriers which are being at a vertical position which exceeds a preset reference position to be raised and lowered until the cargo carriers go beyond preset upper and lower allowable limits, respectively.

According to the invention, there is provided a cargo handling vehicle, wherein the movement control section is adapted to stop the rearward movement of the vehicle main body at a point in time where a rearward distance which is being covered by the vehicle main body becomes equal to or greater than the forward distance which has already been covered by the vehicle main body.

According to the invention, there is provided a cargo handling vehicle, wherein the movement control section is adapted to start the lowering movement of the cargo carriers at a point in time where a rearward distance which is being covered by the vehicle main body becomes equal to or greater than the forward distance which has already been covered by the vehicle main body.

According to the invention, there is provided a cargo handling vehicle, further comprising control canceling section for canceling the control by the movement control section to prohibit the lowering movement of the cargo carriers.

According to the invention, there is provided a cargo handling vehicle, further comprising information or alarm section for notifying the operating condition of the movement control section to the outside.

According to the invention, there is provided a cargo handling vehicle in which a lift unit for raising and/or lowering cargo carriers for carrying a cargo thereon along supporting masts is disposed on a vehicle main body and in which a running system for moving the vehicle main body forward and backward is provided on the vehicle main body, said cargo handling vehicle comprising a cargo detecting section for detecting the existence of a cargo on the cargo carriers, a lift height detecting section for detecting the vertical position of the cargo carriers, a traveling distance measuring section for measuring individually a forward distance covered by the vehicle main body and a rearward distance covered by the vehicle main body after the vehicle main body has completed its forward movement, and a movement control section for prohibiting the lowering movement of the cargo carriers until a rearward distance of the vehicle main body to be detected by the traveling distance measuring section becomes equal to or greater than the forward distance covered by the vehicle main body in a state in which the vertical position of the cargo carriers detected by the lift height detecting section exceeds a preset reference value and in which the existence of a cargo on the cargo carriers is detected by the cargo detecting section.

According to the invention, there is provided a cargo handling vehicle, wherein the movement control section permits the lift unit to raise and/or lower said cargo carriers only within preset upper and lower allowable limits in the event that the height of the cargo carriers detected by the lift height detecting section exceeds a reference position.

According to the invention, there is provided a cargo handling vehicle, wherein the movement control section is adapted to stop the rearward movement of the vehicle main body in the event that a rearward distance which is being covered by the vehicle main body becomes equal to or greater than the forward distance which has already been covered by the vehicle main body.

According to the invention, there is provided a cargo handling vehicle, wherein the movement control section is adapted to automatically start the lowering movement of the cargo carriers in the event that a rearward distance which is being covered by the vehicle main body becomes equal to or greater than the forward distance which has already been covered by the vehicle main body.

According to the invention, there is provided a cargo handling vehicle, further comprising operation selecting section for selecting either the execution of operation of the movement control section or the prohibition of operation thereof.

According to, there is provided a cargo handling vehicle, further comprising information or alarm section for notifying the operating condition of the movement control section to the outside.

According to the invention, there is provided a cargo handling vehicle comprising cargo carriers for carrying a cargo thereon, a lift unit for raising and/or lowering the cargo carriers, a vehicle main body on which the cargo carriers and the lift unit are disposed, and a running system for moving the vehicle main body itself forward and backward, the cargo handling vehicle being characterized by further provision thereon of a lift height detecting section for detecting the vertical position of the cargo carriers, traveling distance measuring section for measuring a rearward distance covered by the vehicle main body adapted to start to move forward after the cargo carriers is raised to a vertical position which is beyond a preset reference position and then start to move rearward after the cargo carriers is raised and lowered within preset upper and lower allowable limits, and movement control section for prohibiting the lowering movement of the cargo carriers until a rearward distance to be covered by the vehicle main body which is moving rearward becomes equal to or greater than a forward distance which has been covered by the vehicle main body.

According to the invention, there is provided a cargo handling vehicle, wherein the movement control section is adapted to stop the rearward movement of the vehicle main body at a point in time where a rearward distance which is being covered by the vehicle main body becomes equal to or greater than the forward distance which has already been covered by the vehicle main body.

According to the invention, there is provided a cargo handling vehicle, wherein the movement control section is adapted to start the lowering movement of the cargo carriers at a point in time where a rearward distance which is being covered by the vehicle main body becomes equal to or greater than the forward distance which has already been covered by the vehicle main body.

According to the invention, there is provided a cargo handling vehicle, further comprising an operation selecting section for selecting either the execution of operation of the movement control section or the prohibition of operation thereof.

According to the invention, there is provided a cargo handling vehicle, further comprising an information or alarm section for notifying the operating condition of the movement control section to the outside.

According to the invention, there is provided a cargo handling vehicle comprising cargo carriers for carrying a cargo thereon, a lift unit for raising and/or lowering the cargo carriers, a vehicle main body on which the cargo carriers and the lift unit are disposed, and a running system disposed on the vehicle main body for moving the vehicle main body itself forward and backward, the cargo handling vehicle being characterized by further provision thereon of a traveling distance measuring section for measuring a rearward distance covered by the vehicle main body, a movement control section for prohibiting the lowering movement of the cargo carriers until a rearward distance to be covered by the vehicle main body exceeds a set distance which is set by adding a surplus distance to the full length of the cargo carriers, and a control execution designating section for designating the execution of the control by the movement control section.

According to the invention, there is provided a cargo handling vehicle, wherein the control execution designating section is adapted to designate the execution of the control by the movement control section at a point in time where the vehicle main body starts to move rearward with the cargo carriers being raised to a certain height or a height higher than the certain height.

According to the invention, there is provided a cargo handling vehicle, wherein the movement control section is adapted to stop the rearward movement of the vehicle main body at a point in time where a rearward distance which is covered by the vehicle main body exceeds the set distance.

According to the invention, there is provided a cargo handling vehicle, further comprising information or alarm section for notifying a status in which the control by the movement control section is executed to the outside.

According to the invention, there is provided a cargo handling vehicle comprising cargo carriers for carrying a cargo thereon, a lift unit for raising and/or lowering the cargo carriers, a vehicle main body on which the cargo carriers and the lift unit are disposed, and a running system disposed on the vehicle main body for moving the vehicle main body itself forward and backward, the cargo handling vehicle being characterized by further provision thereon of a vehicle body movement starting section for starting the forward movement or rearward movement of the vehicle main body, a traveling distance measuring section for measuring a forward distance and a rearward distance covered by the vehicle main body, a movement control section for prohibiting the lowering movement of the cargo carriers until a rearward distance to be covered by the vehicle main body exceeds a set distance which is set by adding a surplus distance to the full length of the cargo carriers and stopping the rearward movement of the vehicle main body at a point in time where the rearward distance covered by the vehicle main body exceeds the set distance, and a control execution designating section for designating the execution of the control by the movement control section.

According to the invention, there is provided a cargo handling vehicle, wherein the control execution designating section is adapted to designate the execution of the control by the movement control section at a point in time where the vehicle main body starts to move rearward with the cargo carriers being raised to a certain height or a height higher than the certain height.

According to the invention, there is provided a cargo handling vehicle, further comprising an information or alarm section for notifying a status in which the control by the movement control section is executed to the outside.

According to the invention, there is provided a cargo handling vehicle comprising cargo carriers for carrying a cargo thereon, a lift unit for raising and/or lowering said cargo carriers, a vehicle main body on which the cargo carriers and the lift unit are disposed, and a running system disposed on the vehicle main body for moving the vehicle main body itself forward and backward, the cargo handling vehicle being characterized by further provision thereon of a lowering movement designating section for designating the lowering movement of the cargo carriers, a traveling distance measuring section for measuring a rearward distance covered by the vehicle main body, a movement control section for prohibiting the lowering movement of the cargo carriers until a rearward distance to be covered by the vehicle main body exceeds a set distance which is set by adding a surplus distance to the full length of the cargo carriers and executing a control to lower the cargo carriers at a point in time where the rearward distance covered by the vehicle main body exceeds the set distance, and a control execution designating section for designating the execution of the control by the movement control section.

According to the invention, there is provided a cargo handling vehicle, wherein the control execution designating section is adapted to designate the execution of the control by the movement control section at a point in time where the vehicle main body starts to move rearward with the cargo carriers being raised to a certain height or a height higher than the certain height.

According to the invention, there is provided a cargo handling vehicle, wherein the movement control section stops the rearward movement of the vehicle main body at a point in time where the rearward distance covered by the vehicle main body exceeds the set distance.

According to the invention, there is provided a cargo handling vehicle, further comprising information or alarm section for notifying a status in which the control by said movement control section is executed to the outside.

According to the invention, there is provided a reach forklift truck comprising forks adapted to be raised and/or lowered while being guided by masts, a lift unit for raising and/or lowering the forks and a reach unit for moving forward and rearward the forks and the masts along straddle arms, the reach forklift truck being characterized by provision of a fork rearward distance calculating section for calculating a rearward distance of the forks and the masts, a control operation executing section for executing control to prohibit the lowering movement of the forks until a calculated rearward distance of the forks and the masts exceeds a set distance set by adding the overall length of the forks and an extra distance, and control execution designating section for designating the execution of control by the control operation executing section.

According to the invention, there is provided a reach forklift truck comprising forks adapted to be raised and/or lowered while being guided by masts, a lift unit for raising and/or lowering the forks, straddle arms for guiding forward and rearward movements of the masts, a reach unit for moving forward and rearward the forks and the masts and a running system for moving forward and rearward a vehicle body, the reach forklift truck being characterized by provision of a fork rearward distance calculating section for calculating a rearward distance of the forks and the masts, vehicle body rearward distance calculating section for calculating a rearward distance of the vehicle body, control operation executing section for executing control to prohibit the lowering movement of the forks until a total rearward distance calculated by adding a rearward distance of the forks and the masts and a rearward distance of the vehicle body exceeds a set distance set by adding the overall length of the forks and an extra distance, and control execution designating section for designating the execution of control by the control operation executing section.

According to the invention, there is provided a reach forklift truck, wherein the control execution designating section is adapted to designate the execution of control to prohibit the lowering movement of the forks at a point in time where the forks located at a vertical position which is as high as or higher than a predetermined height start to move rearward together with the masts.

According to the invention, there is provided a reach forklift truck, wherein the control operation executing section is adapted to start lowering the forks at a point in time where a rearward distance of the forks and the masts exceeds the set distance set by adding the overall length of the forks and an extra distance.

According to the invention, there is provided a reach forklift truck, wherein the control operation executing section is adapted to start lowering the forks at a point in time where a rearward distance of the forks and the masts exceeds a total rearward distance calculated by adding a rearward distance of the forks and the masts and a rearward distance of the vehicle body exceeds the set distance set by adding the overall length of the forks and an extra distance.

According to the invention, there is provided a reach forklift truck, wherein the control operation executing section is adapted to stop the operation of the reach unit at a point in time where a rearward distance of the forks and the masts exceeds the set distance set by adding the overall length of the forks and an extra distance.

According to the invention, there is provided a reach forklift truck, wherein the control operation executing section is adapted to stop the operations of the reach unit and the running system at a point in time where a rearward distance of the forks and the masts exceeds a total rearward distance calculated by adding a rearward distance of the forks and the masts and a rearward distance of the vehicle body exceeds the set distance set by adding the overall length of the forks and an extra distance.

According to the invention, there is provided a forklift truck in which forks for carrying a cargo thereon and a lift unit for driving the forks to raise and/or lower the forks along masts are provided on a vehicle body, the forklift truck comprising a lowering movement detecting section for detecting whether or not the lowering movement of the forks is being performed properly by the lift unit, and a lowering prohibiting section for prohibiting the lowering movement of the forks by the lift unit when the lowering movement detecting section detects that the lowering movement of the forks is not being performed properly.

According to the invention, there is provided a forklift truck, wherein the forks are suspended from upper ends of the masts with chains, and wherein the lowering movement detecting section comprises a slack detecting section for detecting the slack of the chains, whereby the lowering movement of the forks by the lift unit is prohibited when the slack detecting section detects the slack of the chains.

According to the invention, there is provided a forklift truck, wherein the forks are titably supported on the vehicle body, wherein the lowering movement detecting section comprises a tilt detecting section for detecting the tilt of the forks, and wherein the lowering prohibiting section prohibits the lowering movement of the forks by the lift unit when the tilt detecting section detects that the forks tilt through a predetermined angle or greater.

According to the invention, there is provided a forklift truck the invention, further comprising a tilt driving section for tilt driving the forks relative to the vehicle body, wherein the lowering movement of the forks by the lift unit is prohibited when the tilt detecting section detects the tilt of the forks which results from any other cause than the action of the tilt driving section.

According to the invention, there is provided a forklift truck, further comprising a lift height detecting section for detecting the raised and lowered heights of the forks raised and lowered by the lift unit, wherein the lowering prohibiting section prohibits the forks from being lowered on condition that the raised and lowered heights of the forks detected by the lift height detecting section are equal to or greater than predetermined values.

According to the invention, there is provided a forklift truck, further comprising a vehicle body stopping section for stopping the vehicle body from moving forward and rearward in the event that the tilt detecting section detects that the forks tilt through a predetermined angle or greater.

According to the invention, there is provided a forklift truck, further comprising an information section for informing that further lowering of the forks causes a dangerous state in the event that the tilt detecting section detects that the forks tilt through a predetermined angle or greater.

According to the invention, there is provided a forklift truck, further comprising a manually operable lowering prohibition canceling switch for canceling the lowering prohibiting function of the lowering prohibiting section.

According to the invention, there is provided a cargo handling vehicle comprising a lift bracket comprising in turn cargo carriers, a lift unit for raising and/or lowering the lift bracket, a vehicle main body having the lift bracket and the lift unit installed thereon, and a running system for running the vehicle main body, the cargo handling vehicle being characterized by provision of, a sensor for detecting the application of an upward force which is as great as or greater than a predetermined magnitude to the cargo carrier, wherein when the sensor detects the application of an upward force which is as great as or greater than a predetermined magnitude to the cargo carrier, at least the lift bracket is prohibited from lowering.

In the invention, when the cargo carriers happen to ride on a rack or a cargo due to a mistake in operation while the lift bracket is being lowered, whereby an upward force which is as great as or greater than a predetermined magnitude is applied to the cargo carriers, the sensors detect the application of the force to the cargo carriers, and a movement control section prohibit the lift bracket from lowering further. Namely, a safety operation works. Consequently, the lowering of the cargo carriers is automatically stopped so that the failure of the rack or the cargo is minimized.

In addition, the running movement of the vehicle main body can be prohibited as required. Namely, in the event that the vehicle main body is run with the cargo carriers riding on the rack or the cargo, there may be caused a risk that the rack or the cargo is caused to fail further or that the cargo carriers abruptly drop immediately the cargo carriers are separated from the rack or the cargo. However, since the running movement of the vehicle main body is prohibited at a stage where the cargo carriers ride on the rack or the cargo, the aforesaid risk can be avoided, this allowing for safe work.

Additionally, in order to cancel the prohibition of the lowering movement or even the running movement, the state may only have to be eliminated in which the cargo carries are riding on the rack or the cargo, and for example, the lift bracket is raised or lifted up from the position which causes that state to occur so as to remove the upward force applied to the cargo carriers. Then, as this occurs, the sensors detect the removal of the force, and the movement control section cancels the prohibition of the lowering movement of the lift bracket, as well as the running movement of the vehicle main body in response to signals outputted from the sensors. The cancellation of the prohibition of those movements may of course be manually effected but a control program may be installed for automatic cancellation.

According to the invention, there is provided a cargo handling vehicle, wherein the cargo carriers are mounted on the lift bracket in such a manner as to be lifted up by a minute amount relative to the lift bracket, and wherein when the cargo carrier is lifted up by a minute amount relative to the lift bracket, the sensor determines that an upward force which is as great as or greater than a predetermined magnitude is applied to the cargo carrier.

In the invention, when the cargo carriers are lifted up against the deadweights thereof, it is designed to be determined that the cargo carriers ride on a rack or a cargo. Consequently, with a simple construction in which the cargo carriers are mounted on the lift bracket in such a manner as to be lifted up by a minute amount relative to the lift bracket and in which the sensors are mounted for detecting the lift-up of the cargo carriers, the aforesaid safe operation can be activated as required.

According to the invention, there is provided a cargo handling vehicle, wherein the cargo carriers are mounted on the lift bracket with pins in such a manner as to rotate in vertical directions, whereby the cargo carriers are supported in such a manner that distal ends thereof are allowed to be lifted up by a minute amount, and wherein the sensor is mounted in such a manner as to output a detection signal when the cargo carrier rotates in a direction in which the distal end of the cargo carrier is lifted up by a minute amount.

In the invention, in the event that the distal ends of the cargo carriers ride on a rack or a cargo, whereby the cargo carriers rotate, the sensors detect the rotation, and the movement control section prohibits at least the lowering movement (and also the running movement, as required) Consequently, only when the distal ends of the cargo carriers are caught on the rack or the cargo, the aforesaid safe operation is activated.

According to the invention, there is provide a cargo handling vehicle, wherein the lift bracket is mounted on an operator's stand, wherein the cargo carriers are mounted on the operator's stand at intermediate positions between distal ends and proximal ends of the cargo carriers extending horizontally with the pins in such a manner as to rotate in vertical directions, and wherein a limit switch, functioning as the sensor, for detecting that the cargo carrier rotates in a direction in which the distal end of the cargo carrier is lifted up by a minute amount is provided on the operator's stand at a position corresponding to the proximal end of each of the cargo carriers.

In the invention, since the intermediate portions of the horizontally extending cargo carriers are supported with the pins, the cargo carriers rotate by a minute amount only when the distal ends of the cargo carriers are pushed upward with a force of a relatively small magnitude. Consequently, the aforesaid safe operation is activated only when the cargo carriers ride on a rack or a cargo slightly.

According to the invention, there is provided a cargo handling vehicle, wherein the cargo carriers are biased by springs in a direction opposite to the direction in which the distal ends of the cargo carriers are lifted up by a minute amount.

In the invention, when the cargo carriers rotate against the force of the springs, the limit switches are constructed to be activated, and therefore, the activating condition of the aforesaid safe operation can optionally be varied depending on a force set on the springs, irrespective of the deadweights of the cargo carriers.

According to the invention, there is provided a cargo handling vehicle, wherein a mounting gap for each of the springs is constructed to be changed, whereby the biasing force of the spring can be adjusted by changing the gap.

In the invention, the activating condition of the safe operation may optionally be changed without changing springs.

According to the invention, there is provided a cargo handling vehicle, wherein the cargo carriers are each formed into an L-shape having a vertical portion and a horizontal portion, wherein the cargo carriers are mounted on the lift bracket with the pins at upper ends of the vertical portions in such a manner as to rotate in vertical directions, wherein a bearing portion for bearing an angular moment resulting from the deadweight of the cargo carrier and holding the horizontal portion of the cargo carrier in a horizontal state is provided on the lift bracket at a position corresponding to the vertical portion of each of the cargo carriers, and wherein the sensor is mounted in such a manner as to output a detection signal when the vertical portion of the cargo carrier is separated from the bearing portion.

According to the invention, when the cargo carriers ride on a rack or a cargo and thereby rotate through a mistake in operation while the lift bracket is being lowered and the vertical portions of the cargo carriers are separated from the bearing portions, the sensors detect the separation, and the movement control section prohibits the lift bracket from lowering. Consequently, the aforesaid safe operation is activated only when the distal ends of the horizontal portions of the cargo carriers ride on the rack or the cargo slightly.

According to the invention, an operation lever is provided for the forklift truck for operating the lift unit to lift the cargo carrier up and down, wherein the measurement start indication switch is provided on a knob of an operation lever.

### BRIEF DESCRIPTION OF THE DRAWINGS

FIG. 1 is a block diagram showing a main part of a control system which is provided on a forklift truck according to a first embodiment of the invention.

FIG. 2 is a flowchart showing a first half stage of a control.

FIG. 3 is a flowchart showing a second half stage of the control.

FIG. 4 is a side view showing the overall construction of a forklift truck according to both the embodiment of the invention and the Related art.

FIG. 5 is a block diagram showing a main part of a control system which is provided on a forklift truck according to a second embodiment of the invention.

FIG. 6 is a flowchart showing a first half stage of a control.

FIG. 7 is a flowchart showing a second half stage of the control.

FIG. 8 is a side view showing the overall construction of a forklift truck according to both the embodiment of the invention and prior art example.

FIG. 9 is a block diagram showing a main part of a control system which is provided on a forklift truck according to a third embodiment of the invention.

FIG. 10 is a flowchart showing a control process.

FIG. 11 is a side view showing the overall construction of a forklift truck according to both the embodiment of the invention and the related art.

FIG. 12 is a block diagram showing a main part of a control system which is provided on a forklift truck according to a fourth embodiment of the invention.

FIG. 13 is a flowchart showing a procedure of a control by the control system.

FIG. 14 is a side view showing the overall construction of a forklift truck according to both the embodiment of the invention and the related art.

FIG. 15 is a block diagram showing a main part of a control system which is provided on a forklift truck according to a fifth embodiment of the invention.

FIG. 16 is a flowchart showing control operations by the control system.

FIG. 17 is a side view showing the overall construction of a forklift truck according to both the embodiment of the invention and the related art.

FIG. 18 is a block diagram showing a main part of a control system which is provided on a forklift truck according to a sixth embodiment of the invention.

FIG. 19 is a flowchart showing control operations by the control system.

FIG. 20 is a side view showing the overall construction of a forklift truck according to both the embodiment of the invention and the related art.

FIG. 21 is a block diagram showing a main part of a control system which is provided on a forklift truck according to a seventh embodiment of the invention.

FIG. 22 is a flowchart showing control operations by the control system.

FIG. 23 is a side view showing the overall construction of a forklift truck according to both the embodiment of the invention and the related art.

FIG. 24 is a block diagram showing a main part of a control system equipped on a reach forklift truck according to an eighth embodiment of the invention.

FIG. 25 is a flowchart showing a first control operation.

FIG. 26 is a flowchart showing a second control operation.

FIG. 27 is a flowchart showing a third control operation.

FIG. 28 is a side view showing an overall construction common to the reach forklift truck according to the embodiment of the invention and the related art.

FIG. 29 is a block diagram showing a main part of a control system equipped on a reach forklift truck according to a ninth embodiment of the invention.

FIG. 30 is a side view showing a state in which a tilt driving section and a tilt detecting section are laid out which are both provided in the vicinity of forks.

FIG. 31 is a flowchart showing control operations executed by the reach forklift truck of the embodiment.

FIG. 32 is a side view showing a state in which a slack detecting section is laid out which is provided in the vicinity of forks of a counterbalance forklift truck.

FIG. 33 is a side view showing an overall structure common to the reach forklift trucks according to the embodiment of the invention and a conventional reach forklift truck.

FIG. 34 is an enlarged view of a main part of a tenth embodiment of the invention.

FIG. 35 is an enlarged view of the main part showing a state in which a sensor is in operation according to the tenth embodiment.

FIG. 36 is an enlarged view of a main part showing a modification to the tenth embodiment.

FIG. 37 is an overall view of a forklift truck according to an eleventh embodiment of the invention.

FIG. 38 is an enlarged view of a main part of the eleventh embodiment.

FIG. 39 is an enlarged view of the main part showing a state in which a sensor is in operation according to the eleventh embodiment.

FIG. 40 is a schematic view of a conventional forklift truck.

FIG. 41 is an enlarged view showing a variation of the ninth embodiment.

FIGS. 42 to 44 show variations of the tenth embodiment of the invention.

FIGS. 45 to 47 show variations of the eleventh embodiment of the invention.

### DETAILED DESCRIPTION OF THE PRESENT INVENTION

The present invention will be described below in detail with reference to the accompanying drawings, and in the embodiment to be described, a cargo handling vehicle is described as a forklift truck. However, needless to say, the cargo handling vehicle is not limited to forklift trucks but may be a cargo handling vehicle of any type other than forklift trucks provided that the cargo handling vehicle comprises cargo carriers for carrying a cargo thereon, a lift unit for raising or lowering the cargo carriers along supporting masts, a vehicle main body on which the cargo carriers, the supporting masts and the lift unit are disposed, the cargo carriers and the supporting masts being disposed at forward positions thereon, and a running system disposed on the vehicle main body for moving the vehicle main body itself forward and backward.

First Embodiment

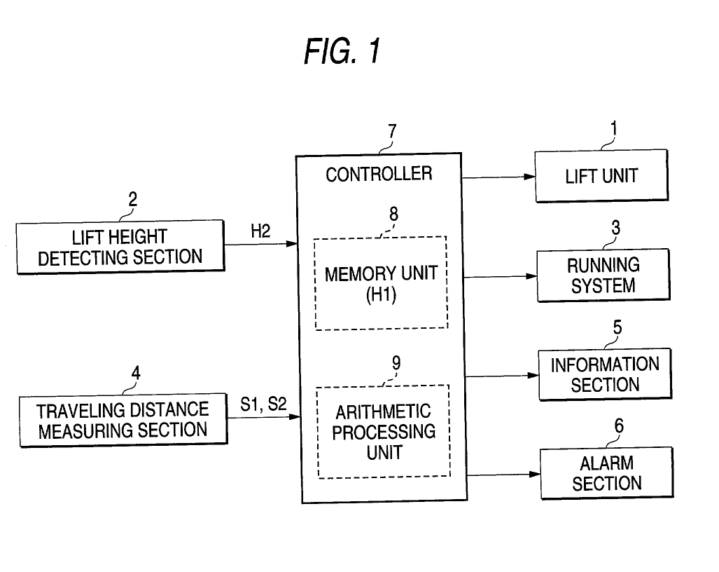

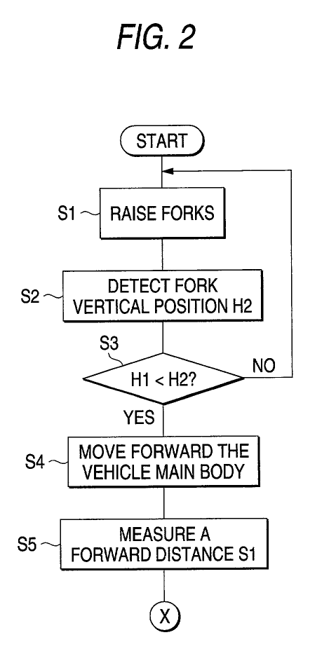

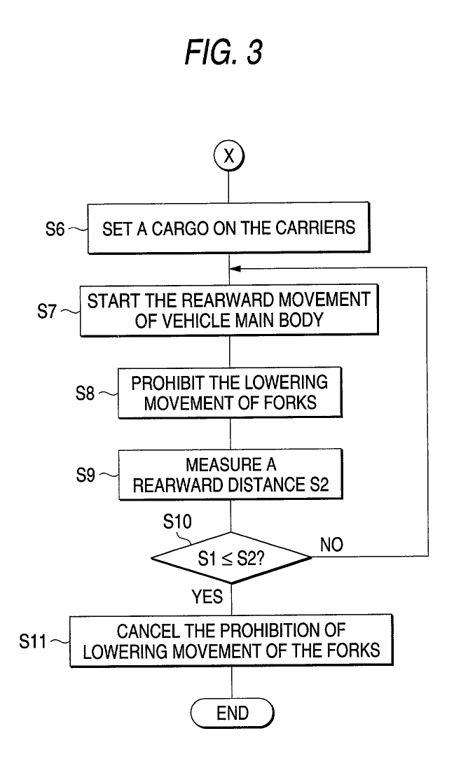

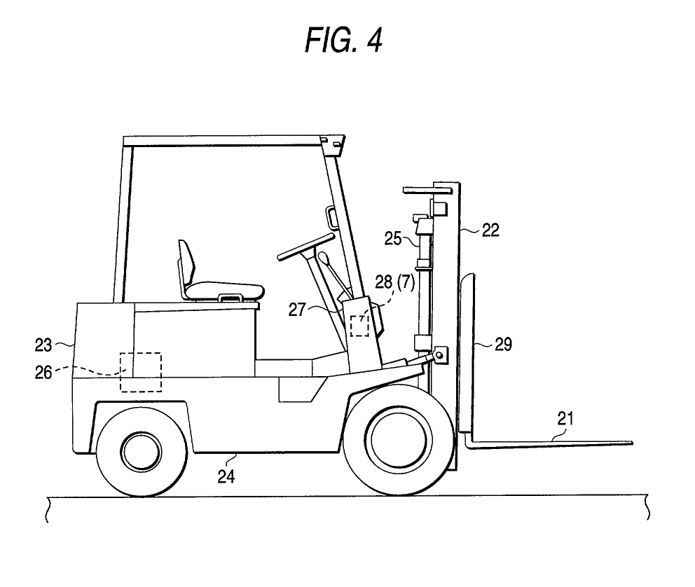

FIG. 1 is a block diagram showing a main part of a control system provided on a forklift truck according to a first embodiment of the invention, FIG. 2 is a flowchart showing a first half stage of a control according to the first embodiment of the forklift truck and FIG. 3 is a second half stage of the control. Note that the forklift truck according to the first embodiment is a counterbalance forklift truck, and the overall construction thereof is similar to that of the prior art forklift truck of the same type shown in FIG. 4, and therefore, no specific drawing therefor being provided here, the overall construction of the forklift truck according to the first embodiment will be described while referring to FIG. 4.

As shown in FIGS. 1 and 4, the forklift truck according to the first embodiment of the invention comprises a vehicle main body 24 having forks 21 for carrying a cargo thereon and masts 22 for guiding the rising and lowering movements of the forks 21 which are both disposed at forward positions of the vehicle main body 24, and a counterweight 23 which is disposed at a rearward position thereof. Then, hydraulic cylinders 25 are provided so as to erect along the masts 22 which support the forks 21 vertically movably, and the forks 21 are raised and/or lowered along the masts as a lift unit 1 disposed in the interior of the vehicle main body 24 and using the hydraulic cylinders 25 as actuators. In addition, the vertical position of the forks 21 when they are raised is detected by making use of a lift height detecting section 2 such as a reel type potentiometer and a magnet sensor.

Furthermore, a running motor 26 is installed in the vehicle main body 24, and the vehicle main body 24 itself or forklift truck itself is constructed so as to be move forward and backward in longitudinal directions and turned by a running system 3 which uses the running motor 26 as an actuator. Then, a forward distance S1 and a rearward distance S2 which are covered by the vehicle main body 24 can be measured by using, for example, a traveling distance measuring section 4, one example of which is an up-down type measuring apparatus adapted to up-count the forward distance S1 of the vehicle main body 24 and down-count the rearward distance S2 thereof which counts the number of times of rotations of a tire of the forklift truck.

Namely, to be specific, the traveling distance measuring section 4 is designed to measure a forward distance S1 covered by the vehicle main body 24 which starts its forward movement after the forks 21 have started to rise and a reward distance S2 covered by the vehicle main body 24 which starts its rearward movement after the completion of the forward movement thereof. Here, the traveling distance measuring device 4 is not limited to the up-down type measuring apparatus but may be constructed by using a rotary encoder or the like.

On the other hand, disposed on the operator's instrument panel 27 provided on the vehicle main body 24 are various types of manipulation levers for use in manually operating the lift unit 1 or the like, as well as an information section 5 and an alarm section 6 such as a liquid crystal display and a buzzer, and also disposed in the interior of the operator's instrument panel 27 is a controller 7 configured by making use of a microcomputer or a controller 7 constructed so as to function as a movement control section for prohibiting the lowering movement of the forks 21 while controlling in a united fashion operations of individual devices, as well as coordinated operations between the individual devices. Note that the information section 5 and the alarm section 6 are, respectively, designed to function to notify the operating condition of the controller 7 to the outside, more specifically, to the operator.

In this construction, a change-over switch (not shown) as a operation selecting section may be provided for determining whether or not the function of the controller 7 as the movement control section is effected or selecting either the execution of operation of the movement control section or the prohibition of operation thereof, and it is common to dispose such a change-over switch on the operator's instrument panel 27.

Then, this controller 7 is constructed to include a memory unit 8 constituted by a ROM or a RAM which stores a various types of data and an arithmetic processing unit 9 constituted by a CPU, and data on the vertical position of the forks 21 which constitutes a reference for prohibiting the lowering movement of the forks 21 during a loading or unloading operation or data on a reference position H1 is stored in the memory unit 8. Namely, the reference position H1 section a vertical position which the forks 21 are required to reach which is determined in advance after considering the vertical positions of rack shelves on which cargoes are loaded or the vertical positions of rack shelves from which cargoes are unloaded.

Additionally, in the forklift truck according to the first embodiment of the invention, upper and lower allowable limits h1 are set in advance to which the forks 21 which are being at a vertical position H2 beyond the reference position H1 are permitted to rise or lower, and data on the upper and lower allowable limits h1 is also stored in the memory unit 8. Namely, in loading or unloading a cargo using the forks 21, it is a common practice to move vertically the forks 21 over a small range, and as long as the actual vertical position H2 of the forks 21 is beyond the reference position H1, such fluctuations of the forks 21 over the small range would cause no inconvenience. However, in the event that the upper and lower traveling limits h2 of the forks 21 are too large, there may be predicted a problem in unloading a cargo, and therefore, the upper and lower allowable limits h1 between which the forks 21 are permitted to be lowered are set in advance. Thus, the upper and lower traveling limits h2 of the forks 21 are regulated by setting the upper and lower allowable limits h1.

The arithmetic processing unit 9 constituting the controller 7 functions as a movement control section for determining whether or not the actual vertical position H2 of the raised forks 21 is beyond the preset reference position H1 and whether or not a rearward distance S2 being covered by the vehicle main body 24 which has started its rearward movement in the state in which the vertical position H2 of the forks 21 is beyond the reference position H1 becomes equal to or greater than a forward distance S1 that was covered by the vehicle main body 24 when it moved forward, and prohibiting the lowering movement of the forks 21 until the rearward distance S2 becomes equal to or greater than the forward distance S1. Then, the arithmetic processing unit 9 is also configured to execute a control to permit the rising and lowering movements of the forks 21 until the upper and lower traveling limits h2 of the forks 21 which are being at the vertical position H2 which is beyond the reference position H1 exceed the preset upper and lower allowable limits h1 after considering the actual conditions of an unloading operation or the like.

As shown in FIG. 1, to make that happen, various types of needed signals are inputted into the controller 7 from the lift height detecting section 2 and the traveling distance measuring section 4, respectively, and signals are outputted from this controller 7 toward the lift unit 1, the running system 3, the information section 5 and the alarm section 6, respectively, for designating the movements of those devices. Note that while in the first embodiment of the invention, the data on the upper and lower allowable limits h1 between which the forks 21 are allowed to be lowered is stored in the memory unit 8 of the controller 7, and the arithmetic unit 9 is designed to execute the control to permit the rising and lowering movements of the forks 21 until the upper and lower traveling limits 2h exceed the upper and lower allowable limits h1, it is needless to say that even a construction also falls within the scope of the invention in which data on the upper and lower allowable limits is not stored in the memory unit 8, and additionally, the arithmetic processing unit 9 does not execute a control to permit the lowering movement of the forks 21.

Next, a control for a cargo unloading operation performed by the forklift truck according to the first embodiment of the invention will be described based on flowcharts shown in FIGS. 2 and 3. Note that in this first embodiment, only the control of an unloading operation using the forklift truck is described. A control for a loading operation performed by the forklift truck will basically be identical, and therefore, the description thereof will be omitted here.

First of all, when unloading cargoes, the operator moves the vehicle main body 24 closer in front of a rack shelf from which a cargo is to be unloaded, and thereafter the operator starts the operation of the lift unit 1 by manually manipulating a lift lever and allows the hydraulic cylinders to extend in conjunction with the operation of the lift unit 1. Then, the forks 21 start their rising movement while being guided by the masts 22 (step 1), and the actual vertical position H2 of the rising forks 21 is designed to be detected by the lift height detecting section 2 (step 2).

With time, when the actual vertical position H2 of the forks 21 exceeds the reference position H1 (step 3), the vehicle main body 24 is moved forward by the running system 3 (step 4), and the forks 21 are inserted into the rack shelf on which a cargo on a pallet is stored in conjunction with the forward movement of the vehicle main body 24. Then, as this occurs, since the vehicle main body 24 has started to move forward after the forks 21 started their rising movement, a forward distance S1 that has been covered by the vehicle main body 24 by then is measured by the traveling distance measuring section 4 (step 5).

Furthermore, the forks 21 inserted into the rack shelf are expected to lift up the cargo together with the pallet while being raised and lowered, and thus, the cargo stored on the rack shelf is now set on the forks 21 (step 6). The vertical position H2 of the forks 21 which are being raised and lowered or fluctuated is also detected by the lift position detecting section 2, and the rising and lowering movements of the forks 21 are allowed by the arithmetic processing unit 9 provided that the upper and lower traveling limits h2 of the forks 21 which are calculated based on the actual vertical position of the fluctuating forks 21 do not exceed the preset upper and lower allowable limits h1, or h2≦h1.

Thereafter, the forks 21 on which the cargo is set are moved backward to get out of the rack shelf as the vehicle main body 24 is moved backward by so operating the running system 3 (step 7), and as this occurs, since the vehicle main body 24 is started to move backward under a state in which the actual vertical position H2 of the forks 21 exceeds the reference position H1, the arithmetic processing unit 9 of the controller 7 executes the control to prohibit the lowering movement of the forks 21 (step 8). Then, since the vehicle main body 24 has started its rearward movement following the completion of its forward movement in conjunction with the rearward movement of the forks 21, a rearward distance S2 covered by the vehicle main body 24 is measured by the traveling distance measuring section 4 (step 9), and the arithmetic processing unit 9 continues to prohibit the lowering movement of the forks 21 until the rearward distance that is being covered by the vehicle main body 24 becomes equal to or greater than the forward distance S1 that was covered by the vehicle main body 24 at a point in time of completion of its forward movement (step 10).

In other words, while the forks 21 are moving rearward, the arithmetic processing unit 9 of the controller 7 determines whether or not the rearward distance S2 of the vehicle main body 24 becomes equal to or greater than the forward distance S1 based on the fact that the vehicle main body 24 starts to move rearward under the state in which the actual vertical position H2 of the forks 21 exceeds the reference position H1 (step 10), and as long as the rearward distance 52 does not become equal to or greater than the forward distance S1, or as long as S2<S1, the control to prohibit the rearward movement of the vehicle main body 24, as well as the lowering movement of the forks 21 continues to be effective (step 7 to 9). Then, the lowering movement of the forks 21 continues until the rearward distance S2 of the vehicle main body 24 becomes equal to or greater than the forward distance S1 thereof (S2≧S1), and the control to prohibit the lowering movement of the forks 21 is cancelled at a point in time where the arithmetic processing unit 9 determines that the rearward distance S2 of the vehicle main body 24 becomes equal to or greater than the forward distance S1 thereof (step 11).

Then, at after this point in time, the forks 21 are allowed to be lowered below the reference position H1 by manually manipulating the lift lever to resume the operation of the lift unit 1 and allowing the hydraulic cylinders 25 to retract. Note that there is no particular reason or rationale for manually operating the lift lever in lowering the forks 21, and therefore, a function may be imparted to the arithmetic unit 9 which is the movement control section of automatically starting the lowering movement of the forks 21 at the point in time where the rearward distance S2 of the vehicle main body 24 becomes equal to or greater than the forward distance S1 thereof.

While in the first embodiment, the control to prohibit the lowering movement of the forks 21 is described as being cancelled at the point in time where the arithmetic unit 9 of the controller 7 determines that the rearward distance S2 of the vehicle main body 24 becomes equal to or greater than the forward distance S1 thereof, it is needless to say that the arithmetic processing unit 9 which so determines the cancellation may be designed to execute such a movement control as to stop the rearward movement of the vehicle main body 24 at the same time. In addition, in the event that no rising and lowering movements of the forks 21 inserted into the rack shelf occur in step 6, or, in the event that no rearward movement of the vehicle main body 24 occurs in step 7, it is considered that no normal unloading operation is being performed or that there occurs a failure, and then it is practical to stop the execution of the control to prohibit the lowering movement of the forks 21 after a predetermined length of time has elapsed.

Additionally, although omitting a detailed description thereof here, a construction may be adopted in which an operating condition such as the start-up of the control to prohibit the lowering movement of the forks 21 or the continued rearward movement of the forks 21 is notified to the operator suitably with the information section 5 and the alarm section 6, and in a case where such a construction is adopted, an advantage can be secured that a misjudgment by the operator is difficult to occur. Note that the movement control to prohibit the lowering movement of the forks 21 is not always required throughout an unloading work using the forklift truck, and in a case where the lowering movement does not have to be prohibited, it is needless to say that it is possible to select the prohibition of operation of the arithmetic processing unit 9 by making use of the change-over switch disposed on the operator's instrument panel 27.

Second Embodiment

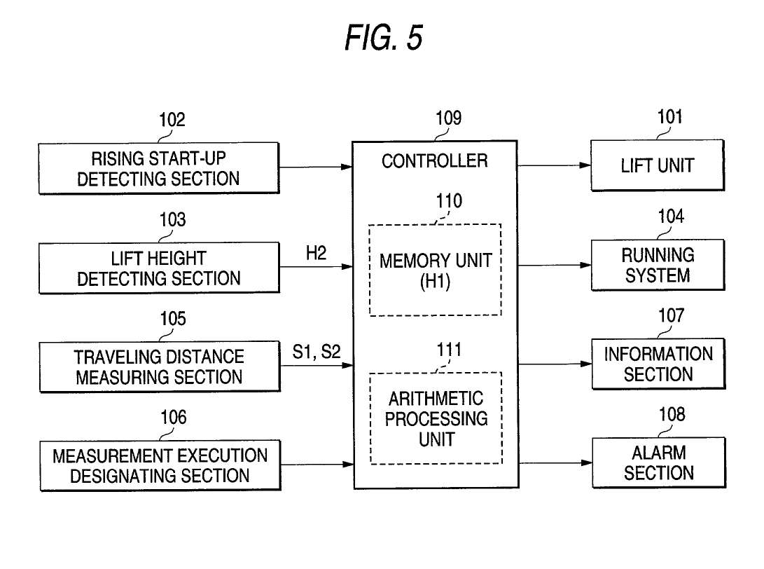

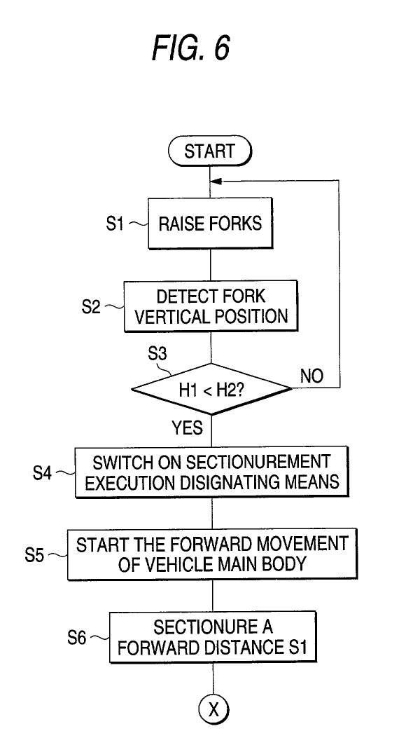

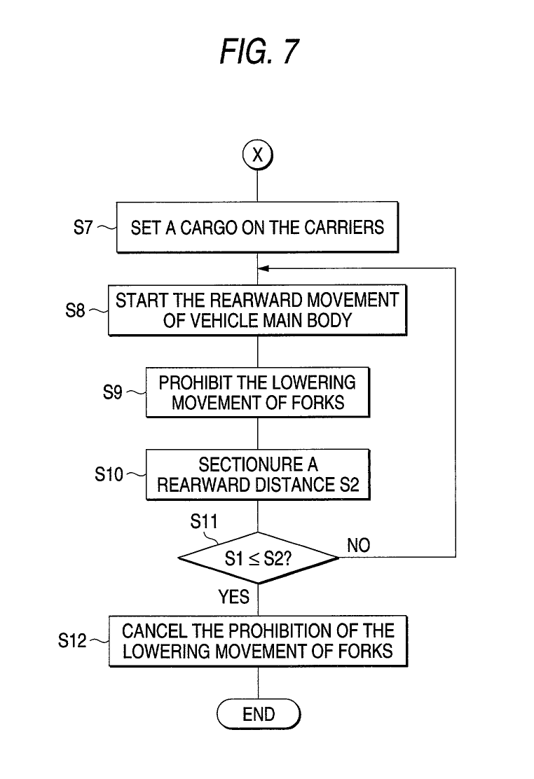

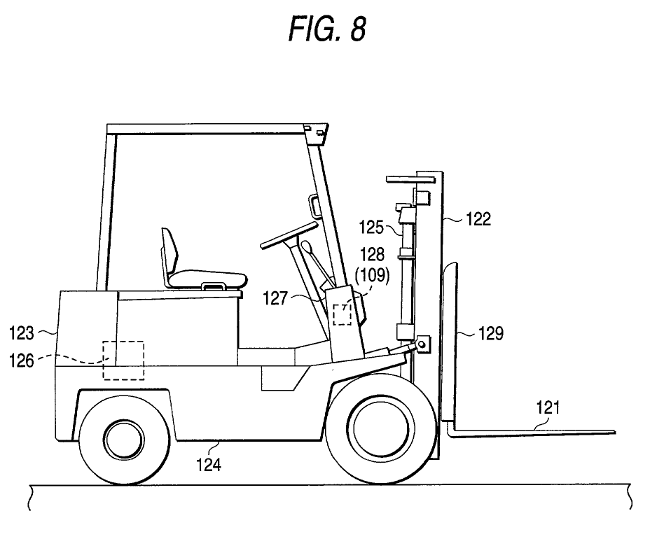

FIG. 5 is a block diagram showing a main part of a control system provided on a forklift truck according to a second embodiment of the invention, FIG. 6 is a flowchart showing a first half stage of a control according to the second embodiment of the forklift truck and FIG. 7 is a second half stage of the control. Note that the forklift truck according to the second embodiment is a counterbalance forklift truck, and the overall construction thereof is similar to that of the prior art forklift truck of the same type shown in FIG. 8, and therefore, no specific drawing therefor being provided here, the overall construction of the forklift truck according to the second embodiment will be described while referring to FIG. 8.

As shown in FIGS. 5 and 8, the forklift truck according to the second embodiment of the invention comprises a vehicle main body 124 having forks 121 for carrying a cargo set on a pallet or the like and masts 122 for guiding the rising and lowering movements of the forks 121 which are both disposed at forward positions of the vehicle main body 124, and a counterweight 123 which is disposed at a rearward position thereof. Furthermore, hydraulic cylinders 125 are provided so as to erect along the masts 122 which support the forks 121 vertically movably, and the forks 121 are raised and/or lowered along the masts by operating a lift unit 101 disposed in the interior of the vehicle main body 124 or a lift unit 101 of the hydraulic system with the hydraulic cylinders 125 functioning as actuators.

Note that the start-up of rising movement of the forks 121 is detected by a rising start-up detection section 102 which is a detection sensor such as a limit switch disposed at a predetermined position along the masts, and on the other hand, the height or vertical position of the forks so raised is detected by making use of a known lift height detecting section 103 such as a reek-type potentiometer or magnet sensor.

In addition, a running motor 126 is disposed in the interior of the vehicle main body 124, and the vehicle main body 124 itself or forklift truck itself is constructed so as to be moved forward and backward in longitudinal directions and turned by an electric running system 104 which uses the running motor 126 as an actuator. Furthermore, a forward distance S1 and a rearward distance S2 which are covered by the vehicle main body 124 when it is moved as described above can be measured by a traveling distance measuring section 105 such as an up-down type measuring apparatus adapted to up-count the forward distance S1 of the vehicle main body 124 and down-count the rearward distance S2 thereof.

Namely, in the second embodiment of the invention, the traveling distance measuring section 105 is designed to measure a forward distance S1 covered by the vehicle main body 124 which starts its forward movement after the forks 121 have started to rise and a reward distance S2 covered by the vehicle main body 124 which starts its rearward movement after the completion of the forward movement thereof based on an ON signal from a measurement execution designating section 106 which is a switch or the like disposed on an operator's instrument panel 127, or based on the input of such an ON signal designating the execution of measurement. Here, the traveling distance measuring device 105 is not limited to an up-down type measuring instrument or apparatus for counting the number of times of rotations of a tire but may be constructed by using a rotary encoder or the like.

Furthermore, disposed on the operator's instrument panel 127 are various types of manipulation levers for use in manually operating the lift unit 101 or the like, as well as an information section 107 and an alarm section 108 such as a liquid crystal display and a buzzer, and also disposed in the interior of the operator's instrument panel 127 is a controller 109 configured by making use of a microcomputer or a controller 109 for controlling in a united fashion operations of individual devices, as well as mutually coordinated operations between the individual devices and realizing a control of movements of the vehicle main body while prohibiting the lowering movement of the forks 121. Note that in this second embodiment, the information section 107 and the alarm section 108 are designed to function to notify the operating condition of the controller 109 to the outside, more specifically, to the operator.

This controller 109 comprises a memory unit 110 constituted by a ROM or a RAM which stores a various types of data and an arithmetic processing unit 111 constituted by a CPU, and data on the vertical position of the forks 121 which constitutes a reference for prohibiting the lowering movement of the forks 121 during a loading or unloading operation or data on a reference position H1 is stored in the memory unit 110. Here, the reference position H1 section a vertical position which the forks 121 are required to reach which is determined in advance after considering the vertical positions of rack shelves on which cargoes are loaded or the vertical positions of rack shelves from which cargoes are unloaded.

Additionally, in the forklift truck according to the second embodiment of the invention, upper and lower allowable limits h1 are set in advance to which the forks 121 which are being at a vertical position H2 beyond the reference position H1 are permitted to rise or lower, and data on the upper and lower allowable limits h1 is also stored in the memory unit 110. Namely, in loading or unloading a cargo using the forks 121, it is a common practice to move vertically the forks 121 over a small range, and as long as the actual vertical position H2 of the forks 121 is beyond the reference position H1, such fluctuations of the forks 121 over the small range would cause no inconvenience. However, in the event that the upper and lower traveling limits h2 of the forks 121 are too large, there may be predicted a problem in unloading a cargo, and therefore, the upper and lower allowable limits h1 between which the forks 121 are permitted to be lowered are set in advance. Thus, the upper and lower traveling limits h2 of the forks 121 are regulated by setting the upper and lower allowable limits h1.

The arithmetic processing unit 111 constituting the controller 109 functions as a movement control section for determining whether or not a forward movement of the vehicle main body 124 is started after the forks 121 have started to rise and whether or not an ON signal is outputted from the measurement execution designating section 106 and prohibiting the lowering movement of the forks 121 until a rearward distance S2 of the vehicle main body 124 measured by the traveling distance measuring section 105 under the state in which an ON signal is inputted from the measurement execution designating section 106 becomes equal to or greater than a forward distance S1 which has been covered by the vehicle main body 124. In addition, the arithmetic processing unit 111 is also configured to execute a control to permit the rising and lowering movements of the forks 121 until the upper and lower traveling limits h2 of the forks 121 which are being at the vertical position H2 which is beyond the reference position H1 exceed the preset upper and lower allowable limits h1 after considering the actual conditions of an unloading operation or the like.

As shown in FIG. 5, to make that happen, various types of movement signals and detection signals are inputted into the controller 109 from the rising start-up detecting section 102, the lift height detecting section 103, the traveling distance measuring section 105 and the measurement execution designating section 106, respectively, while designation signals are designed to be outputted from the controller 109 to the lift unit 101, the running system 104, the information section 107, the alarm section 108 and the like. In the second embodiment of the invention, the data on the upper and lower allowable limits h1 between which the forks 121 are allowed to be lowered is stored in the memory unit 110, and the arithmetic unit 11 is designed to execute the control to permit the rising and lowering movements of the forks 121 until the upper and lower traveling limits 2h exceed the upper and lower allowable limits h1. However, it is needless to say that even a construction also falls within the scope of the invention in which data on the upper and lower allowable limits is not stored in the memory unit 110, and additionally, the arithmetic processing unit 111 does not execute a control to permit the lowering movement of the forks 121.

Next, a control for a cargo unloading operation performed by the forklift truck according to the second embodiment of the invention will be described based on flowcharts shown in FIGS. 6 and 7. Note that in this second embodiment, only the control of an unloading operation using the forklift truck is described. A control for a loading operation performed by the forklift truck will basically be identical, and therefore, the description thereof will be omitted here.

First of all, when unloading cargoes, the operator moves the vehicle main body 124 closer in front of a rack shelf from which a cargo is to be unloaded, and thereafter the operator starts the operation of the lift unit 101 by manually manipulating a lift lever and allows the hydraulic cylinders to extend in conjunction with the operation of the lift unit 101. Then, the forks 121 start their rising movement while being guided by the masts 122 (step 1), and the start-up of rising movement of the forks 121 is detected by the rising start-up detecting section 102. In addition, the actual vertical position H2 of the rising forks 121 is designed to be detected by the lift height detecting section 103 (step 2).

With time, when the actual vertical position H2 of the forks 121 exceeds the reference position H1 (step 3), the operator then manually switch on the measurement execution designating section 106 (step 4), whereby the vehicle main body 124 is driven forward by the running system 104 (step 5). Then, the forks 121 are inserted into the rack shelf on which a cargo set on a pallet is stored. However, as this occurs, since the measurement execution designating section 106 is manipulated to be switched on and moreover since the vehicle main body 124 has started its forward movement after the forks 121 started their rising movement, a forward distance S1 that has been covered by the vehicle main body 124 by then is measured by the traveling distance measuring section 105 (step 6). Note that there is no specific reason for switching on the measurement execution designating section 106 in step 3, it is needless to say that the measurement execution designating section 106 may be switched on at a point in time earlier than in step 3.

Furthermore, the forks 121 inserted into the rack shelf are expected to lift up the cargo together with the pallet while being raised and lowered, and thus, the cargo stored on the rack shelf is now set on the forks 121 (step 7). The vertical position H2 of the forks 121 which are being raised and lowered or fluctuated is also detected by the lift position detecting section 103, and the rising and lowering movements of the forks 121 are allowed by the arithmetic processing unit 111 in the controller 109 provided that the upper and lower traveling limits h2 of the forks 121 which are calculated based on the actual vertical position of the fluctuating forks 121 do not exceed the preset upper and lower allowable limits h1, or h2≦h1.

Thereafter, the forks 121 on which the cargo is set are moved backward to get out of the rack shelf as the vehicle main body 124 is moved backward by so operating the running system 104 (step 8), and as this occurs, since the vehicle main body 124 is started to move backward under a state in which the actual vertical position H2 of the forks 121 exceeds the reference position H1, the arithmetic processing unit 111 of the controller 109 executes the control to prohibit the lowering movement of the forks 121 (step 9). Then, since the vehicle main body 124 has started its rearward movement following the completion of its forward movement, a rearward distance S2 covered by the vehicle main body 124 is measured by the traveling distance measuring section 105 as the forks 121 move backward (step 10), and the arithmetic processing unit 111 continues to prohibit the lowering movement of the forks 121 until the rearward distance that is being covered by the vehicle main body 124 becomes equal to or greater than the forward distance S1 that was covered by the vehicle main body 124 during its forward movement (step 11).

In other words, while the forks 121 are moving rearward, the arithmetic processing unit 111 of the controller 109 determines whether or not the rearward distance S2 of the vehicle main body 124 becomes equal to or greater than the forward distance S1 based on the fact that the vehicle main body 124 starts to move rearward under the state in which the vertical position H2 of the forks 121 exceeds the reference position H1 (step 11), and as long as the rearward distance S2 does not become equal to or greater than the forward distance S1, or as long as S2<S1, the control to prohibit the lowering movement of the forks 121 continues to be effective (step 9). Then, the lowering movement of the forks 121 continues until the rearward distance S2 of the vehicle main body 124 becomes equal to or greater than the forward distance S1 thereof (S2≧S1), and the control to prohibit the lowering movement of the forks 121 is cancelled at a point in time where the arithmetic processing unit 111 determines that the rearward distance S2 of the vehicle main body 124 becomes equal to or greater than the forward distance S1 thereof (step 12).

Then, at and after this point in time, the forks 121 are allowed to be lowered below the reference position H1 by manually manipulating the lift lever to resume the operation of the lift unit 101 and allowing the hydraulic cylinders 125 to retract. Note that there is no particular reason or rationale for manually operating the lift lever in lowering the forks 121, and therefore, a function may be imparted to the arithmetic unit 11 which is the movement control section of automatically starting the lowering movement of the forks 121 at the point in time where the rearward distance S2 of the vehicle main body 124 becomes equal to or greater than the forward distance S1 thereof.

While in the second embodiment, the control to prohibit the lowering movement of the forks 121 is described as being cancelled at the point in time where the arithmetic unit 11 of the controller 109 determines that the rearward distance S2 of the vehicle main body 124 becomes equal to or greater than the forward distance S1 thereof, it is needless to say that the arithmetic processing unit 111 which so determines the cancellation may be designed to execute such a movement control as to stop the rearward movement of the vehicle main body 124 at the same time. In addition, in the event that no rising and lowering movements of the forks 121 inserted into the rack shelf occur in step 7, or, in the event that no rearward movement of the vehicle main body 124 occurs in step 8, it is considered that no normal unloading operation is being performed or that there occurs a failure, and it is practical to stop the execution of the control to prohibit the lowering movement of the forks 121 after a predetermined length of time has elapsed.

Additionally, although omitting a detailed description thereof here, a construction maybe adopted in which an operating condition such as the start-up of the control to prohibit the lowering movement of the forks 121 or the continued rearward movement of the forks 121 is notified to the operator suitably with the information section 107 and the alarm section 108, and in a case where such a construction is adopted, an advantage can be secured that a misjudgment by the operator is difficult to occur. Note that the movement control to prohibit the lowering movement of the forks 121 is not always required throughout an unloading work using the forklift truck, and in a case where the lowering movement of the forks 121 does not have to be prohibited, it is needless to say that a construction may be adopted in which the control to prohibit the lowering movement of the forks 121 by the arithmetic unit 11 of the controller 109 is cancelled by making use of a control canceling section (not shown) such as a switch disposed on the operator's instrument panel 127.

Third Embodiment

A third embodiment of the invention will be described below with reference to the accompanying drawings, and in the third embodiment to be described, a cargo handling vehicle is described as a counterbalance forklift truck. However, the invention is not limited to counterbalance forklift trucks but may be applied to other types of forklift trucks such as reach, picking and straddle forklift trucks. Furthermore, the invention is not limited to forklift trucks but may be applied to a cargo handling vehicle of any type other than forklift trucks provided that the cargo handling vehicle comprises cargo carriers for carrying a cargo thereon, a lift unit for raising and/or lowering the cargo carriers along supporting masts, a vehicle main body on which the cargo carriers, the supporting masts and the lift unit are disposed, the cargo carriers and the supporting masts being disposed at forward positions thereon, and a running system disposed on the vehicle main body for moving the vehicle main body itself forward and backward.

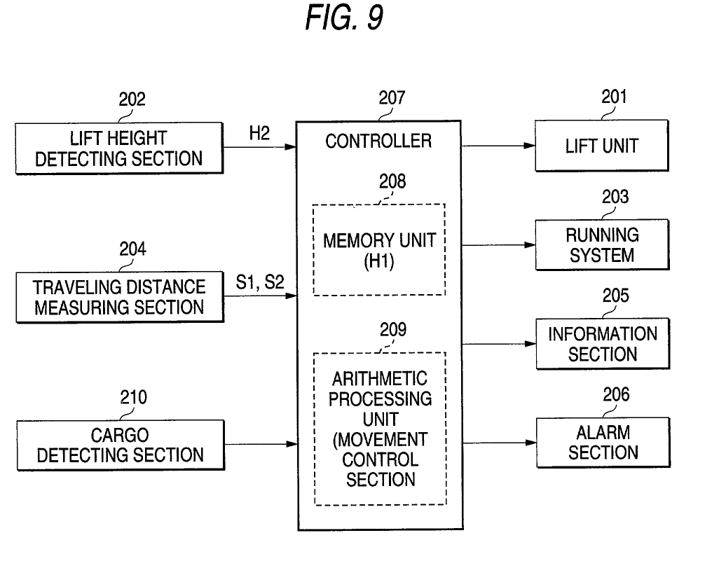

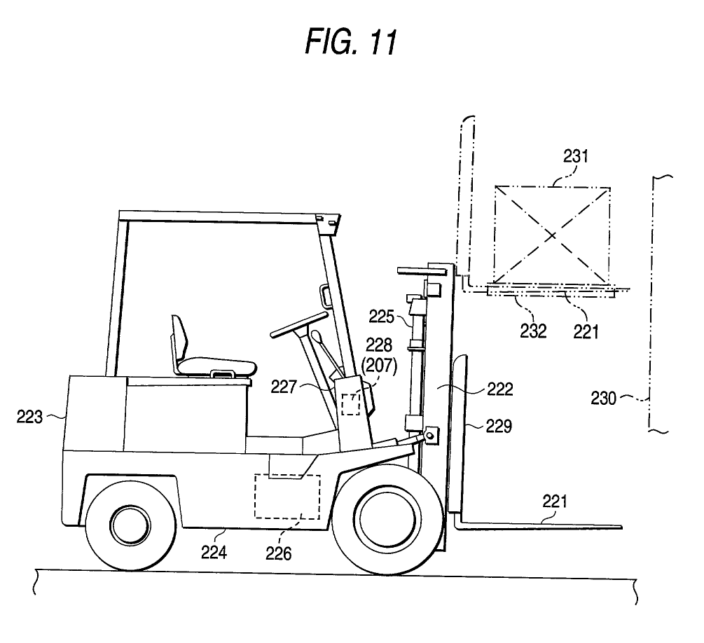

FIG. 9 is a block diagram showing a main part of a control system provided on a counterbalance forklift truck according to the third embodiment of the invention. Note that the overall construction this counterbalance forklift truck is basically similar to that of the prior art forklift truck of the same type shown in FIG. 11, and therefore, the overall construction thereof will be described while referring to FIG. 11.

In the counterbalance forklift truck according to the third embodiment of the invention, forks 221 for carrying a cargo 231 thereon and masts 222 which are supporting masts for guiding the rising and lowering movements of the forks 221 are both disposed at forward positions of a vehicle main body 224, and a counterweight 223 is disposed at a rearward position thereof. Furthermore, hydraulic cylinders 225 are provided so as to erect along the masts 222 which support the forks 221 vertically movably, and the forks 221 are constructed so as to be raised and/or lowered by a lift unit 201 using the hydraulic cylinders 225 as actuators. The vertical position of the forks 221 which are so raised or lowered is then detected by a lift height detecting section 202 such as a reel type potentiometer or a magnet sensor.

In addition, in this third embodiment, a cargo detecting section 210 comprising a photoelectric sensor is provided at part of a back rest 229 of the fork 221 for detecting the existence of a cargo on the forks 221. Note that a load cell or the like for detecting a load applied to the fork 221 may be used as the cargo detecting section 210 instead of the photoelectric sensor.

In addition, a running motor 226 is installed in the vehicle main body 224, and the vehicle main body 224 is constructed such that the entirety thereof is moved forward and backward in longitudinal directions and turned by a running system 203 which uses the running motor 226 as an actuator. Furthermore, a forward distance S1 and a rearward distance S2 of the vehicle main body 224 are designed to be measured individually by a traveling distance measuring section 204 constituted by a measuring apparatus such as an up-down counter which is adapted to up-count, for example, a forward distance S1 of the vehicle main body 224 and down-count a rearward distance S2 thereof. Note that instead of the up-down counter, a measuring apparatus such as a rotary encoder may be used.

Furthermore, disposed on the operator's instrument panel 227 are various types of manipulation levers for use in manually operating the lift unit 201 or the like, as well as an information section 205 such as a liquid crystal display and an alarm section 206 such as a buzzer or lamp.

Also disposed in the interior of the operator's instrument panel 227 is a controller 207 configured by making use of a microcomputer. This controller 207 is intended to control in a united fashion operations of individual devices, as well as coordinated operations between the respective devices and includes a memory unit 208 comprising a ROM or a RAM which stores a various types of data and an arithmetic processing unit 209 constituted by a CPU.

The memory unit 208 is designed to store in advance data which constitutes a reference for prohibition of the lowering movement of the forks 221 in loading or unloading a cargo, or data on a reference position H1. The reference position H1 section a maximum allowable value for the lift height of the forks 221 which can be considered relatively safe, and is used in determining that it is danger when the lift height of the forks 221 exceeds the reference position to thereby prohibit the lowering movement of the forks 221.

Additionally, stored in advance in the memory unit 208 is data on upper and lower allowable limits Δ within which the forks 221 which are being at a vertical position H2 which is beyond the reference position H1 are permitted to rise and lower. Namely, in actually loading or unloading a cargo, forks 221 need to be finely adjusted in height by slightly fluctuating the forks 221 so as to be positively inserted in a pallet, and the upper and lower allowable limits Δ are provided to meet such a requirement

The arithmetic processing unit 209 is intended to control the operations of the respective devices such as the lift unit 201, the running system 203, the alarm section 205 and the information section 206 based on respective detection outputs from the lift unit 201, the traveling distance measuring section 204 and the cargo detecting section 210, as well as the data stored in the memory unit 208, and this arithmetic processing unit functions as a movement control section claimed in the scope of the invention.

To make this happen, as shown in FIG. 9, various types of necessary signals are inputted into the controller 207 from the lift height detecting section 202, the traveling distance measuring section 204 and the cargo detecting section 210, respectively, while movement designation signals are designed to be outputted from the controller 207 to the lift unit 201, the running system 203, the information section 205, the alarm section 206 and the like.

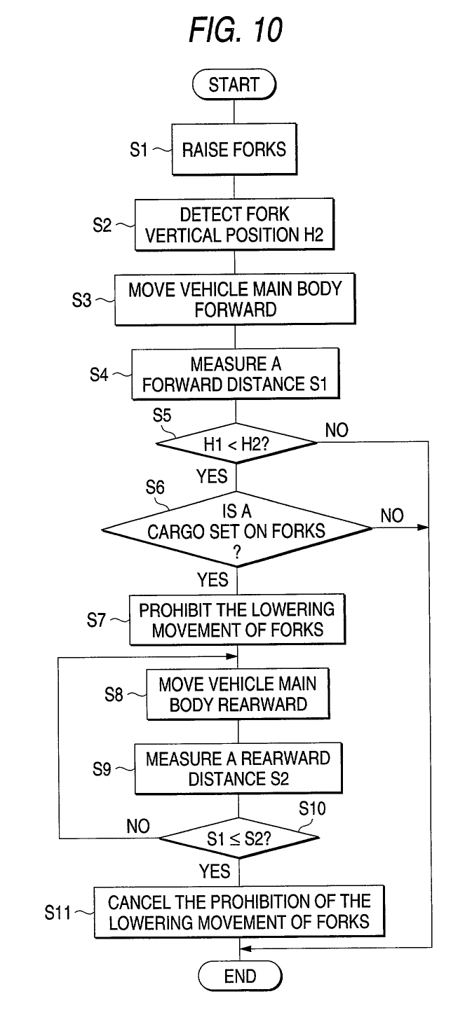

Next, a control for a cargo unloading operation performed by the forklift truck according to the third embodiment of the invention will be described based on a flowchart shown in FIG. 10. Note that in this third embodiment, only the control of an unloading operation using the forklift truck is described. A control for a loading operation performed by the forklift truck will basically be identical, and therefore, the description thereof will be omitted here.

First of all, when unloading a cargo, the operator moves the vehicle main body 224 closer in front of a rack shelf 230 from which a cargo is to be unloaded, and thereafter the operator starts the operation of the lift unit 201 by manually manipulating a lift lever, when the hydraulic cylinders 225 are then activated and the forks 221 starts its rising movement while being guided by the masts 222 (step 1). As this occurs, the actual vertical position H2 of the forks 221 are detected by the lift height detecting section 202 (step 2).

Next, when the vehicle main body 224 is moved forward by the running system 203 (step 3), the forks 221 gradually approach a rack shelf 230 storing therein a cargo set on a pallet in conjunction with the advancement of the vehicle main body 224. A forward distance S1 covered by the vehicle main body 224 at the end of its forward movement is detected by the traveling distance measuring section 204 (step 4), and a measured value S1 is then stored in the memory unit 208.

Then, the arithmetic processing unit 209 determines whether or not the actual vertical position H2 of the forks 221 exceed the reference position H at a point in time where the forks 221 obtain a height H1 and an insertion length which allow them to unload a predetermined cargo set on the rack shelf 230 and the rising movement of the forks 221 and the forward movement of the vehicle main body 224 are both stopped (step 5). In the event that the actual vertical position H2 of the forks 221 exceeds the reference position H1, whether or not the cargo 231 is actually set on the forks 221 is determined based on detection outputs from the cargo detecting section 210 (step 6) In the event that it is determined that the cargo 231 actually exists on the forks 221, the arithmetic processing unit 209 prohibits the lowering movement of the forks (step 7).

However, even in the event that the actual vertical position H2 of the forks 221 exceed the reference position H1 with the cargo 231 resting on the forks 221, the controller 207 of the arithmetic processing unit 209 allows the forks 221 to be raised and lowered by the lift unit 201 within the upper and lower allowable limits Δ. Therefore, since the forks 221 are allowed to be raised and lowered within the upper and lower allowable limits Δ, the cargo 231 resting on the pallet can positively be moved onto the forks 221.

Thereafter, as the vehicle main body 224 is moved rearward by section of the running system 203, the forks 221 carrying the cargo thereon are moved rearward so as to get out of the rack shelf 230 (step 8), and as this occurs, a rearward distance S2 being covered by the vehicle main body 224 is detected by the traveling distance measuring section 204 (step 9).

The arithmetic processing unit 209 continues to execute the prohibition of the lowering movement of the forks 221 until the rearward distance S2 of the vehicle main body 224 which is continuously detected by the traveling distance measuring section 204 becomes equal to or greater than the forward distance S1 stored in the memory unit 208 (step 10).

When the rearward distance S2 of the vehicle main body 224 becomes equal to or greater than the forward distance S1, the arithmetic processing unit 209 cancels the control to prohibit the lowering movement of the forks 221 (step 11). Thus, after this point in time, the forks 221 can be lowered beyond the upper and lower allowable limits Δ by the hydraulic cylinders 225 by manually manipulating the lift lever to resume the operation of the lift unit 201.

Additionally, in step 5, in the event that the actual vertical position H2 of the forks 221 is determined below the reference position H1, the operator can easily visually recognize that the forks 221 have got out completely of the rack shelf 230, and in step 6, even in the event that the actual vertical position H2 of the forks 221 exceed the reference position H1, in such a case where it is determined that no cargo rests on the forks 221, since there is no risk of a cargo falling from the forks 221, the arithmetic processing unit 209 does not enter the mode in which the forks 221 are prohibited to be lowered, and therefore, the forks 221 can be lowered beyond the upper and lower allowable limits Δ.

It can be considered possible that the following modifications or applications are made to the aforesaid third embodiment of the invention.

(1) While in the third embodiment, the control to prohibit the lowering movement of the forks 221 is designed to be cancelled at the point in time where the controller 207 of the arithmetic processing unit 209 determines that the rearward distance S2 of the vehicle main body 224 becomes equal to or greater than the forward distance S1, it may be designed such that the arithmetic processing unit 209 which so determines the cancellation executes a control to stop the rearward movement of the vehicle main body 224 at the same time.

(2) While in the third embodiment, the lowering movement of the forks 221 is effected by manually manipulating the lift lever after the prohibition of the lowering movement of the forks 221 is cancelled in step 11, a function may be imparted to the arithmetic processing unit 209 which is the movement control section of automatically starting the lowering movement of the forks 221 without having to manually manipulating the lift lever at the point in time where the rearward distance S2 of the vehicle main body 224 becomes equal to or greater than the forward distance S1 stored in the memory unit 208 in step 10.

(3) A construction may be suitably adopted in which the operating condition of the forklift truck such as the start-up of the control to prohibit the lowering movement of the forks 221 or the occurrence of the rearward movement of the vehicle main body is notified to the operator through the information device 5 and the alarm section 206. In a case where such a construction is adopted, an advantage is secured that a misjudgment by the operator is difficult to occur.

(4) Since the control to prohibit the lowering movement of the forks 221 is not always required throughout an unloading work using a forklift truck, it may be constructed such that a change-over switch (not shown) is provided on the operator's instrument panel 227 as an operation selecting section for determining whether or not the function of the controller 207 as the movement control section is executed, or selecting either the execution of operation of the movement control section or the prohibition of operation thereof, thereby making it possible to select whether to prohibit the operation of the arithmetic processing unit 209 or to cancel the prohibition of the operation thereof by switching the change-over switch as required by the operator.

Fourth Embodiment

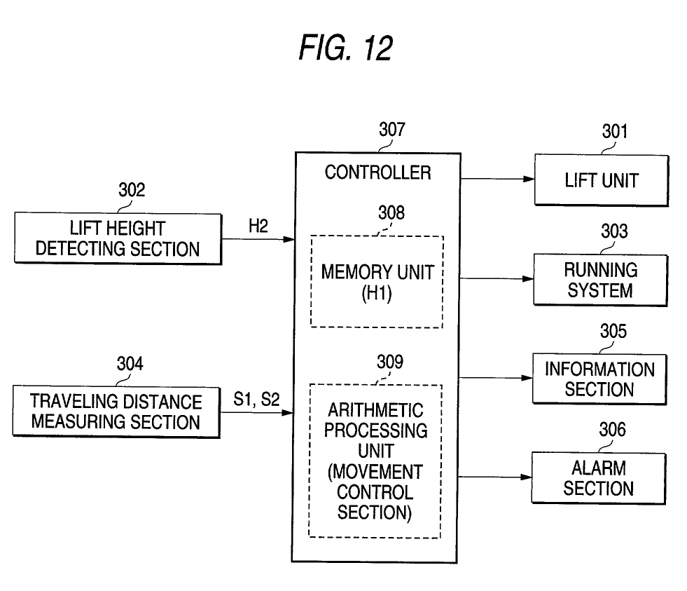

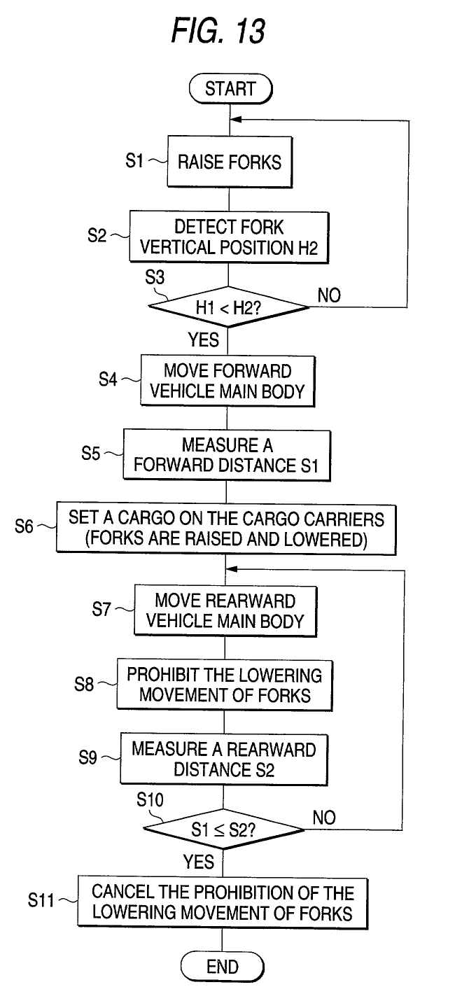

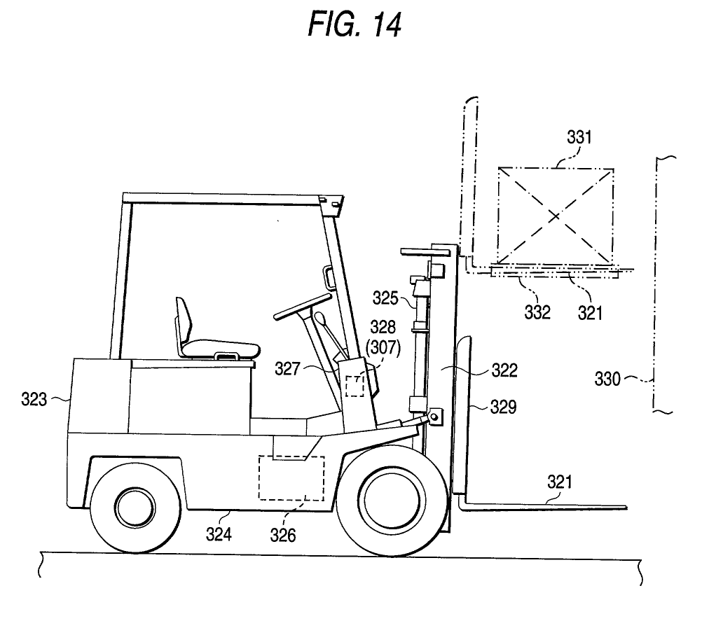

FIG. 12 is a block diagram showing a main part of a control system provided on a forklift truck according to a fourth embodiment of the invention, and FIG. 13 is a flowchart showing the procedure of a control by the control system. Note that the overall construction of the counterbalance forklift according to the invention is similar to that of a prior art forklift truck of the same type shown in FIG. 14, and therefore, no specific drawing therefor being provided here, the overall construction of the forklift truck according to the fourth embodiment will be described while referring to FIG. 14.

As shown in FIGS. 12 and 14, the counterbalance forklift truck according to the fourth embodiment of the invention comprises a vehicle main body 324 having forks 321 for carrying a cargo 331 set on a pallet 332 and masts 322 for guiding the rising and lowering movements of the forks 321 which are both disposed at forward positions of the vehicle main body 324, and a counterweight 323 which is disposed at a rearward position thereof. Furthermore, hydraulic cylinders 325 are provided so as to erect along the masts 322 which support the forks 321 vertically movably, and the forks 321 are constructed so as to be raised and/or lowered along the masts 322 as a lift unit 301 disposed in the interior of the vehicle main body 324 and using the hydraulic cylinders 325 as actuators or a hydraulic lift unit 301 is operated.

Additionally, a running motor 326 which can rotate clockwise and/or counterclockwise is disposed in the interior of the vehicle main body 324, and the vehicle main body 324 itself or forklift truck itself is moved forward and backward in longitudinal directions and turned by an electric running system 303 which uses the running motor 326 as an actuator. Furthermore, a forward distance S1 and a rearward distance S2 being covered by the vehicle main body 324 which is moving forward and rearward are being measured by a traveling distance measuring section 304 which is constituted by an up-down type measuring apparatus adapted to up-count the forward distance S1 of the vehicle main body 324 and down-count the rearward distance S2 thereof or a rotary encoder. Note that as this occurs, the forward distance S1 of the vehicle main body 324 is measured by regarding as an origin a stop point of the vehicle main body 324 which is at a stop immediately before the forks 321 are inserted into the rack shelf 330, and the rearward distance S2 is measured by regarding as an origin a stop point of the vehicle main body 324 which is at a stop in a state in which the forks 321 are inserted into the rack shelf 330 for carrying the cargo thereon.

Furthermore, disposed on the operator's instrument panel 327 are various types of manipulation levers for use in manually operating the lift unit 301 or the like, as well as an information section 305 and an alarm section 306 such as a liquid crystal display and a buzzer, and also disposed in the interior of the operator's instrument panel 327 is a controller 307 configured by making use of a microcomputer or a controller 307 for controlling in a united fashion operations of individual devices, as well as mutually coordinated operations between the individual devices and realizing a control of movements resulting in prohibiting the lowering movement of the forks 321. Note that in this fourth embodiment, the information section 305 and the alarm section 306 are those designed to function to notify the operating condition of the controller 307 to the outside, more specifically, to the operator.

In the forklift truck according to the fourth embodiment of the invention, a change-over switch (not shown) may be provided for determining whether or not a function of the controller 307 as a movement control section is executed or selecting the execution of operation of the movement control section or the prohibition of operation thereof, and in a case where a change-over switch like this is provided, it is a common practice to dispose the change-over switch on the operator's instrument panel 327.

Furthermore, in this case, the controller 307 is constituted by a memory unit 308 constituted by in turn a ROM or a RAM which stores various types of data and an arithmetic processing unit 309 constituted by a CPU. The memory unit 308 stores therein data on a vertical position constituting a reference for prohibiting the lowering movement of the forks 321 in loading or unloading a cargo, or data on a reference position H1. Here, note that the reference position H1 section a vertical position which is preset as a position to be reached by the forks 321 after considering the vertical position of the rack shelf 330 into which the cargo is stowed or the vertical position of the rack shelf 330 from which the cargo 331 is unloaded.

In addition, in the forklift according to the fourth embodiment of the invention, upper and lower allowable limits h1 are set in advance to which the forks 321 which are being at a vertical position H2 beyond the reference position H1 are permitted to rise or lower, and data on the upper and lower allowable limits h1 is also stored in the memory unit 308. Namely, in loading a cargo 331 on the forks 321, it is a common practice to move vertically the forks 321 over a small range, and as long as the actual vertical position H2 of the forks 321 is beyond the reference position H1, such fluctuations of the forks 321 over the small range would cause no inconvenience.

However, in the event that the upper and lower traveling limits h2 of the forks 321 are too large, there may be predicted a problem in unloading a cargo, and therefore, the upper and lower allowable limits h1 between which the forks 321 are permitted to be raised and lowered are set in advance, whereby the upper and lower traveling limits h2 of the forks 321 are regulated based on the upper and lower allowable limits h1 so set. Furthermore, the controller of the arithmetic processing unit 309 is adapted to determine whether or not the forks 321 are raised to a vertical position which is beyond the reference position H1, whether or not a forward movement of the vehicle main body 324 is started after the forks 321 have started to rise, and whether or not the forks 321 are raised and lowered within the preset upper and lower allowable limits h1.

Moreover, the arithmetic processing unit 309 not only determines whether or not a rearward distance S2 covered by the vehicle main body 324 which is moving rearward becomes equal to or greater than a forward distance S1 which has already been covered by the vehicle main body 324 but also continues to execute a control to prohibit the lowering movement of the forks 321 until the rearward distance S2 becomes equal to or greater than the forward distance S2. As shown in FIG. 12, to make that happen, various types of necessary signals are inputted into the controller 307 from the lift height detecting section 302, and the traveling distance measuring section 304, respectively, while signals designating operations of the lift unit 301 and the running system 303, the information section 305 and the alarm section 306 are designed to be outputted from the controller 307 to those devices, respectively.

Next, a control for a cargo unloading operation performed by the forklift truck according to the fourth embodiment of the invention will be described based on a flowchart shown in FIG. 13. Note that while in this fourth embodiment, only the control of an unloading operation using the forklift truck is described, a control for a loading operation performed by the forklift truck will basically be identical, and therefore, the description thereof will be omitted here.

First of all, when unloading cargoes, the operator moves the vehicle main body 324 closer in front of a rack shelf from which a cargo is to be unloaded, and thereafter the operator starts the operation of the lift unit 301 by manually manipulating a lift lever and allows the hydraulic cylinders 325 to extend in conjunction with the operation of the lift unit 301. Then, the forks 321 start their rising movement while being guided by the masts 322 (step 1), and the actual vertical position H2 of the rising forks 321 is detected by the lift height detecting section 302 (step 2).

Then, when the actual vertical position H2 of the forks 321 exceeds the reference position H1 (H1<H2) (step 3), as the operator operates the running system 303, the vehicle main body 324 is then driven forward (step 4), whereby the forks 321 are inserted into the rack shelf 330 on which the cargo 331 is stowed. However, as this occurs, since the vehicle main body 324 has started its forward movement after the forks 321 started their rising movement, a forward distance S1 that has been covered by the vehicle main body 324 by then is measured by the traveling distance measuring section 304 (step 5).

Furthermore, the cargo 331 set on a pallet 332 is then expected to be set on the forks 321 which have been inserted into the rack shelf 330, and as this occurs, the cargo 331 is set on the forks 321 while the forks 321 are being raised and lowered within the preset upper and lower allowable limits h1 (step 6). Namely, the vertical position H2 of the forks 321 which are being raised and lowered or fluctuated is also detected by the lift position detecting section 302, and the rising and lowering movements of the forks 321 continue to be allowed by the arithmetic processing unit 309 as long as the upper and lower traveling limits h2 of the forks 321 which are calculated based on the actual vertical position of the fluctuating forks 321, or h2≧h1.

Thereafter, the forks 321 on which the cargo 331 is set are moved backward so as to get out of the rack shelf 330 as the operator operates the running system 303 so as to move rearward the vehicle main body 324 (step 7), and as this occurs, since the vehicle main body 324 is started to move backward after the forks 321 are raised and lowered within the preset upper and lower allowable limits h1, the control to prohibit the lowering movement of the forks 321 is executed by the arithmetic unit 309 of the controller 307 (step 8). As the forks 321 move rearward, since the vehicle main body 324 has started to move rearward after the completion of its forward movement, the rearward distance S2 of the vehicle main body 324 is to be measured by the traveling distance measuring section 304 (step 9), and the arithmetic processing unit 309 continues to execute the control to prohibit the lowering movement of the forks 321 until the rearward distance that is being covered by the vehicle main body 324 becomes equal to or greater than the forward distance S1 that was covered by the vehicle main body 324 during its forward movement (step 10).

In other words, while the forks 321 are moving rearward, the arithmetic processing unit 309 of the controller 307 continues to determine whether or not the rearward distance S2 of the vehicle main body 324 becomes equal to or greater than the forward distance S1 (step 10), and as long as the rearward distance S2 do not become equal to or greater than the forward distance S1, or as long as S2<S1, the control to prohibit the rearward movement of the vehicle body 24, as well as the lowering movement of the forks 321 continues to be effective (steps 7 to 9). Then, the control to prohibit the lowering movement of the forks 321 is cancelled at a point in time where the arithmetic processing unit 309 determines that the rearward distance S2 of the vehicle main body 324 becomes equal to or greater than the forward distance Sl thereof (S1≦S2) (step 11).

Then, at and after this point in time, the forks 321 are allowed to be lowered below the reference position H1 by manually manipulating the lift lever to resume the operation of the lift unit 301 and allowing the hydraulic cylinders 325 to retract. Note that there is no particular reason or rationale for manually operating the lift lever in lowering the forks 321, and therefore, needless to say, a function may be imparted to the arithmetic unit 309 which is the movement control section of automatically starting the lowering movement of the forks 321 at the point in time where the rearward distance S2 of the vehicle main body 324 becomes equal to or greater than the forward distance S1 thereof.

While in the fourth embodiment, the control to prohibit the lowering movement of the forks 321 is described as being cancelled at the point in time where the arithmetic unit 309 of the controller 307 determines that the rearward distance S2 of the vehicle main body 324 becomes equal to or greater than the forward distance S1 thereof, it is needless to say that the arithmetic processing unit 309 which so determines the cancellation may be designed to execute such a movement control as to stop the rearward movement of the vehicle main body 324 at the same time. In addition, in the event that no rising and lowering movements of the forks 321 inserted into the rack shelf 330 occur in step 6, or, in the event that no rearward movement of the vehicle main body 324 occurs in step 7, it is considered that no normal unloading operation is being performed or that there occurs a failure, and it is practical to stop the execution of the control to prohibit the lowering movement of the forks 321 after a predetermined length of time has elapsed.

Additionally, although omitting a detailed description thereof here, a construction may be adopted in which an operating condition such as the start-up of the control to prohibit the lowering movement of the forks 321 or the continued rearward movement of the forks 321 is notified to the operator suitably with the information section 305 and the alarm section 306, and in a case where such a construction is adopted, an advantage can be secured that a misjudgment by the operator is difficult to occur. Note that the movement control to prohibit the lowering movement of the forks 321 is not always required throughout an unloading work using the forklift truck, and in a case where the lowering movement of the forks 321 does not have to be prohibited, it is needless to say that a construction may be adopted in which the prohibition of operation of the arithmetic processing unit 309 may be selected by making use of a change-over switch (not shown) disposed on the operator's instrument panel 327.

Fifth Embodiment

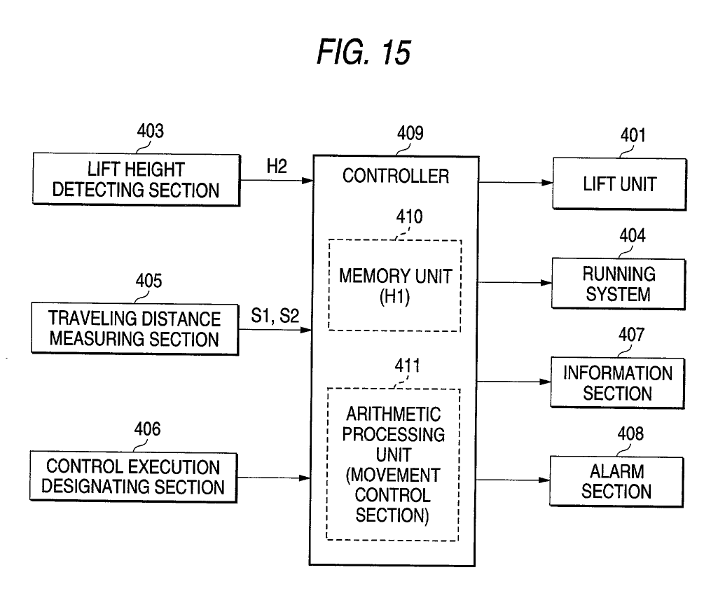

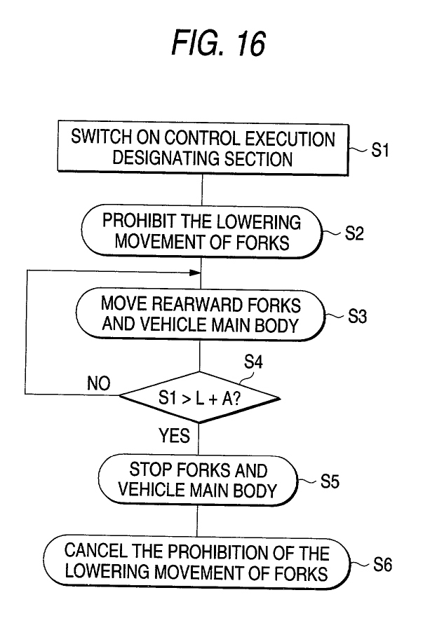

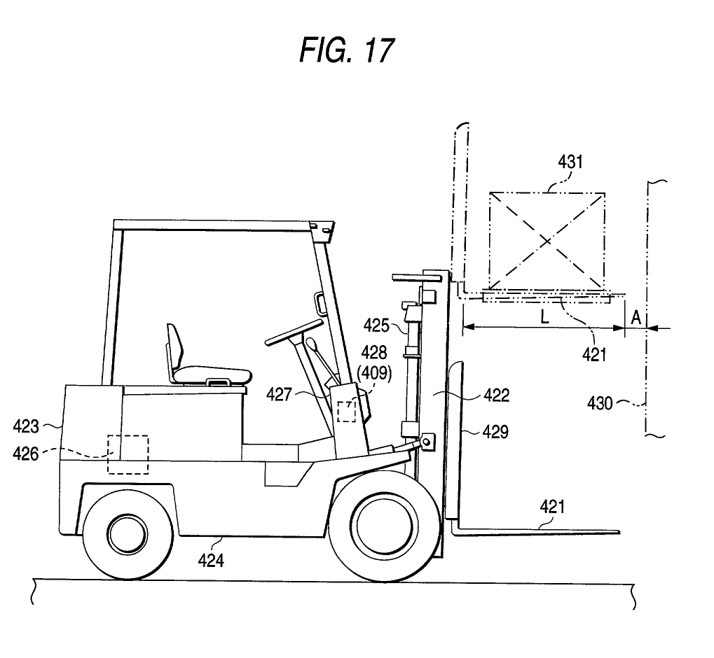

FIG. 15 is a block diagram showing a main part of a control system provided on a forklift truck according to a fifth embodiment of the invention, FIG. 16 is a flowchart showing a procedure of a control by the control system. Note that the forklift truck according to the fifth embodiment is a counterbalance forklift truck, and the overall construction thereof is basically similar to that of a prior art forklift truck of the same type shown in FIG. 17, and therefore, no specific drawing therefor being provided here, the overall construction of the forklift truck according to the fifth embodiment will be described while referring to FIG. 17.

As shown in FIGS. 15 and 17, the forklift truck according to the fifth embodiment of the invention comprises a vehicle main body 424 having forks 421 for carrying a cargo 431 set on a pallet and masts 422 for guiding the rising and lowering movements of the forks 421, which are both disposed at forward positions of the vehicle main body 424, and a counterweight 423, which is disposed at a rearward position thereof. Furthermore, hydraulic cylinders 425 are provided so as to erect along the masts 422 which support the forks 421 vertically movably, and the forks 421 are constructed so as to be raised and/or lowered while being guided by the masts as a lift unit 401 disposed in the interior of the vehicle main body 424 which uses the hydraulic cylinders 425 as actuators or a hydraulic lift unit 401 is operated. Note that the vertical position of the raised forks 421 is detected by making use of a lift height detecting section 403 such as a reel type potentiometer and a magnet sensor.

In addition, a running motor 426 which can rotate clockwise and counterclockwise is disposed in the interior of the vehicle main body 424, and the vehicle main body 424 itself or forklift truck itself is constructed so as to be moved forward and backward in longitudinal directions and turned by an electric running system 404 which uses the running motor 426 as an actuator. Furthermore, a forward distance and a rearward distance, in particular, the rearward distance S1 of the vehicle main body 424 is measured by using a traveling distance measuring section 405 constituted by making use of an up-down type measuring apparatus adapted to up-count the forward distance S1 of the vehicle main body 424 and down-count the rearward distance S2 thereof or a rotary encoder. Note that in unloading a cargo, the rearward distance of the vehicle main body 424 is designed to be measured by regarding as an origin a stop position of the vehicle main body which is at a stop with the forks 421 being inserted into a rack shelf 430.

Furthermore, disposed on the operator's instrument panel 427 are a plurality of manipulation levers or various types of manipulation levers which are manually manipulated in operating the lift unit 401 or the running system 404, as well as an information section 407 and an alarm section 408 such as a liquid crystal display and a buzzer. Moreover, disposed on the operator's instrument panel 427 is a switch functioning as a control execution designating section 406 for designating the control to prohibit the lowering movement of the forks, whereby the traveling distance measuring section 405 is designed to measure the rearward distance S1 of the vehicle main body 424 based on an ON signal outputted from the control execution designating section 406 or an ON signal designating the execution of the control to prohibit the lowering movement of the forks 421.

Moreover, also disposed in the interior of the operator's instrument panel 427 is a controller 409 configured by making use of a microcomputer or a controller 409 for controlling in a united fashion operations of individual devices, as well as mutually coordinated operations between the individual devices, and this controller 409 is constructed so as to include a memory unit 410 comprising a ROM or a RAM which stores various types of data and an arithmetic processing unit 411. The memory unit 410 constituting the controller 409 stores as data therein in advance a set distance (L+A) which is set by adding a surplus distance A measured in advance or a surplus distance A which should be secured between distal ends of the forks 421 and an outer surface of the rack shelf 430 when the forks 421 securely get out of the rack shelf 430 to the full length of the forks 421 themselves.

On the other hand, as this occurs, the arithmetic processing unit 411 determines whether or not the rearward distance S1 of the vehicle main body 424 measured by the traveling distance measuring section 405 exceeds the set distance (L+A) which is set by adding the surplus distance A to the full length L of the forks 421 and the arithmetic processing unit 411 also functions as a movement control section for prohibiting the lowering movement of the forks 421 until S1 exceeds L+A. To make this happen, as shown in FIG. 15, various types of operation signals and detection signals are inputted into the controller 409 from the lift height detecting section 403, the traveling distance measuring section 405 and the control execution designating section 406, respectively, while signals designating operations of the lift unit 401, the running system 404, the information section and the alarm section 408 are outputted from the controller 409 to those devices, respectively.

Next, a control for a cargo unloading operation performed by the forklift truck according to the fifth embodiment of the invention will be described based on the flowchart shown in FIG. 16. Note that while in this fifth embodiment, only the control of an unloading operation using the forklift truck is described, a control for a loading operation performed by the forklift truck will basically be identical, and therefore, the description thereof will be omitted here.

First of all, when unloading cargoes, the operator moves the vehicle main body 424 closer in front of a rack shelf 430 from which a cargo is to be unloaded, and thereafter the operator moves the vehicle main body 424 forward so as to insert the forks 421 into the rack shelf 430. Then, the forks 421 so inserted into the rack shelf are raised slightly so that a cargo 431 set on a pallet 432 is set on the forks 421, and thereafter, the control execution designating section 406 for designating the execution of the control to prohibit the lowering movement of the forks 421 or the control execution designating section 406 disposed on the operator's instrument panel 427 as a switch is switched on (step 1). Note that the vertical position of the forks 421 which are raised to be inserted into the rack shelf 430 is detected by making use of the lift height detecting section 403.

Then, the arithmetic processing unit 411 of the controller 409 into which an ON signal is inputted from the control execution designating section 406 is to be shifted to a mode for performing the control to prohibit the lowering movement of the forks 421 (step 2), and a signal to designate to execute a rearward movement is outputted from the arithmetic processing unit 411 to the running device 404. Following this, the vehicle main body 424 is then caused to move rearward by the running system 404, as a result of which the forks 421 are also caused to move rearward at the same time (step 3). Thereafter, the arithmetic processing unit 411 continues to prohibit the lowering movement of the forks 421 while determining whether or not the rearward distance S1 of the vehicle main body 424 which continues to be measured by the traveling distance measuring section 405 exceeds the set distance (L+A) which is set by adding the surplus distance A to the full length of the forks 421 (step 4).

When the arithmetic processing unit 411 determines that the rearward distance S1 of the vehicle main body 424 exceeds the set distance (L+A), a designating signal to stop the rearward movement of the vehicle main body 424 is outputted from the arithmetic processing unit 411 to the running system 404, whereby the rearward movement of the vehicle main body 424, as well as the rearward movement of the forks 421 are brought to a stop (step 5). In other words, the arithmetic processing unit 411 of the controller 409 functions as the movement control section for stopping the rearward movement of the vehicle main body 424 at a point in time where the rearward distance S1 of the vehicle main body 424 exceeds the set distance (L+A). In addition, the arithmetic processing unit 411 which determines that the rearward distance S1 of the vehicle main body 424 exceeds the set distance (L+A) cancels the control to prohibit the lowering movement of the forks 421 (step 6), and at and after this point in time, the forks 421 can be lowered by manually manipulating the lift lever.

Note that in lowering the forks 421 as done above, the manual manipulation of the lift lever is not always needed, and therefore, a function may be imparted to the arithmetic processing unit 411 which functions as the movement control section of automatically starting the forks 421 to be lowered at the point in time where the rearward distance S1 of the vehicle main body 424 exceeds the set distance (L+A) which is set by adding the surplus distance A to the full length L of the forks 421. In addition, while it is described as a control action taken as this occurs that the rearward movement of the vehicle main body 424 is stopped automatically, needless to say, it may be constructed such that only the lowering movement of the forks 421 is prohibited.

While in the control action according to the fifth embodiment of the invention, the control execution designating section 406 is described as being switched on through the manual operation, the control execution designating section 406 is not limited to that manually operated but the lift height detecting section 403 may be used instead for detecting that the forks 421 are at a vertical position which has a certain height or a height higher than that certain height. In other words, when the vehicle main body 424 starts to move rearward in a state in which the forks 421 are raised to a certain height or a height higher than the certain height, this fact is regarded as an unloading operation being performed, and a construction may be adopted in which the execution of the control actions described above may automatically be started.

Additionally, although omitting a detailed description thereof here, it may be desirable to adopt a construction in which when the prohibition of the lowering movement of the forks 421 is cancelled, the cancellation is informed to the operator using the information section 407 or when the operator tries to manually lower the forks 421 while the control to prohibit the lowering movement of the forks 421 is in operation, the operator is alarmed against such an attempt, and if these constructions are adopted, an advantage can be secured that a misjudgment by the operator is difficult to occur.

Sixth Embodiment

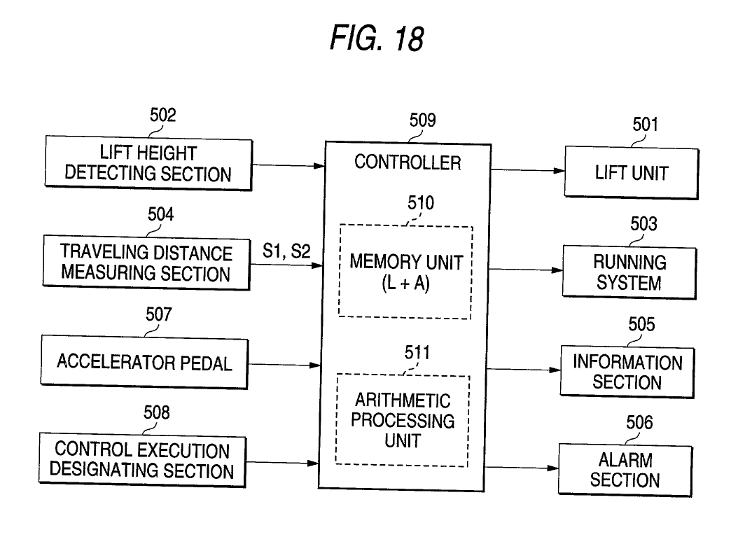

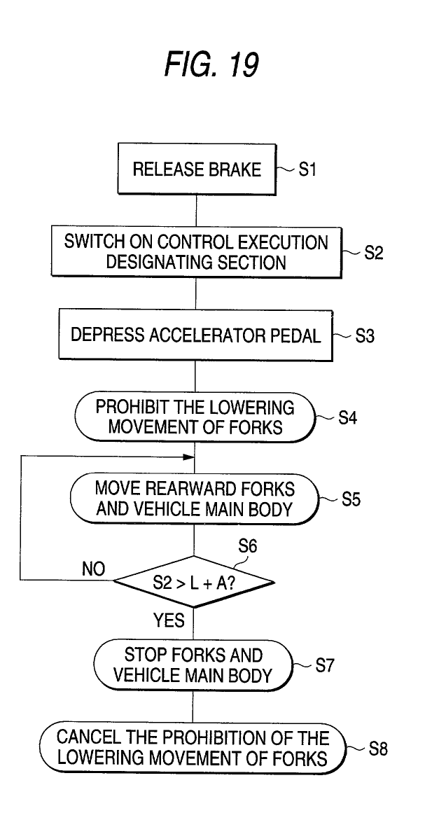

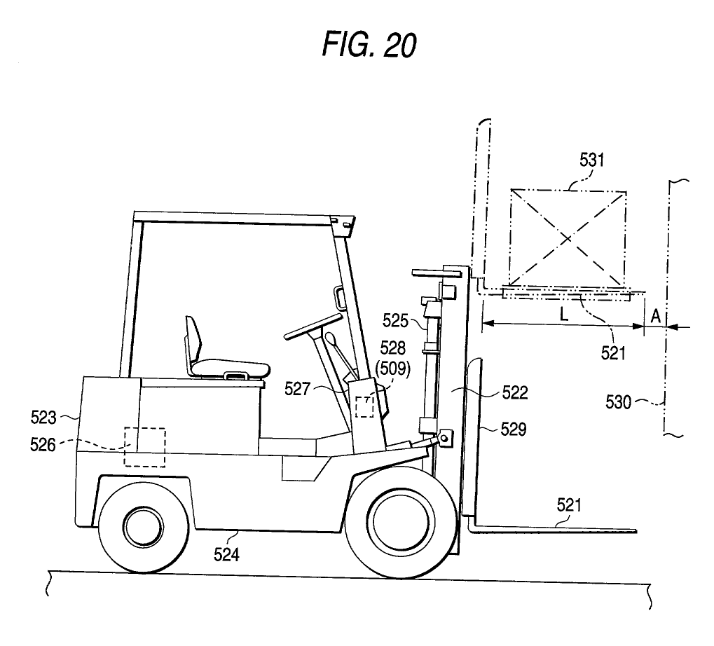

FIG. 18 is a block diagram showing a main part of a control system provided on a forklift truck according to a sixth embodiment of the invention, FIG. 19 is a flowchart showing a procedure of a control by the control system. Note that the forklift truck according to the sixth embodiment is a counterbalance forklift truck, and the overall construction thereof is basically similar to that of a prior art forklift truck of the same type shown in FIG. 20, and therefore, no specific drawing therefor being provided here, the overall construction of the forklift truck according to the sixth embodiment will be described while referring to FIG. 20.

As shown in FIGS. 18 and 20, the forklift truck according to the sixth embodiment of the invention comprises a vehicle main body 524 having forks 521 for carrying a cargo 531 set on a pallet and masts 522 for guiding the rising and lowering movements of the forks 521, which are both disposed at forward positions of the vehicle main body 524, and a counterweight 523, which is disposed at a rearward position thereof. Furthermore, hydraulic cylinders 525 are provided so as to erect along the masts 522 which support the forks 521 vertically movably, and the forks 521 are constructed so as to be raised and/or lowered while being guided by the masts as a lift unit 501 disposed in the interior of the vehicle main body 524 which uses the hydraulic cylinders 525 as actuators or a hydraulic lift unit 501 is operated. Note that the vertical position of the raised forks 521 is detected by making use of a lift height detecting section 503 such as a reel type potentiometer and a magnet sensor.

In addition, a running motor 526 which can rotate clockwise and counterclockwise is disposed in the interior of the vehicle main body 524, and the vehicle main body 524 itself or forklift truck itself is constructed so as to be moved forward and backward in longitudinal directions and turned by an electric running system 503 which uses the running motor 526 as an actuator. Furthermore, a forward distance S1 and a rearward distance S2 of the vehicle main body 524 is measured by using a traveling distance measuring section 504 constituted by making use of an up-down type measuring apparatus adapted to up-count the forward distance S1 of the vehicle main body 524 and down-count the rearward distance S2 thereof or a rotary encoder. Note that the forward distance S1 of the vehicle main body 524 is designed to be measured by regarding as an origin a stop position of the vehicle main body 524 which is at a stop immediately before the forks 521 are inserted into to a rack shelf 530, and the rearward distance S2 of the vehicle main body 524 is designed to be measured by regarding as an origin a stop position of the vehicle main body which is at a stop in a state in which the cargo 531 is set on the forks 521 which have been inserted into the rack shelf 530.

Furthermore, disposed on the operator's instrument panel 527 are a plurality of manipulation levers or various types of manipulation levers which are manually manipulated in operating the lift unit 501 or the running system 503, as well as an information section 505 and an alarm section 506 such as a liquid crystal display and a buzzer. In addition, disposed in the foot well below the operator's instrument panel 527 are brake and accelerator pedals which are used when the operator operates the running system 503 or the brake pedal for forcibly stopping the running movement of the vehicle main body 524 by the running system 503 and the accelerator pedal functioning as a speed regulating section for regulating the traveling speeds when the vehicle main body 524 moves forward and rearward, as well as a vehicle body movement starting section 507 for starting the forward and rearward movements of the vehicle main body 524.

Additionally, disposed on the operator's instrument panel 527 is a switch functioning as a control execution designating section 508 for designating the control to prohibit the lowering movement of the forks 521, and an ON signal outputted from the control execution designating section 508 or an ON signal for designating the execution of the control to prohibit the lowering movement of the forks 521 is designed to be inputted into a controller 509, which will be described later. When an ON signal outputted in conjunction with the depression of the accelerator pedal which is the vehicle body movement starting section 507 is inputted into the controller 509 together with the ON signal outputted from the control execution designating section 508, the traveling distance measuring section 504 is designed to start measuring the forward distance S1 and the rearward distance S2 of the vehicle main body 524.

Moreover, also disposed in the interior of the operator's instrument panel 527 is a controller 509 configured by making use of a microcomputer or a controller 509 for controlling in a united fashion operations of individual devices, as well as mutually coordinated operations between the individual devices, and this controller 509 is constructed so as to include a memory unit 510 comprising a ROM or a RAM which stores various types of data and an arithmetic processing unit 511. The memory unit 510 constituting the controller 509 stores as data therein in advance a set distance (L+A) which is set by adding a surplus distance A measured in advance or a surplus distance A which should be secured between distal ends of the forks 521 and an outer surface of the rack shelf 530 when the forks 521 securely get out of the rack shelf 530 to the full length of the forks 521 themselves.

On the other hand, as this occurs, the arithmetic processing unit 511 functions as a movement control section for prohibiting the lowering movement of the forks 521 until the rearward distance S2 measured by the traveling distance measuring section 504 exceeds the set distance (L+A) or the set distance (L+A) which is set by adding the surplus distance A to the full length L of the forks 521 and stopping the rearward movement of the vehicle main body 524 at the point in time where the rearward distance S2 of the vehicle main body 524 exceeds the set distance (L+A). To make this happen, as shown in FIG. 18, various types of operation signals and detection signals are inputted into the controller 509 from the lift height detecting section 502, the traveling distance measuring section 504, the vehicle body movement starting section 507 which is the accelerator pedal, and the control execution designating section 508, respectively, while signals designating operations of the lift unit 501, the running system 503, the information section, the information section 505 and the alarm section 506 are outputted from the controller 509 to those devices, respectively.

Next, a control for a cargo unloading operation performed by the forklift truck according to the sixth embodiment of the invention will be described based on the flowchart shown in FIG. 19. Note that while in this sixth embodiment, only the control of an unloading operation using the forklift truck is described, a control for a loading operation performed by the forklift truck will basically be identical, and therefore, the description thereof will be omitted here.

First of all, when unloading cargoes, the operator moves the vehicle main body 524 closer in front of a rack shelf 530 from which a cargo is to be unloaded, and thereafter the operator moves the vehicle main body 524 forward so as to insert the forks 521 into the rack shelf 530. Then, the forks 521 so inserted into the rack shelf are raised slightly so that a cargo 531 is set on the forks 521, and thereafter, the operator releases the brake which is forcibly stopping the operation of the running system 503 (step 1) and then switches on the control execution designating section 508 for designating the execution of the control to prohibit the lowering movement of the forks 521 or the control execution designating section 508 which is disposed on the operator's instrument panel 527 as the switch (step 2). Note that the vertical position of the forks 521 which are raised to be inserted into the rack shelf 530 is detected by making use of the lift height detecting section 502.

Furthermore, when the operator depresses the accelerator pedal in order to move the vehicle main body rearward, an ON signal is outputted from the vehicle body movement starting section 507 which is the accelerator pedal so depressed (step 3), and ON signals are inputted into the controller 509 from the vehicle body movement starting section 507 and the control execution designating section 508, respectively. Then, the arithmetic processing unit 511 of the controller 509 into which those ON signals are inputted is shifted so as to execute the control to prohibit the lowering movement of the forks 521 (step 4), whereby a signal is outputted from the arithmetic processing unit 511 to the running system 503 which designates to start to move rearward.

Then, the vehicle main body 524 is caused to move rearward by the running system 503 which is designated to start the rearward movement, whereby the forks 521 are also caused to move rearward together with the vehicle main body 524 (step 5). Due to this, the traveling distance measuring section 504 is caused to start measuring the rearward distance S2 of the vehicle main body 524, and, the arithmetic processing unit 511 of the controller 509 continues to determine whether or not the rearward distance S2 of the vehicle main body 524 which is measured by the traveling distance measuring section 504 exceeds the set distance (L+A) which is set by adding the surplus distance A to the full length L of the forks 521 while prohibiting the lowering movement of the forks 521 (step 6).

When the arithmetic processing unit 511 determines that the rearward distance S2 of the vehicle main body 524 exceeds the set distance (L+A), a designating signal to stop the rearward movement of the vehicle main body 524 is outputted from the arithmetic processing unit 511 to the running system 503, whereby the rearward movement of the vehicle main body 524, as well as the rearward movement of the forks 521 are brought to a stop (step 7). In other words, the arithmetic processing unit 511 of the controller 509 functions as the movement control section for automatically stopping the rearward movement of the vehicle main body 524 at a point in time where the rearward distance S2 of the vehicle main body 524 exceeds the set distance (L+A) In addition, the arithmetic processing unit 511 which determines that the rearward distance S2 of the vehicle main body 524 exceeds the set distance (L+A) cancels the control to prohibit the lowering movement of the forks 521 (step 8), and at and after this point in time, the forks 521 can be lowered by manually manipulating the lift lever.

While in the control action according to the sixth embodiment of the invention, the control execution designating section 508 is described as being switched on through the manual operation, the control execution designating section 508 is not limited to the one which is manually operated but the lift height detecting section 502 may be used instead for detecting that the forks 521 are at a vertical position which has a certain height or a height higher than that certain height. In other words, when the vehicle main body 524 starts to move rearward in a state in which the forks 521 are raised to a certain height or a height higher than the certain height, this fact is regarded as an unloading operation being performed, and a construction may be adopted in which the execution of the control actions described heretofore in the sixth embodiment of the invention may automatically be started.

Additionally, although omitting a detailed description thereof here, it may be desirable to adopt a construction in which when the prohibition of the lowering movement of the forks 521 is cancelled, the cancellation is informed to the operator using the information section 505 or when the operator tries to manually lower the forks 521 while the control to prohibit the lowering movement of the forks 521 is in operation, the operator is alarmed against such an attempt through the alarm section 506, and if these constructions are adopted, an advantage can be secured that a misjudgment by the operator is difficult to occur.

Seventh Embodiment

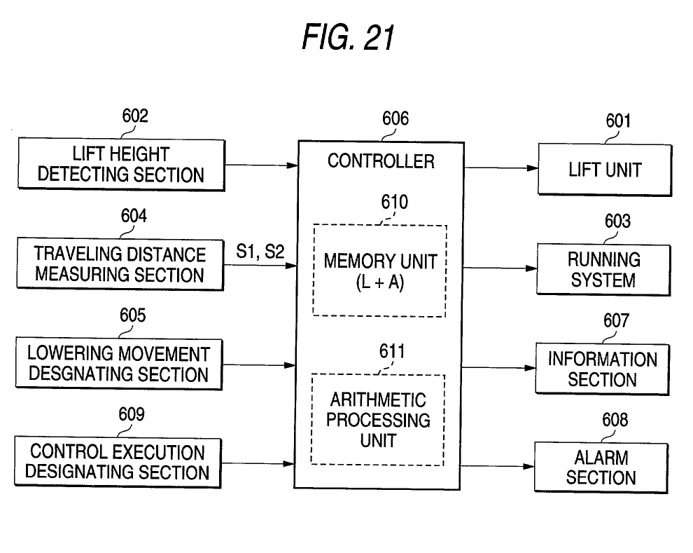

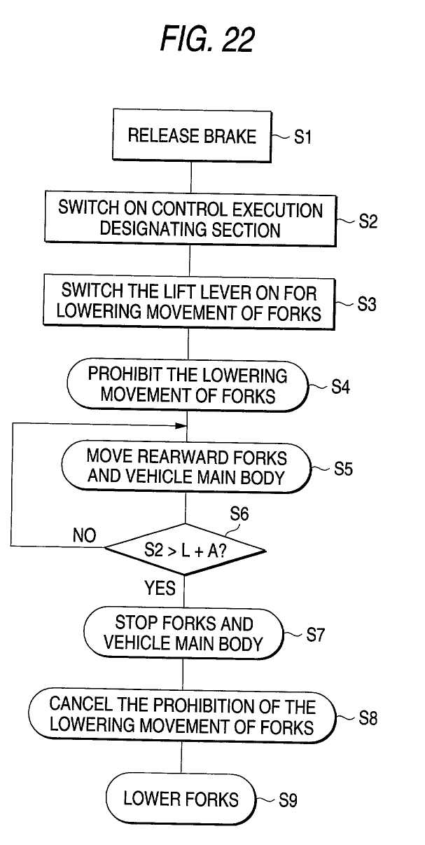

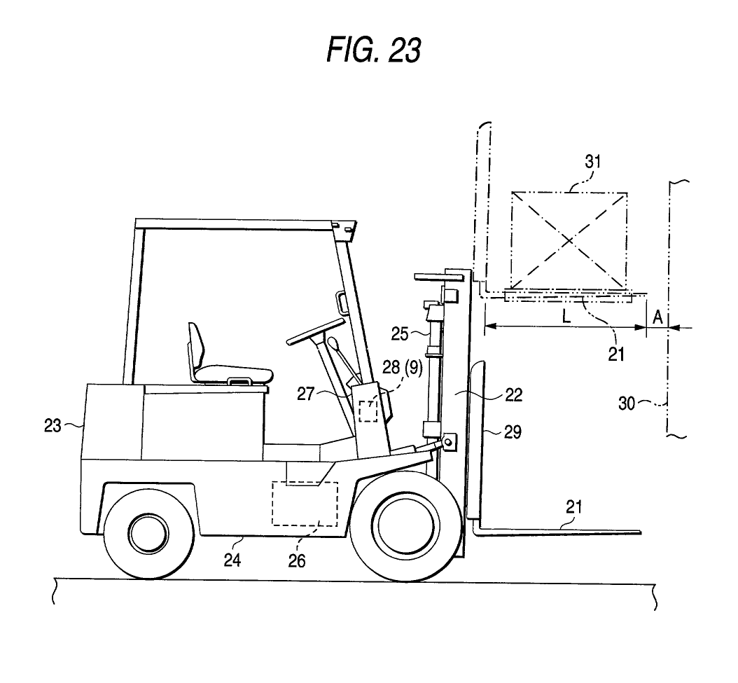

FIG. 21 is a block diagram showing a main part of a control system provided on a forklift truck according to a seventh embodiment of the invention, and FIG. 22 is a flowchart showing a procedure of a control by the control system. Note that the forklift truck according to the seventh embodiment is a counterbalance forklift truck, and the overall construction thereof is basically similar to that of a prior art forklift truck of the same type shown in FIG. 23, and therefore, no specific drawing therefor being provided here, the overall construction of the forklift truck according to the seventh embodiment will be described while referring to FIG. 23.

As shown in FIGS. 21 and 23, the forklift truck according to the seventh embodiment of the invention comprises a vehicle main body 624 having forks 621 for carrying a cargo 631 set on a pallet and masts 622 for guiding the rising and lowering movements of the forks 621, which are both disposed at forward positions of the vehicle main body 624, and a counterweight 623, which is disposed at a rearward position thereof. Furthermore, hydraulic cylinders 625 are provided so as to erect along the masts 622 which support the forks 621 vertically movably, and the forks 621 are constructed so as to be raised and/or lowered while being guided by the masts 622 as a lift unit 601 disposed in the interior of the vehicle main body 624 which uses the hydraulic cylinders 625 as actuators or a hydraulic lift unit 601 is operated. Note that the vertical position of the raised forks 621 is detected by making use of a lift height detecting section 602 such as a reel type potentiometer and a magnet sensor.

In addition, a running motor 626 which can rotate clockwise and counterclockwise is disposed in the interior of the vehicle main body 624, and the vehicle main body 624 itself or forklift truck itself is constructed so as to be moved forward and backward in longitudinal directions and turned by an electric running system 603 which uses the running motor 626 as an actuator. Furthermore, a forward distance S1 and a rearward distance S2 of the vehicle main body 624 moving forward and backward is measured by using a traveling distance measuring section 604 constituted by making use of an up-down type measuring apparatus adapted to up-count the forward distance S1 of the vehicle main body 624 and down-count the rearward distance S2 thereof or a rotary encoder. Note that the forward distance S1 of the vehicle main body 624 is designed to be measured by regarding as an origin a stop position of the vehicle main body 624 which is at a stop immediately before the forks 621 are inserted into to a rack shelf 630, and the rearward distance S2 of the vehicle main body 624 is designed to be measured by regarding as an origin a stop position of the vehicle main body which is at a stop in a state in which the cargo 631 is set on the forks 621 which have been inserted into the rack shelf 630.

Furthermore, disposed on the operator's instrument panel 627 are a plurality of manipulation levers including a lift lever 628 which is manually manipulated in raising and lowering the forks 621 and functions as a lowering movement designating section 605 for designating the lowering movement of the forks 621 or various types of manipulation levers which are manipulated in operating the lift unit 601 or the running system 603. The lift lever 628 functioning as the lowering movement designating section 605 is designed to output an ON signal in conjunction with the manual manipulation for lowering the forks 621, and the ON signal so outputted from the lift lever 628 enters a controller 606, which will be described later. Note that although not shown, brake and accelerator pedals are disposed in the foot well below the operator's instrument panel 627 for use when the running system 603 is operated.

Additionally, disposed on the operator's instrument panel 627 are an information section 607 and an alarm section 608 such as a liquid crystal display and a buzzer for notifying a status in which the control is executed to the operator, as well as a switch functioning as a control execution designating section 609 for designating the execution of the control to prohibit the lowering movement of the forks 621, and an ON signal outputted from the control execution designating section 609 or an ON signal for designating the execution of the control to prohibit the lowering movement of the forks 621 is designed to be inputted into a controller 606. In a case where an ON signal outputted from the control execution designating section 609 enters the controller 606 together with an ON signal outputted from the lift lever 628 which is the lowering movement designating section 605, the traveling distance measuring section 604 is designed to measure both the forward distance S1 and the rearward distance S2 of the vehicle main body 624.

Moreover, also disposed in the interior of the operator's instrument panel 627 is a controller 606 configured by making use of a microcomputer or a controller 606 for controlling in a united fashion operations of individual devices, as well as mutually coordinated operations between the individual devices, and this controller 606 is constructed so as to include a memory unit 610 comprising a ROM or a RAM which stores various types of data and an arithmetic processing unit 611. The memory unit 610 constituting the controller 606 stores as data therein in advance a set distance (L+A) which is set by adding a surplus distance A measured in advance or a surplus distance A which should be secured between distal ends of the forks 621 and an outer surface of the rack shelf 630 when the forks 621 securely get out of the rack shelf 630 to the full length of the forks 621 themselves.

On the other hand, the arithmetic processing unit 611 of the controller 606 functions as a movement control section for prohibiting the lowering movement of the forks 621 until the rearward distance S2 measured by the traveling distance measuring section 604 exceeds the set distance (L+A) or the set distance (L+A) which is set by adding the surplus distance A to the full length L of the forks 621 and executing the control to lower the forks 621 at the point in time where the rearward distance S2 of the vehicle main body 624 exceeds the set distance (L+A). To make this happen, as shown in FIG. 21, various types of operation signals and detection signals are inputted into the controller 606 from the lift height detecting section 602, the traveling distance measuring section 604, the lowering movement designating section 605 which is the lift lever 628, and the control execution designating section 609, respectively, while signals designating operations of the lift unit 601, the running system 603, the information section 607, and the alarm section 608 are outputted from the controller 606 to those devices, respectively.

As this occurs, while the arithmetic processing unit 611 executes the control to prohibit the lowering movement of the forks 621 until the rearward distance S2 of the vehicle main body 624 exceeds the set distance (L+A) and lower the forks 621 at the point in time where the rearward distance S2 of the vehicle main body 624 exceeds the set distance (L+A), a function may, of course, be provided of automatically stopping the rearward movement of the vehicle main body 624 at the point in time where the rearward distance S2 of the vehicle main body 624 exceeds the set distance (L+A). In addition, in the seventh embodiment of the invention, while the control execution designating section 609 is described as being switched on through a manual operation, the control execution designating section 609 is not limited to the one which is manually operated but the lift height detecting section 602 for detecting that the forks 621 are at a vertical position which has a certain height or a height higher than that certain height may be used instead for automatically switching on the control execution designating section 609. In other words, it may be constructed such that when the vehicle main body 624 starts to move rearward in a state in which the forks 621 are raised to a certain height or a height higher than the certain height, the arithmetic processing unit 611 determines from this that an unloading operation is being performed and determines that the execution of the control is automatically designated.

Next, a control for a cargo unloading operation performed by the forklift truck according to the seventh embodiment of the invention will be described based on the flowchart shown in FIG. 22. Note that while in this seventh embodiment, only the control of an unloading operation using the forklift truck is described, a control for a loading operation performed by the forklift truck will basically be identical, and therefore, the description thereof will be omitted here.

First of all, when unloading cargoes, the operator moves the vehicle main body 624 closer in front of a rack shelf 630 from which a cargo is to be unloaded, and thereafter the operator moves the vehicle main body 624 forward so as to insert the forks 621 into the rack shelf 630. Then, the forks 621 so inserted into the rack shelf are raised slightly so that a cargo 631 is set on the forks 621, and thereafter, the operator releases the brake which is forcibly stopping the operation of the running system 603 (step 1) and then switches on the control execution designating section 609 for designating the execution of the control to prohibit the lowering movement of the forks 621 or the control execution designating section 609 which is disposed on the operator's instrument panel 627 as the switch (step 2). Note that the vertical position of the forks 621 which are raised to be inserted into the rack shelf 630 is detected by making use of the lift height detecting section 602.

Furthermore, the operator manually operates the lift lever 628 functioning as the lowering movement designating section 605 to a side where the lowering movement of the forks 621 is effected (step 3). Then, an ON signal is outputted from the lift lever 628 which is the lowering movement designating section 605, and ON signals are then inputted into the controller 606 from the lowering movement designating section 605 and the control execution designating section 609, respectively. Then, the arithmetic processing unit 611 of the controller into which those ON signals are inputted is shifted so as to effect the control to prohibit the lowering movement of the forks 621 (step 4), and as this occurs, a designating signal to start the rearward movement of the vehicle main body 624 is outputted from the arithmetic processing unit 611 to the running system 603.

As a result, the vehicle main body 624 is caused to move rearward by the running system 603 which is designated to start the rearward movement, whereby the forks 621 are also caused to move rearward together with the vehicle main body 624 (step 5). Then, the traveling distance measuring section 604 is caused to start measuring the rearward distance S2 of the vehicle main body 624, and the arithmetic processing unit 611 of the controller 606 continues to determine whether or not the rearward distance S2 of the vehicle main body 624 which is measured by the traveling distance measuring section 604 exceeds the set distance (L+A) which is set by adding the surplus distance A to the full length L of the forks 621 while prohibiting the lowering movement of the forks 621 (step 6).

When the arithmetic processing unit 611 determines that the rearward distance S2 of the vehicle main body 624 exceeds the set distance (L+A), a designating signal to stop the rearward movement of the vehicle main body 624 is outputted from the arithmetic processing unit 611 to the running system 603, whereby the rearward movement of the vehicle main body 624, as well as the rearward movement of the forks 621 are brought to a stop (step 7). In other words, the arithmetic processing unit 611 of the controller 606 functions as to stop the rearward movement of the vehicle main body 624 at the point in time where the rearward distance S2 of the vehicle main body 624 exceeds the set distance (L+A).

In addition, the arithmetic processing unit 611 of the controller 606 cancels the control to prohibit the lowering movement of the forks 621 (step 8) at the same time, and a designating signal to execute the lowering movement of the forks 621 is outputted from the arithmetic processing unit 611 to the lift unit 601. As this occurs, with assistance of the fact that the lift lever 628 has already been shifted to the side where the lowering movement of the forks 621 occurs, the forks 621 continue to be lowered by the lift unit 601 into which the designating signal is so inputted (step 9). In other words, as this occurs, the arithmetic processing unit 611 is designed to start functioning to lower the forks 621 at the point in time where the rearward distance S2 of the vehicle main body 624 exceeds the set distance (L+A).

Additionally, although omitting a detailed description thereof here, it may be desirable to adopt a construction in which when the prohibition of the lowering movement of the forks 621 is cancelled, the cancellation is informed to the operator using the information section 607 or when the operator tries to manually lower the forks 621 while the control to prohibit the lowering movement of the forks 621 is in operation, the operator is alarmed against such an attempt through the alarming section 8, and if these constructions are adopted, an advantage can be secured that a misjudgment by the operator is difficult to occur.

Eighth Embodiment

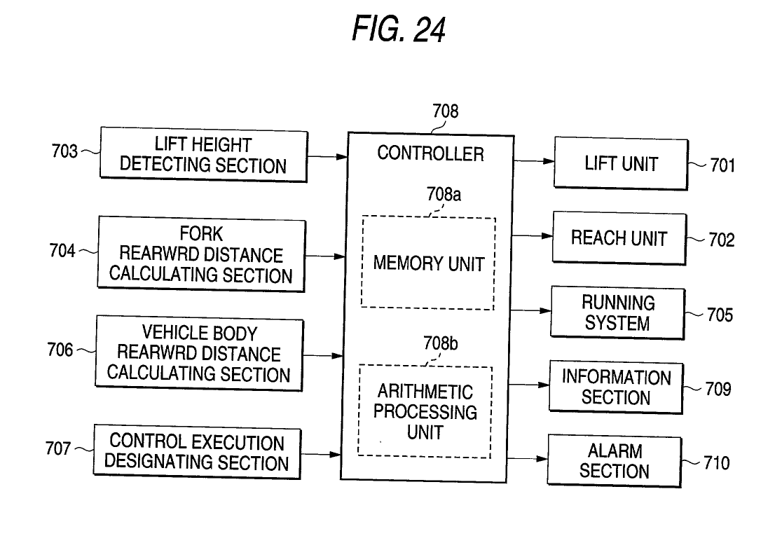

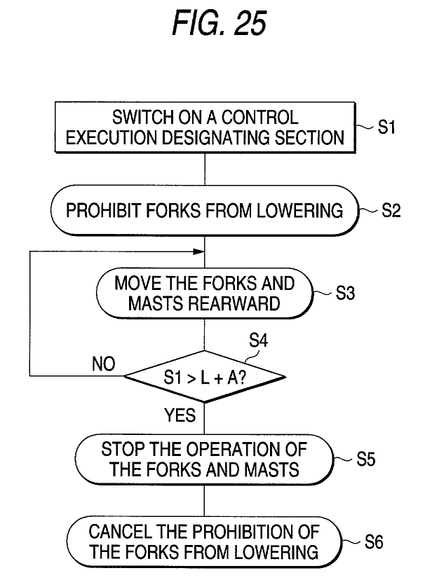

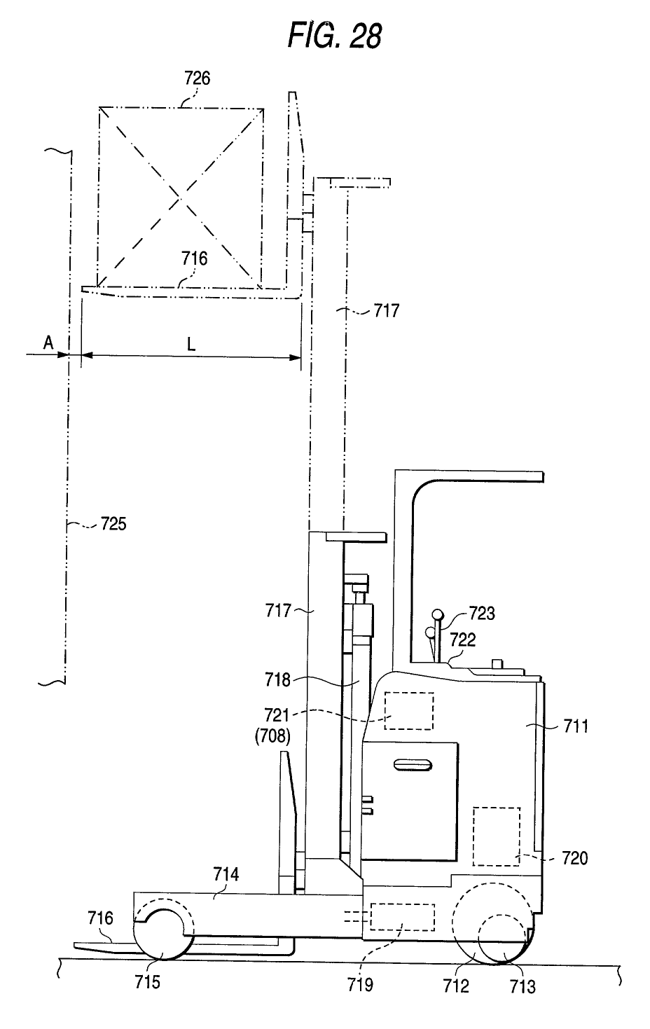

FIG. 24 is a block diagram showing a main part of a control system equipped on a reach forklift truck according to an eighth embodiment of the invention, and FIGS. 25 to 27 are flowcharts showing first to third control operations, respectively. Note that the overall construction of the reach forklift truck according to the eighth embodiment is basically the same as that of a conventional mode shown in FIG. 28, and therefore, a specific drawing therefor being omitted here, the overall construction of the reach forklift truck will be described below with reference to FIG. 28.

As shown in FIGS. 24 and 28, the reach forklift truck of the eighth embodiment is constructed such that drive tires 712 and the caster tires 713 are disposed at a rear portion of a vehicle body 711, while provided at a front portion of the vehicle body 711 is a pair of straddle arms which extend forward therefrom. Load tires 715 are disposed at distal end positions of the respective straddle arms 714. Additionally, masts 717 for guiding rising and lowering movements of forks 716 are provided at positions inside the respective straddle arms 714 so as to erect therefrom.

In addition, these forks 716 and masts 717 are adapted to be raised and lowered using a lift unit 701 which uses as actuators hydraulic cylinders 718 provided so as to erect along the masts 717, while the forks 716 and masts 717 are adapted to move forward and backward, while being guided by the straddle arms 714, using a reach unit 702 which uses as actuators hydraulic cylinders 719 installed in the vehicle body 711. Note that it is desirable that the vertical position of the raised forks 716 is constructed to be detected using a lift height detecting section 703 such as a reel type potentiometer or a magnet sensor.

A forward distance and a rearward distance S1 of the forks 716 and the masts 717 when operated as described above are calculated using a distance measuring apparatus. Namely, at least a rearward distance of the forks 716 and the masts 717 which has started to move rearward after completion of a forward movement is calculated by using a fork rearward distance calculating section 704 located at a position where forward and rearward movements of the forks 716 and the masts 717 can be detected, for example, a fork rearward distance calculating section 704 which is a distance measuring apparatus such as reel type potentiometer or a rotary encoder which is connected to the masts 717 via wires.

On the other hand, the vehicle body of the reach forklift truck is constructed to move forward and rearward and turn as a running motor 720 constituting a running system 705 is driven to rotate clockwise or counterclockwise, and a forward distance and a rearward distance of the vehicle body 711 are also calculated by a distance measuring apparatus. As this occurs, in particular, a rearward distance S2 of the vehicle body 711 which has started to move rearward after the completion of a forward movement of the forks 716 which are being raised is designed to be calculated with a vehicle body rearward distance calculating section 706, and a distance measuring apparatus such as a rotary encoder disposed in the vicinity of the running motor 720 is designed to function as the vehicle body rearward distance calculating section 706.

Furthermore, disposed on a control panel 722 located in the vicinity of an operator's seat provided on the vehicle body 711 of the reach forklift truck so that an operator is seated thereon are a plurality of operation levers including a lift lever 723, or various types of operation levers for use in manually operating each of the lift unit 701, the reach unit 702 and the running system 705 as required, as well as an information section 709 and an alarm section 710 such as a liquid crystal display and a buzzer, while disposed in a foot well under the operator's seat are a brake pedal for forcibly stopping the running movement activated by the running system 705 and an accelerator pedal for increasing the speed of the running motor 720 (both the pedals being not shown). Disposed on or built in any of the control panel 722, the lift lever 723 and the accelerator pedal is a control execution designating section 707 which is a switch that is manually operated in designating the start of the execution of control to prohibit the lowering movement of the forks 716.

Moreover, disposed in the interior of the vehicle body 711 is a controller 708 configured using a microcomputer or a controller 708 for controlling in a united fashion individual and coordinated operations of various types of devices equipped on the reach forklift truck, and this controller 708 is constructed to include a memory unit 708a comprising ROM and RAM for storing various types of data and an arithmetic processing unit 708b comprising a CPU. Stored as data in advance in the memory unit 708a constituting the controller 708 is a set distance [L+A] set by adding an extra distance A measured in advance or an extra distance A which is to be secured between the distal ends of the forks 716 and an external face of a rack 725 when the forks 716 assuredly get out of the rack 725 and the overall length L of the forks 716.

On the other hand, the arithmetic processing unit 708b determines whether or not a rearward distance S1 of the forks 716 and the masts 717 which is calculated with the fork rear distance calculating section 704 exceeds the set distance [L+A] set by adding the overall length L of the forks 716 and the extra distance A and functions as the control operation executing section for prohibiting the forks 716 from lowering until S1 exceeds L+A. Alternatively, the arithmetic processing unit 708b determines whether or not a total rearward distance [S1+S2] calculated by adding the rearward distance S1 of the forks 716 and the masts 717 and a rearward distance S2 of the vehicle body 711 exceeds the set distance [L+A] set by adding the overall length L of the forks 716 and the extra distance A and functions as the control operation executing section for prohibiting the forks 716 from lowering until S1+S2 exceeds L+A.

To make this happen, various types of required signals are inputted into the arithmetic processing unit 708b of the controller 708 from the lift height detecting section 703, the fork rearward distance calculating section 704, the vehicle rearward distance calculating section 706 and the control execution designating section 707, respectively, and on the contrary, signals for designating respective operations of the lift unit 701 and the reach unit 702, the running system 705, the information section 709 and the alarm section 710 are outputted from the arithmetic processing unit 708b to those devices.

Next, control operations for cargo unloading work executed by the reach forklift truck according to the eighth embodiment of the invention will be described. First of all, a first control operation thereof will be described based on the flowchart shown in FIG. 25. Note that while the following description describes a control operation for cargo unloading work executed by the reach forklift truck, a control operation for cargo loading work is almost identical, and therefore, the description of the control operation for cargo loading will be omitted here.

Namely, in the first control operation, first, the operator of the reach forklift truck advances the forks 716 together with the masts 717, so that the forks 716 are inserted into a pallet (not shown) on a shelf of the rack 725. Then, the forks 716 so inserted are slightly raised so that a cargo 26 placed on the pallet are set on the forks 716, and thereafter, the control execution designating section 707 for designating the execution of control to prohibit the lowering movement of the forks 716 is switched on. That is, for example, in a case where the control execution designating section 707 is disposed on the control panel 722 as a switch, the operator manually switches on the switch (step 1).

Then, an ON signal from the control execution designating section 707 enters the arithmetic processing unit 708b, which shifts its control to prohibit the forks 716 from lowering (step 2), and a signal for designating the start of the rearward movement of the forks 716 and the masts 717 is outputted from the arithmetic processing unit 708b which has so shifted its control to the reach unit 702, as a result of which the forks 716 and the masts 717 automatically start to move rearward (step 3). Thereafter, the arithmetic processing unit 708b compares a rearward distance S1 of the forks 716 and the masts 717 calculated by the fork rearward distance calculating section 704 with the set distance [L+A] stored in advance in the memory unit 708a of the controller, or the set distance [L+A] set by adding the overall length L of the forks 716 and the extra distance A and continues to prohibit the lowering movement of the forks 716 while determining whether or not the rearward distance S1 exceeds the set distance [L+A] (step 4). Therefore, even if the lift lever 723 is manually operated during the aforesaid control by the arithmetic processing unit 708b, the lowering movement of the forks 716 is designed not to be effected.

Then, the arithmetic processing unit 708b determines that the rearward distance S1 of the forks 716 and the masts 717 has exceeded the set distance [L+A], a signal for designating the stop of the rearward movement of the forks and masts is outputted from the arithmetic processing unit 708b to the reach unit 702, as a result of which the rearward movement of the forks 716 and the masts 717 is automatically stopped (step 5). In other words, as this occurs, the arithmetic processing unit 708b of the controller 708 functions to stop the operation of the reach unit 702 at a point in time where the rearward distance S1 of the forks 716 and the masts 717 has exceeded the set distance [L+A] set by adding the overall length L of the forks 716 and the extra distance A.

In addition, in the arithmetic processing unit 708b which has come to the aforesaid determination, the control to prohibit the forks 716 from lowering is cancelled (step 6), and at and after this point in time the forks 716 are allowed to be lowered by manually operating the lift lever 723. Note that the manual operation of the lift lever 723 is not always required in lowering the forks 716, and the arithmetic processing section 8b which is the control operation executing section may be provided in advance with a function for starting the lowering movement of the forks 716 at the point in time where the rearward distance S1 of the forks 716 and the masts 717 has exceeded the set distance [L+A] set by adding the overall length L of the forks 716 and the extra distance A.

In the first control operation described heretofore, while the forks 716 and the masts 717 automatically start to move rearward by switching on the control execution designating section 707 and the forks 716 and the masts 717 automatically stop to move rearward at the point in time where the rearward distance S1 of the forks 716 and the masts 717 has exceeded the set distance [L+A], but a series of operations like this is not always required, and therefore, it goes without saying that the control to prohibit the forks 716 from lowering may merely be constructed to be executed.

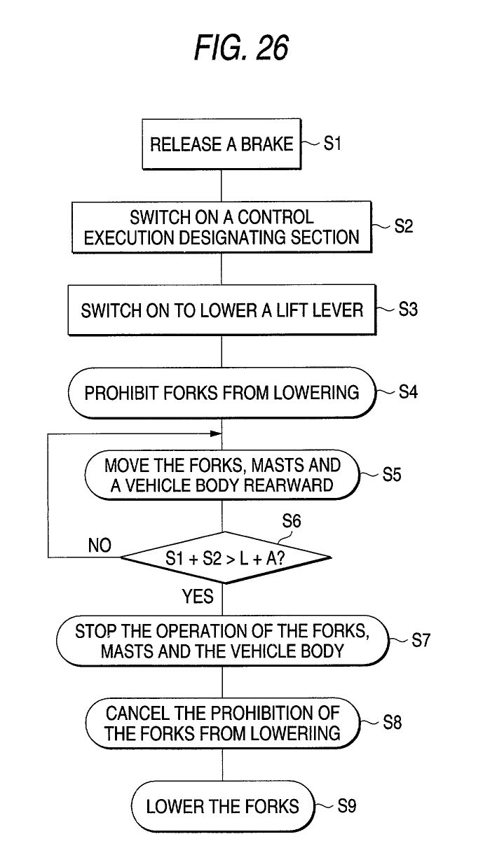

Next, a second control operation will be described based on the flowchart shown in FIG. 26. Namely, first, having completed the placement of a cargo on a pallet on the forks 716 which are inserted into a shelf of the rack 725 which is located at a higher position, the operator releases the brake which is forcibly stopping the running operation of the running system 705 (step 1), thereafter, switches on the switch which is the control execution designating section 707 for designating the execution of control to prohibit the forks 716 from lowering and manually operates the lift lever 723 to a lowering side (steps 2,3). Then, an ON signal from the control execution designating section 707 enters the arithmetic processing unit 8a of the controller 708, which shifts its control to prohibit the forks 716 from lowering (step 4), and as this occurs, a signal for designating the rearward movement is outputted from the arithmetic processing unit 708b to the reach unit 702, while a signal for designating the start of the rearward movement of the vehicle body 711 is outputted from the arithmetic processing unit 708b to the running system 705.

As a result of that, the vehicle body 711 is caused to move rearward by the running system 705 at the same time as the forks 716 and the masts 717 are caused to move rearward by the reach unit 702 (step 5). Thereafter, the arithmetic processing unit 708b continues to prohibit the lowering movement of the forks 716 while determining whether or not the total rearward distance [S1+S2] calculated by adding the rearward distance S1 of the forks 716 and the masts 717 which is calculated by the fork rearward distance calculating section 704 and the rearward distance S2 of the vehicle body 711 which is calculated by the vehicle body rearward distance calculating section 706 exceeds the set distance [L+A] set by adding the overall length L of the forks 716 and the extra distance A (step 6).

Then, having determined that the total rearward distance [S1+S2] so calculated has exceeded the set distance [L+A], the arithmetic processing unit 708b outputs a signal for designating the stop of the rearward movement of the forks 716 and the masts 717 to the reach unit 702 and a signal for designating the stop of the rearward movement of the vehicle body 711 to the running system 705, respectively, whereby both the rearward movement of the forks 716 and the masts 717 and the rearward movement of the vehicle body 711 are stopped (step 7). In other words, here, the arithmetic processing unit 8 functions to stop the operations of the reach unit 702 and the running system 705 at the point in time where the total rearward distance [S1+S2] calculated by adding the rearward distance S1 of the forks 716 and the masts 717 and the rearward distance S2 of the vehicle body 711 exceeds the set distance [L+A] set by adding the overall length L of the forks 716 and the extra distance A.

Note that while in the second control operation both the reach unit 702 and the running system 705 are constructed so as to automatically start operating by switching on the control execution designating section 707 and both the reach unit 702 and the running system 705 are constructed so as to automatically stop operating at the point in time where the total rearward distance [S1+S2] exceeds the set distance [L+A], the operation thereof is not always required to automatically start and stop, but it may be constructed such that the control to prohibit the forks 716 from lowering is merely executed, or that the operation of the reach unit 702 and the running system 705 automatically stops while they start to operate through a manual operation of the operator.

In addition, in the arithmetic processing unit 708b, the control to prohibit the forks 716 from lowering is cancelled at the same time (step 8), and since the lift lever 723 has been operated in advance to the lowering side, the forks 716 and the masts 717 automatically start to lower (step 9). That is, as this occurs, the arithmetic processing unit 708b of the controller 708 functions to allow the forks 716 to start lowering at the point in time where the total rearward distance [S1+S2] calculated by adding the rearward distance S1 of the forks 716 and the masts 717 and the rearward distance S2 of the vehicle body 711 exceeds the set distance [L+A] set by adding the overall length L of the forks 716 and the extra distance A.

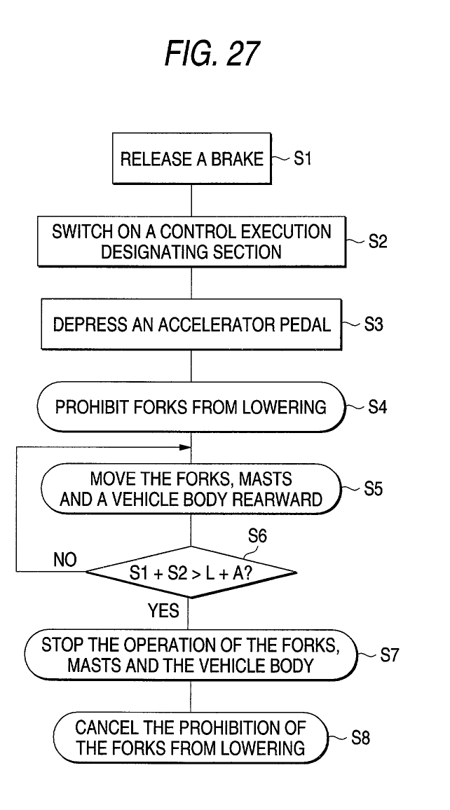

Furthermore, a third control operation will be described based on the flowchart shown in FIG. 27. In this control operation, having placed a cargo on the forks 716, the operator releases the brake (step 1), thereafter, switches on the control execution designating section 707 which is the switch for designating the execution of control to prohibit the forks 716 from lowering, and depresses the accelerator pedal (steps 2, 3). Then, an ON signal from the control execution designating section 707 enters the arithmetic processing unit 708b of the controller 708, which shifts its control to prohibit the forks 716 from lowering (step 4), and having confirmed that the accelerator pedal has been depressed, the arithmetic processing unit 708b outputs a signal for designating the start of the rearward movement of the forks 716 and the masts 717 to the reach unit 702 and a signal for designating the start of the rearward movement of the vehicle body 711 to the running system 705, whereby the vehicle body 711 start to move rearward at the same time as the forks 716 and the masts 717 start to move rearward (step 5).

Thereafter, the arithmetic processing unit 708b continues to prohibit the lowering movement of the forks 716 while determining whether or not the total rearward distance [S1+S2] calculated by adding the rearward distance S1 of the forks 716 and the masts 717 and the rearward distance S2 of the vehicle body 711 exceeds the set distance [L+A] set by adding the overall length L of the forks 716 and the extra distance A (step 6), and having determined that the total rearward distance [S1+S2] has exceeded the set distance [L+A], the arithmetic processing unit 708b outputs a signal for designating the stop of the rearward movement of the forks 716 and the masts 717 to the reach unit 702 and a signal for designating the stop of the rearward movement of the vehicle body 711 to the running system 705, respectively, whereby both the rearward movement of the forks 716 and the masts 717 and the rearward movement of the vehicle body 711 are stopped (step 7), while in the arithmetic processing unit 708b the control to prohibit the forks 716 from lowering is cancelled (step 8).

While in the first to third control operations, the control execution designating section 707 is described as being switched on manually, but the invention is not limited to the manually operated control execution designating section 707, and the lift height detecting section 703 may be used instead which is adapted to detect that the forks 716 are located at a vertical position which is as high as or higher than a certain height. Namely, in this construction, when the forks 716 start to move rearward while they are being located at a high lift position, with this fact, it is determined that a cargo loading or unloading operation has started, and the aforesaid control operations start automatically.

Furthermore, for example, it may be constructed such that the arithmetic processing unit 708b of the controller constitutes the control execution designating section 707 for automatically designating the execution of control to prohibit the forks 716 from lowering at a point in time where the forks 716 which are being located at a position as high as or higher than about 4 m start to move rearward together with the masts 717. Note that although not described in the description of the eighth embodiment, it may be constructed such that in the event that the operator tries to lower the forks 716 manually while the forks 716 are being prohibited from lowering, the alarm section 710 is used to alert the operator, and that when the prohibition of the lowering movement of the forks 716 is cancelled, the cancellation is informed to the operator through the information section 709, and if this construction is adopted, there is provided an advantage that misjudgment by the operator is difficult to occur.

Ninth Embodiment

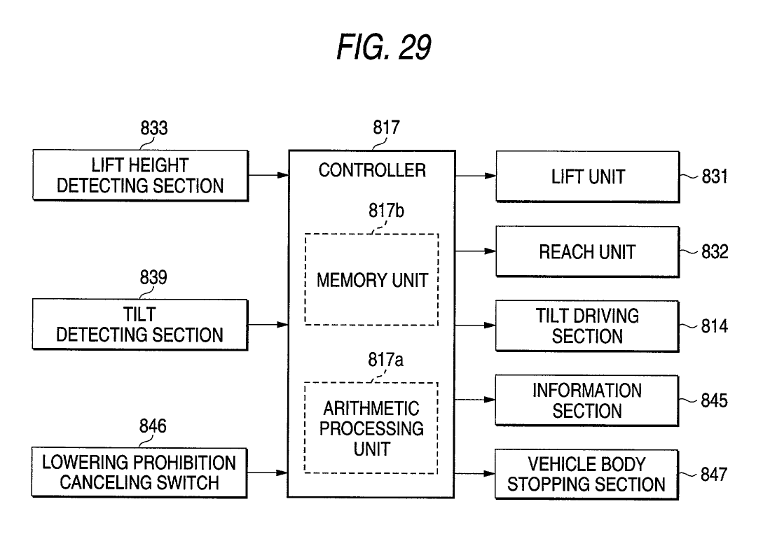

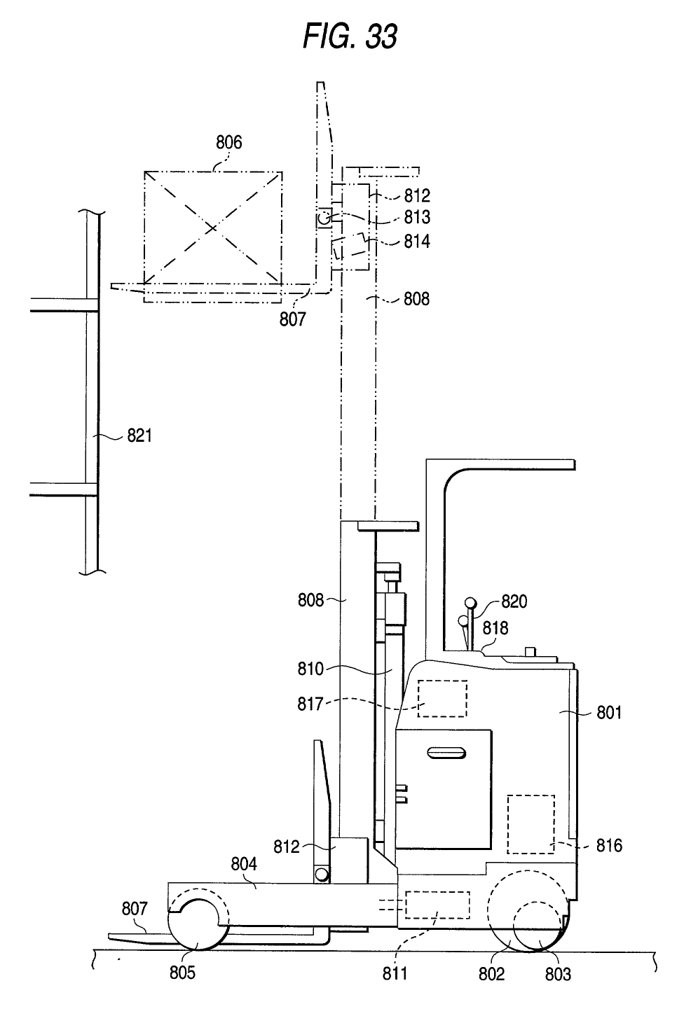

FIG. 29 is a block diagram showing a main part of a control system provided on a reach forklift truck according to a ninth embodiment of the invention. Note that since the overall construction of the reach forklift truck according to the ninth embodiment of the invention is similar to that of the conventional reach forklift truck described previously while referring to FIG. 33, the overall construction of the reach forklift truck of the ninth embodiment will be described while referring to FIG. 33.

In the reach forklift truck according to the ninth embodiment, drive tires 802 and caster tires 803 are disposed at a rear portion of a vehicle body 801, while a pair of straddle arms 804 are disposed at a front portion of the vehicle body 801 so as to extend horizontally forward therefrom. Load tires 805 are disposed at distal ends of the respective straddle arms 804, and masts 808 for guiding rising and lowering movements of forks 807 are provided at positions inside the respective straddle arms 804 so as to erect therefrom.

In addition, both the forks 807 and the masts 808 are constructed so as not only to be raised and lowered by a lift unit 831 having hydraulic cylinders 810 provided so as to erect along the masts 808, respectively, but also to be moved forward and rearward while being guided by the straddle arms 804 by a reach unit 832 having hydraulic cylinders 811 installed in the vehicle body 801.

The vertical position of the forks 807 when raised and lowered is constructed so as to be detected by a lift height detecting section 833 constituted by a reel type potentiometer or a magnet sensor.

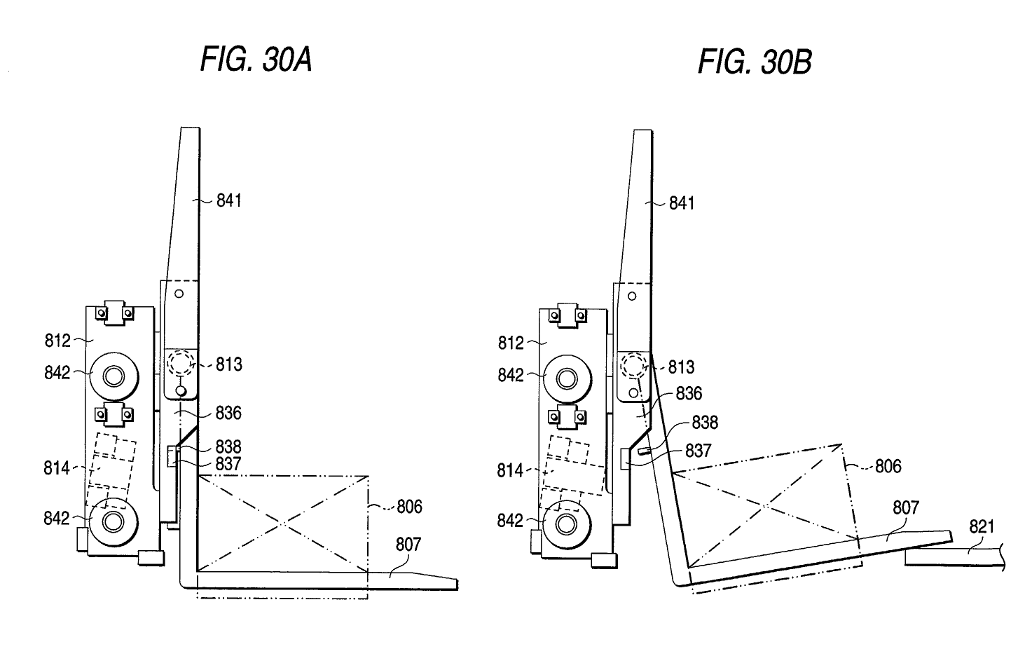

Furthermore, as shown in FIG. 30, the forks 807 are tiltably mounted via a support shaft 813 on a lift bracket 812 which is provided on the masts 808 vertically movably, and hydraulic cylinders 814 for tilting is fixed to the lift bracket 812. Moreover, tilt bars 836 are tiltably mounted on the support shaft 813 of the lift bracket 812 in such a manner that the tilt bars 836 are interposed between the forks 807 and the hydraulic cylinders 814, respectively, whereby the hydraulic cylinders 814, which are tilt driving section, pushes the forks 807 via the tilt bars 836 so that the forks 807 tilt.

Proximity sensors 837 for emitting and receiving light are provided on the tilt bars 836 which are mounted at ends of the support shaft 813, and reflecting pins 838 for reflecting light from the photo electric proximity sensors 837 are provided on sides of the forks 807 which face the lift bracket 812, respectively, the proximity sensors 837 and the reflecting pins 838 constituting a tilt detecting section 839 for detecting the tilt of the forks 807. In this ninth embodiment, the tilt detecting section 839 corresponds to a lowering movement detecting section for detecting whether or not the lowering movement of the forks are performed properly which is claimed under Claims of this specification.

Then, as shown in FIG. 30B, when the forks 807 are caught on a shelf of a rack 821 and abruptly tilt, since the reflecting pins 838 get out of light emitting and receiving ranges of the proximity sensor 837 in conjunction with the tilt of the forks, the light from the proximity sensors 837 is not reflected by the reflecting pins 838, and the reflecting light does not enter the proximity sensors 837, whereby it is detected that the forks 807 tilt through a predetermined angle or greater. In addition, when the hydraulic cylinders 814 which are the tilt driving section are driven, since the forks 807 tilt together with the tilt bars 34, there is no risk of the reflecting pins 838 getting out of the light emitting and receiving ranges, and therefore, the tilt detecting section 839 perform no tilt detection.

Note that in FIG. 30, reference numeral 841 denotes a backrest mounted at an upper portion of the lift bracket 812, and reference numeral 842 denotes guide rollers for guiding the lift bracket 812 together with the forks 807 along the masts 808.

Additionally, a running motor 816 is disposed in the interior of the vehicle body 801, and the drive tires 802 are driven by this running motor 816, in conjunction with which the vehicle body 801 is constructed so as not only to move forward and rearward but also to be turned.

Provided on a control panel 818 provided in the vicinity of an operator's seat are a plurality of operation levers 20, some of which are used for lifting up and down and tilting the forks 807, while the others are used for moving the masts 808 forward and backward, as well as an information section 845 such as lamp, buzzer, liquid crystal display and the like. Furthermore, provided on the control panel 818 is a manually operable lowering prohibition canceling switch 846 for canceling a lowering prohibiting function based the operation of an arithmetic processing unit 817a of a controller 817, which will be described later.

On the other hand, provided in a foot well in the vicinity of the operator's seat a brake pedal for stopping the running operation by a running system 805, an accelerator pedal for increasing the revolution of the running motor 816 (both the pedals being not shown), and a vehicle body stopping section 847 constituted by an electromagnetic brake or the like.

Moreover, a controller 817 is disposed in the interior of the vehicle body 801 which is constituted by a microcomputer and designed to control in a united fashion individual and coordinated operations of the various types of devices, and the controller 817 is configured so as to include the arithmetic processing unit 817a constituted by a CPU and a memory unit 801 comprising ROM or RAM for storing various types of data.

The arithmetic processing unit 817a is configured so as to provide a function as a lowering prohibiting section claimed under Claims of this specification. To make this happen, signal are inputted into this arithmetic processing unit 17 from the tilt detecting section 839, the lift height detecting section 833 and the lower prohibiting canceling switch 846, respectively. Additionally, signals are outputted from this arithmetic unit 817a to the lift unit 831, the reach device 832, the tilt driving section 814, the information section 815 and the vehicle body stopping section 847 for designating the operations of the respective devices and section.

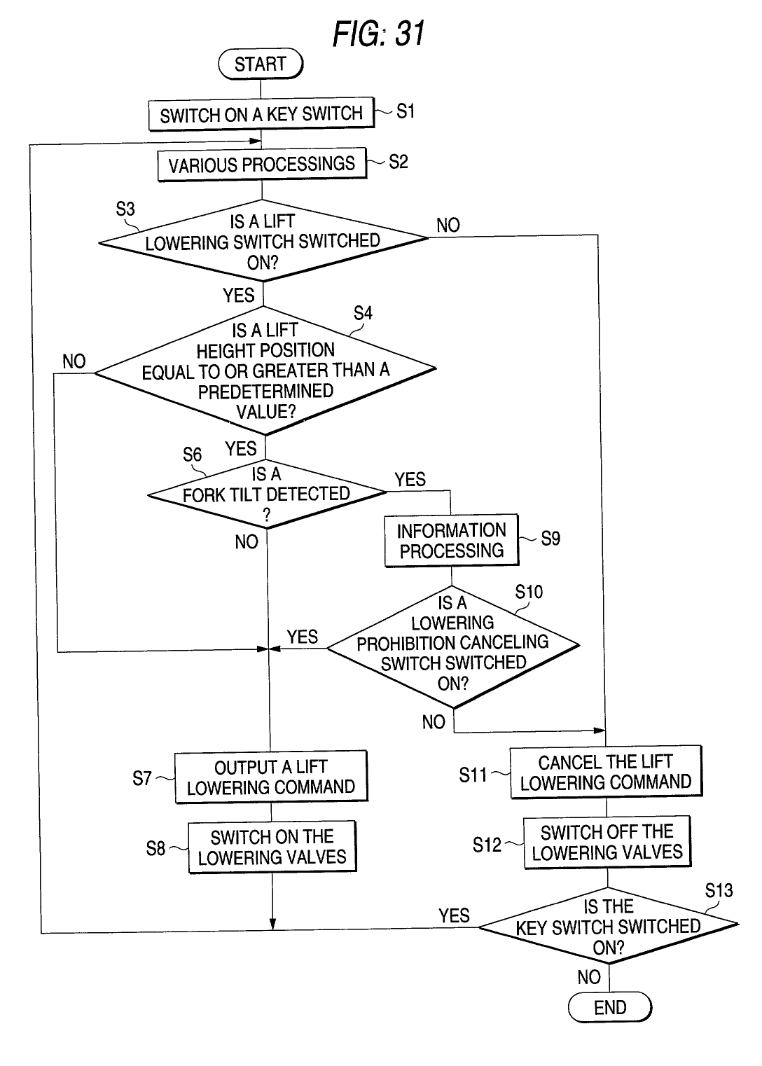

Next, referring to a flowchart shown in FIG. 31, control operations for cargo unloading work executed by the reach forklift truck according to the ninth embodiment of the invention will be described below. Note that S denotes respective steps.

First of all, after the operator of the reach forklift truck switches on to activate the forklift truck (S1), the controller 817 executes various types of operations and processing in response to commands from the operation levers 20 by so operating the levers (S2). Namely, when unloading a cargo, for example, the following operations and processing are carried out; after the vehicle body 801 is caused to approach a rack 821 by the running motor 816, the forks 807 are raised together with the masts 808 by the lift unit 831. Next, the forks 807 together with the masts 808 are caused to move forward by driving the reach unit 832 so that the forks 807 are inserted into a shelf of the rack 821, and following this, the forks 807 are caused to tilt by the tilt driving section 814 so that a cargo 806 is securely set on the forks 807 so inserted.

Next, the arithmetic processing unit 817a determines whether or not a lift lowering switch is turned on (S3). In a case where the operator operates the operation lever 820 for lowering the forks with a view to lowering the forks after the cargo 806 is set on the forks 807, since the lift lowering switch is switched on in response to the operation, the arithmetic processing unit 817a continues to take in detection outputs from the lift height detecting section 833 to thereby determine whether or not the lift height of the forks 807 is equal to or higher than a predetermined value (for example, 1.5 m) (S4).

If the lift height of the forks 807 is below the predetermined value, the arithmetic processing unit 817a determines that the operator can visually confirm whether or not the forks 807 have completely got out of the shelf of the rack 821 and outputs to the lift unit 831 a lift lowering command signal for lowering the forks 807 (S7). Lowering valves of the hydraulic cylinders 810 of the lift unit 831 are switched on (opened) in response to the output of the command signal (S8), and the forks 807 are lowered together with the masts 808.

On the other hand, in step 4, if the lift height of the forks 807 is equal to or greater than the predetermined value, the arithmetic processing unit 817a determines that the operator has difficulty in visually confirming whether or not the forks 807 have completely got out of the shelf of the rack 821, then takes in detection outputs from the tilt detecting section 839, and determines whether or not the forks 807 tilt through a predetermined angle or greater (S6). Note that, as previously described, since the operation of the tilt driving section 814 does not affect the detection by the tilt detecting section 839 of the tilt of the forks, the tilt detecting section 839 is constructed so as to output a detection signal only when an engagement of the forks 807 with the rack 821 occurs.

When it can confirm from detection outputs from the tilt detecting section 839 that the forks 837 do not tilt through the predetermined angle or greater, the arithmetic processing unit 817a determines that the forks 837 are not in contact with the rack 821 or the like and outputs to the lift unit 831 a lift lowering command signal for lowering the forks 807 (S7). This opens the lowering valves of the hydraulic cylinders 810 of the lift unit 831 (S8), whereby the forks 807 are lowered together with the masts 808.

On the contrary, when the arithmetic processing unit 817a determines, in step 6, that the forks 807 tilt through the predetermined angle or greater, since it is highly likely that the forks 807 are in contact with the rack 821 or the like, the arithmetic processing unit 817a activates the information section 845 to inform that the forks 807 are in an abnormal state and that further lowering of the forks causes a dangerous state with a blinking lamp or buzzing buzzer (S9).

Following this, the arithmetic processing unit 817a determines whether or not the lowering prohibition canceling switch 846 is switched on (S10). In the event that the lowering prohibition canceling switch 846 is turned on, this always section that the operator permits the lowering of the forks, and therefore, the flow then moves to step 7, where the forks 807 perform lowering movements together with the masts 808.

In contrast to this, in the event that the lowering prohibition canceling switch 846 is turned off, when the forks 807 are in the dangerous state, since this section that the execution of the prohibition of the lowering movement of the forks 807 is designated, the arithmetic processing unit 817a outputs, in response to this, a lift lowering command canceling signal for stopping the lowering movement of the forks 807 to the lift unit 831 even if the lift lowering switch is switched on in the previous step 3 (S11), whereby the lowering valves of the hydraulic cylinders 810 of the lift unit 831 are closed (S12), the forks 807 being prevented from lowering. As this occurs, the arithmetic processing unit 817a stops outputting driving pulses to the running motor 816 at the same time and activates the electro magnetic brake of the vehicle body stopping section 847 so as to stop the vehicle body 801 from moving forward and rearward. This improves further the safety of the forklift truck.

Next, whether or not the key switch continues to be switched on is determined (S13), and if it is determined that the key switch is switched off, the operation of the forklift truck is completed. On the contrary, if it is determined that the key switch continues to be switched on, then understanding that the operation of the forklift truck should continue, the flow returns to step 2.

In addition, in the event that the lift lowering switch is switched off in step 3, since the forks are not lowered, the flow shifts to the processes in and after step 11.

While the description has been made heretofore as to the controls and operations carried out when the cargo unloading work is performed using the reach forklift truck, controls and operations to be carried out when cargo loading work is performed with the same forklift truck are basically the same as those described above.

The following modifications and applications maybe made to the aforesaid ninth embodiment.

(1) While in the ninth embodiment, the case has been described where the invention is applied to the reach forklift truck, the invention is not limited to that application but may be applied to various types of forklift trucks such as counterbalance, picking and straddle forklift trucks.

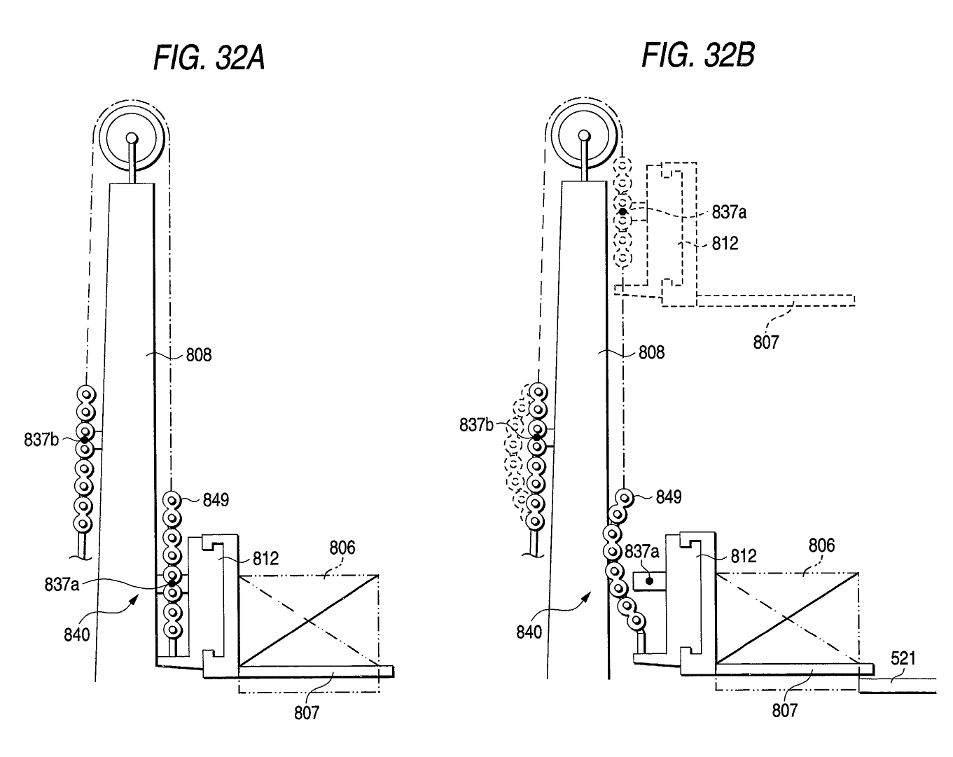

(2) In addition, in the ninth embodiment, the tilt detecting section 839 is constituted by the proximity sensors 837 which are provided on the tilt bars 836 and the reflecting pins 838 which are provided on the forks 807 due to the fact that the invention is applied to a forklift truck of a type such as a reach forklift truck in which the forks 807 are caused to tilt relative to the masts 808 by the tilt driving section. However, in a case where the invention is applied to a forklift truck of a type such as a counterbalance forklift truck in which the masts themselves are caused to tilt by the tilt driving section, for example, as shown in FIG. 32, a slack detecting section 840 for detecting the slack of chains 849 for suspending the forks 807 may be provided instead of the tilt detecting section 839. Note that in this case, the slack detecting section 840 corresponds to a lowering movement detecting section claimed under Claims of the specification.

In other words, photoelectric proximity sensors 837a, 837b functioning as the slack detecting section 840 are provided on the lift bracket 812 to which the brackets 7 are mounted and the masts 808, respectively, for detecting the existence of the chains for raising and lowering the lift bracket 812. Namely, as shown in FIG. 32A, the chains 849 are put in a tensioned state by the weights of the lift bracket 812 and the forks 807 and the proximity sensors 837a, 837b are detecting the existence of the chains 849. However, in the event that the forks 807 are hooked on the rack 821 or the like, as shown in FIG. 32B, the weights of the lift bracket 812 and the forks 807 are prevented from acting on the chains 49, which are then put in a slackened state, and therefore, the proximity sensors 837a, 837b cannot detect the existence of the chains 849. To be specific, when the forks are located at a lower position, as shown by solid lines in FIG. 32B, the proximity sensor 837a, which is one of the proximity sensors, cannot detect the existence of the chain 49, this indicating that the chain 49 gets slackened. On the contrary, when the forks 807 are located at an upper position, as shown by broken lines in FIG. 32B, the other proximity sensor 837b is prevented from detecting the existence of the chain 849, this indicating that the chain 849 gets slackened. Thus, when the slack of the chains 849 become aware, the arithmetic processing unit 817a functioning as the lowering prohibiting section prohibits the forks 807 from being lowered.

In addition, magnetic sensors for detecting the chains in normal position may be used in place of the proximity sensor 837a or 837b.

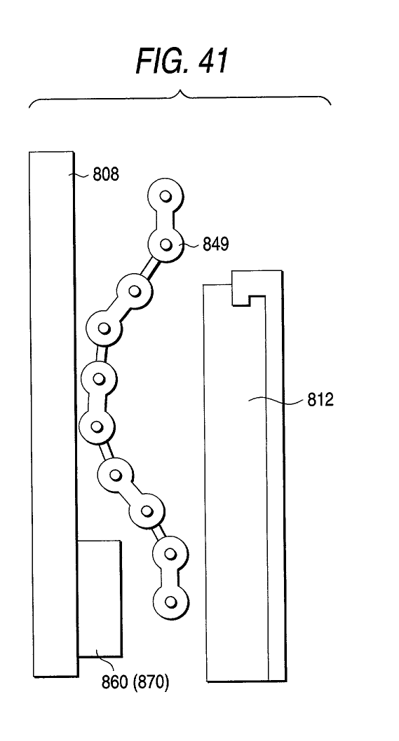

In addition, as shown in FIG. 41, infrared sensors 860 or super sonic sensors 870 may be used in place of the proximity sensor 837a or 837b. The infrared sensors emit infrared rays, and the super sonic sensors emit super sonic to detect the slack of the chains 849. Both sensors may be disposed on the masts 808.

Tenth Embodiment

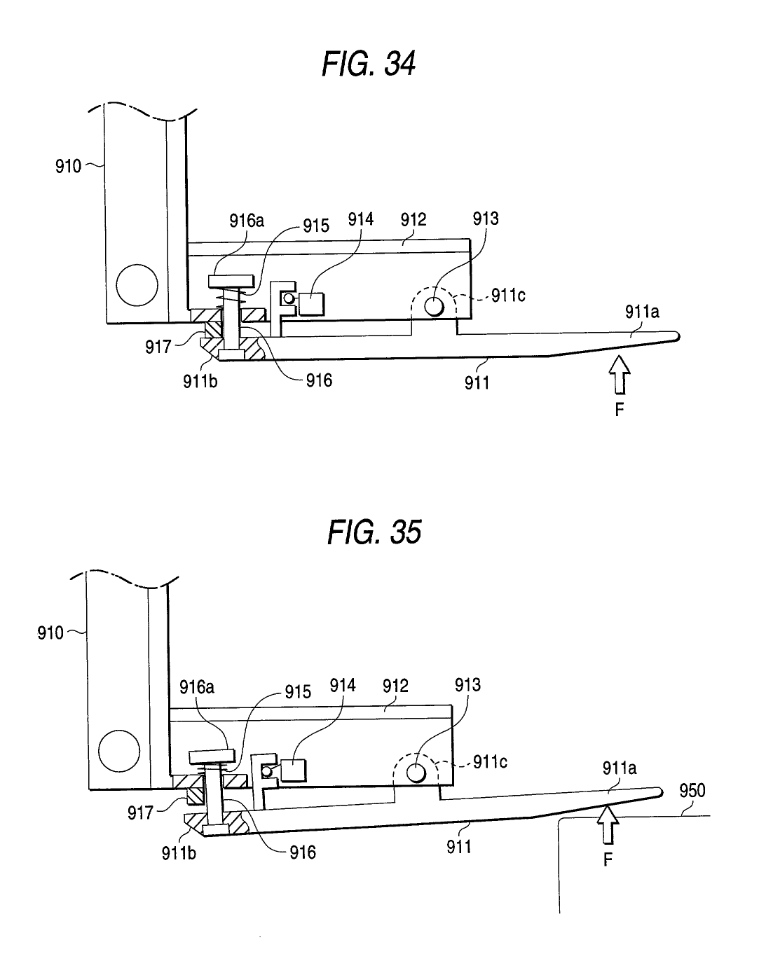

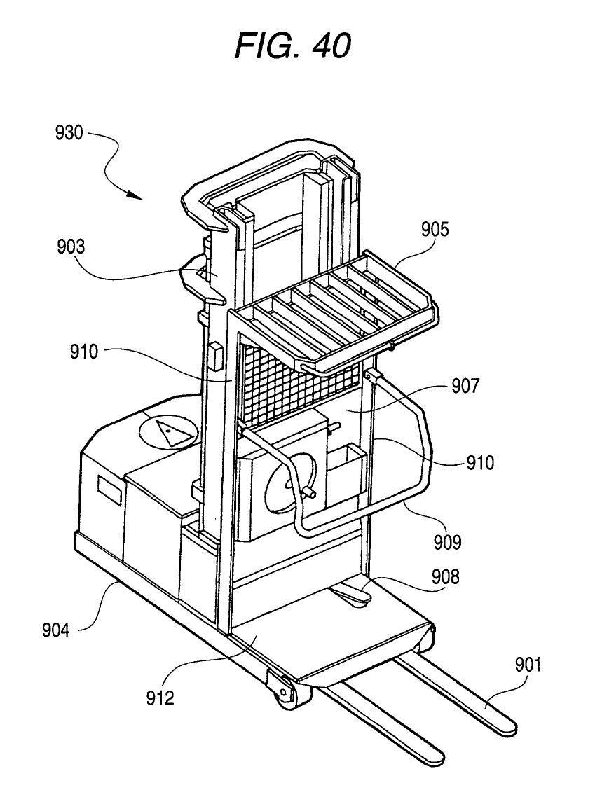

FIGS. 34 and 35 show a lift bracket 910 and forks 911 of a tenth embodiment of the invention. In this forklift truck, the lift bracket 910 is provided in such a manner as to be raised and lowered or lifted up and down along a mast 903 (refer to FIG. 40), and an operator's stand 912 is provided on the lift bracket 910. In addition, the horizontally extending forks 911 are provided at a lower portion of the operator's stand 912, and the forks 911 are mounted on the operator's stand 912 with pins 913 at intermediate positions between distal ends 911a and proximal ends 911b thereof in such a manner as to rotate in vertical directions by a minute amount.

In addition, a limit switch (sensor) 14 for detecting the rotation of the fork 911 when the distal end 911a of the fork 911 rotates in a direction in which the distal end 911a is lifted up by a minute amount is provided at the lower portion of the operator's stand 912 at a position confronting to the proximal end portion 911b of each of the forks 911. In addition, a spring 915 is provided at a position adjacent to the limit switch for biasing the proximal end 911b of the fork 911 in a direction in which the proximal end 911b is lifted up to thereby bias the distal end 911a of the fork 911 in a downward direction which is opposite to the direction in which the proximal end is lifted up. This spring 915 is interposed between an upper end flange 916a of a coupling member 916 for coupling the fork 911 to the operator's stand 912 in a state in which the proximal end 911b of the fork 911 is allowed to move vertically by a predetermined amount and the operator's stand 912. In addition, a stopper 917 is provided on a lower side of the operator's stand 912 at a position in the vicinity of where the spring 915 is disposed for preventing the proximal end 911b of the fork 911 from being lifted up more than required.

Additionally, a controller (not shown) is provided on the forklift truck as a movement control device. This controller prohibits the lift bracket 910 from lowering further when the limit switch 914 is switched on while the lift bracket 910 is in lowering motion. Furthermore, when the limit switch 914 is switched on, the controller can also prohibit the vehicle main body from running when the limit switch 914 is switched on.

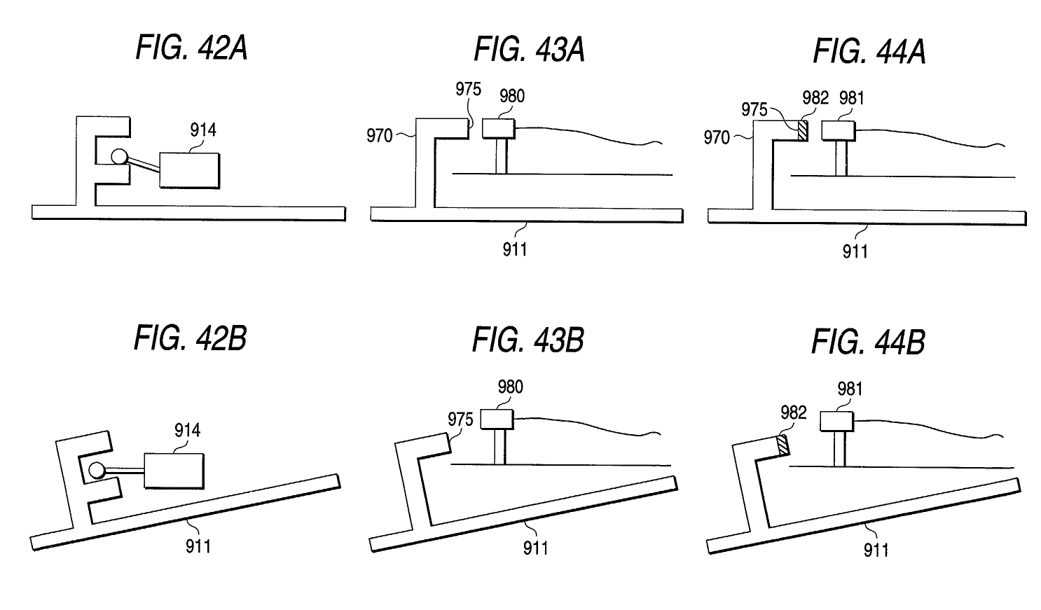

Next, an operation of the forklift truck will be described. In this forklift truck, while the lift bracket 910 or the forks 911 are being lowered, when an upward force F is applied to the distal end 911a of the fork 911, whereby the distal end 911a of the fork 911 is lifted up against the force of the spring 915, the limit switch 914 is switched on. Namely, as shown in FIG. 35, in the event that the fork 911 rides on a rack or a cargo 950 by a mistake in operation while the forks 911 are being lowered, since an upward force F which is as great as or greater than a predetermined magnitude is applied to the distal end 911a of the fork 911, the distal end 911a of the fork 911 is lifted up around the pin 913 as a fulcrum. Then, the limit switch 914 is switched on, and the controller 908 prohibits the lowering movement of the lift bracket 910 (also the running movement of the vehicle main body 904, as required) based on a signal outputted from the limit switch 914. In other words, the safe operation is activated. Here, FIG. 42A shows the limit switch 914 being switched off. FIG. 42B shows the limit switch 914 being switched on.

Consequently, the failure of the rack or the cargo 950 is minimized by automatically stopping the lowering movement of the forks 911. In addition, in the event that the vehicle main body 904 is run with the forks 911 riding on the rack or the cargo 950, there may be caused a risk of the rack or the cargo being damaged further or the forks 911 abruptly dropping immediately the forks 911 are separated from the rack or the cargo 950, however, since the running movement itself is prohibited at the sage in which the forks 911 ride on the rack or the cargo 950, the aforesaid risk can be eliminated, and a safe operation results. In particular, in a forklift truck such as that according to this tenth embodiment of the invention in which the operator's stand 912 is provided on the lift bracket 910, since the abrupt drop of the operator's stand 912 can be prevented, the safety can further be improved.

In addition, in order to cancel the state in which the lowering movement of the forks and running movement of the vehicle main body are prohibited, the state only has to be eliminated in which the forks 911 ride on a rack or a cargo. In other words, the lift bracket 910 is raised or lifted up at that position so as to remove the upward force F being applied to the distal ends 11a of the forks 911. Then, since the limit switches are switched off, the controller cancels the state in which the lowering movement of the lowering bracket 910 and the running movement of the vehicle main body 904 are prohibited. This cancellation of the prohibition state may of course be effected manually but a control program may be installed for automatic cancellation.

Additionally, in the case with the forklift truck according to the tenth embodiment of the invention, since the horizontally extending forks 911 are supported with the pins 913 at the intermediate positions 11c thereof, the forks 911 are constructed so as to rotate by a minute amount only when the distal ends 11a of the forks 911 are pushed upwardly with a force of a relatively small magnitude. Therefore, the aforesaid safe operation can be activated only when the forks 911 ride on the rack or the cargo 950.

Furthermore, when the forks 911 rotate against the force of the springs 915, the limit switches 914 are constructed so as to be activated, and therefore, the activating condition of the aforesaid safe operation can freely be changed by setting the force of the spring differently.

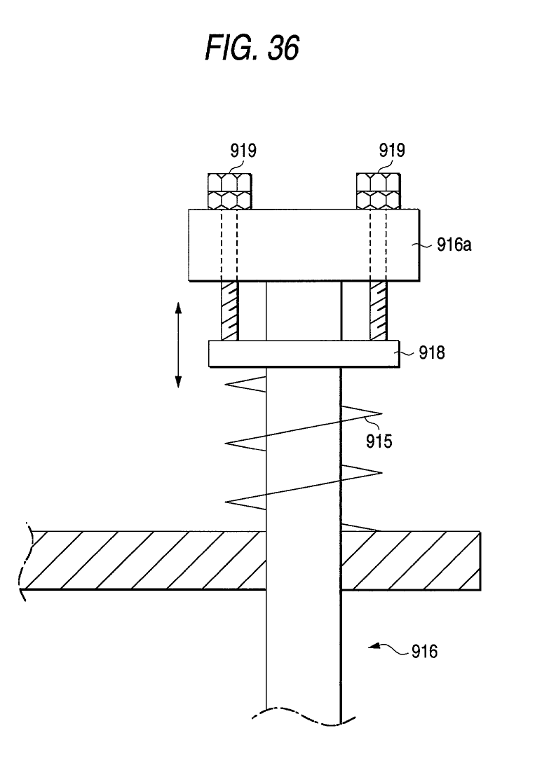

A construction for adjusting the biasing force of the spring 915 can take, for example, a construction illustrated in FIG. 36. Note that FIG. 36 is a schematic partial sectional view showing the construction of the part of the coupling member 916 in FIG. 34. In the construction illustrated in FIG. 36, an annular plate member 918 such as a washer is provided between the spring 915 and an upper end flange 16, and an adjusting bolt 919 is provided so as to be brought into abutment with the annular plate member 918, whereby a mounting gap for the spring 915 can be changed with the adjusting bolt 919. For example, the biasing force of the spring 915 can be strengthened by increasing the thread screwed amount of the adjusting bolt 919 to thereby move the annular plate member 918 axially downwardly of the coupling member 916 as viewed in FIG. 36. On the contrary, the biasing force of the spring 915 can be adjusted so as to be reduced by reducing the thread screwed amount of the adjusting bolt 919.

In addition, in place of the limit switch 914, any other switches may be used for detecting the distal end 911a of the fork 911 being lifted up against the force of the spring 915 when an upward force F is applied to the distal end 911a of the fork 911.

FIGS. 43A and 43B show an example in which a proximal switch 980 is used. In a normal condition, an end 975 of a branch 970 of the fork 911 faces to the proximal switch 980, as shown in FIG. 43A. When an upward force F is applied to the distal end 911a of the fork 911, the end 975 of the branch 970 gets away from the proximal switch 980 as shown in FIG. 43B. Then, the proximal switch 980 detects the upward force F applied to the distal end 911a of the forks 911, and outputs a signal to the controller 908. Then, the controller prohibits the lowering movement of the lift bracket 910 (also the running movement of the vehicle main body 904, as required) based on the signal outputted from the proximal switch 980.

FIGS. 44A and 44B show another example in which a magnet sensor 981 is used. A magnet 982 is disposed on the end 975 of the branch 970 of the fork 911, and in a normal condition, the magnet 982 faces to the magnet sensor 981, as shown in FIG. 44A. When an upward force F is applied to the distal end 911a of the fork 911, the magnet 982 gets away from the magnet sensor 981 as shown in FIG. 44B. Then, the magnet sensor 981 detects the upward force F applied to the distal end 911a of the fork 911, and outputs a signal to the controller 908. Then, the controller prohibits the lowering movement of the lift bracket 910 (also the running movement of the vehicle main body 904, as required) based on the signal outputted from the magnet sensor 981.

Eleventh Embodiment

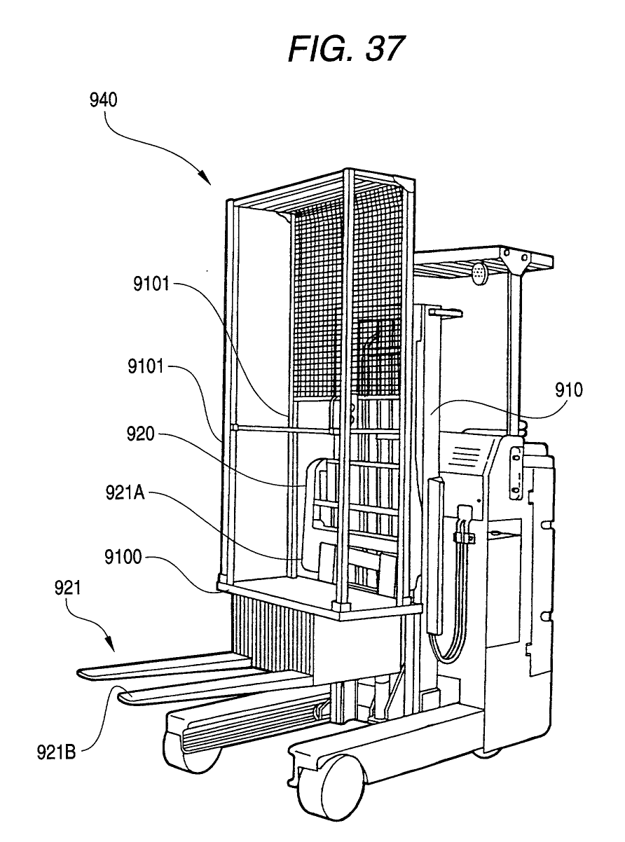

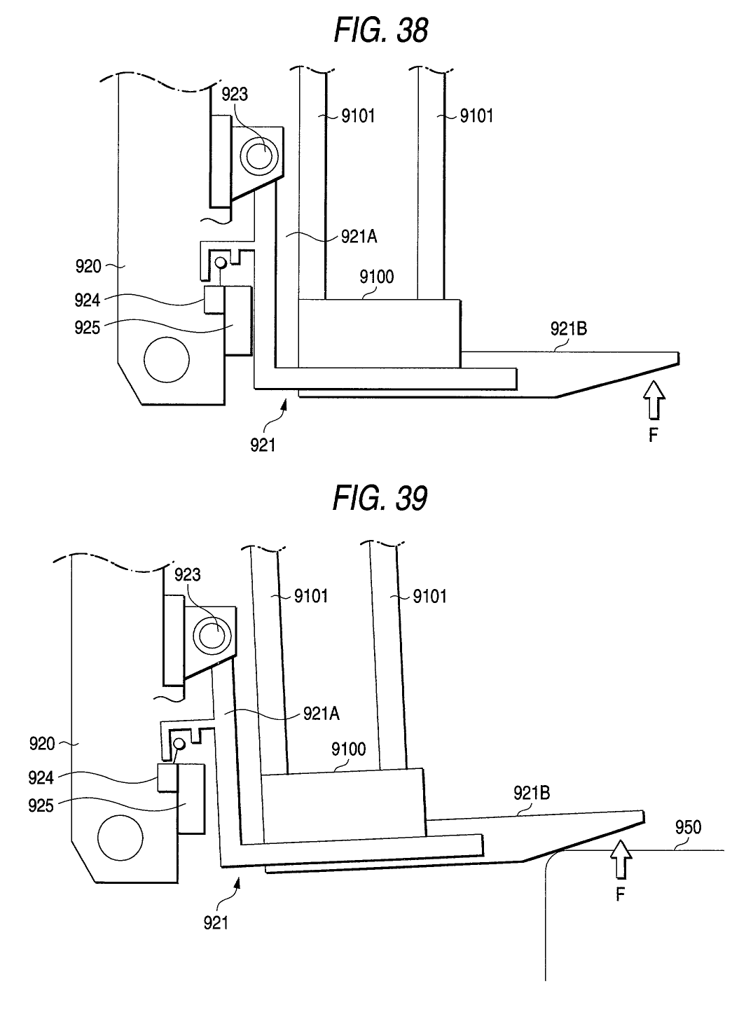

Next, an eleventh embodiment of the invention will be described. FIGS. 37 and 38 show a reach forklift truck 940 according to the eleventh embodiment of the invention, as well as its lift bracket 920 and forks 920. In this forklift truck 940, the lift bracket 920 is provided vertically movably along a lift unit 910, and the forks 921 are provided at a lower end of the lift bracket 920.

In this case, the forks 921 are each formed into an L-shape having a vertical portion 921A and a horizontal portion 921B, and the forks 921 are mounted on the lift bracket 920 with pins 923 at upper ends of the vertical portions 921A in such a manner as to rotate in vertical directions. An operator's stand 9100 on which an operator can ride is provided at proximal ends of the forks 921, and a cage frame 101 is provided so as to erect from four corners of the operator's stand 9100. In addition, bearing portions (tilt bars) 925 are provided for bearing an angular moment resulting from the deadweights of the forks 921 so as to hold the horizontal portions 921B of the forks 921 in a horizontal state, and limit switches 924 are mounted in such a manner as to output detection signals when the vertical portions 921A of the forks 921 are separated from the bearing portions 925.

In this eleventh embodiment, too, a controller 908 is provided with a function to prohibit the lift bracket 920 from lowering further when the limit switches are switched on while the lift bracket 920 is in lowering motion.

Next, an operation of the forklift truck of the eleventh embodiment will be described below.

In this forklift truck 940, as shown in FIG. 39, in the event that forks 921 ride on a rack or a cargo 950 when the lift bracket 920 or the forks 921 in lowering motion are mistakenly operated, an upward force F is applied to distal ends of the horizontal portions 921B of the forks 921, and the vertical portions 921A of the forks 921 are thereby separated from the bearing portions 924, when the limit switches 924 are switched on. Namely, in the event that the horizontal portions 921B of the forks 921 ride on the rack or the cargo 950 due to the mistake in operation while the forks 921 are in lowering motion, an upward force F which is as great as or greater than a predetermined magnitude is applied to the distal ends of the horizontal portions 921B of the forks 921, and therefore, the forks 921 rotate about the pins 923 functioning as fulcrums and the vertical portions 921A of the forks 921 are separated from the bearing portions 924. Then, the limit switches are switched on, and the controller prohibits the lift bracket 920 from lowering further in response to signals outputted from the sensors.

Consequently, in this eleventh embodiment, too, an advantage similar to that provided in the tenth embodiment can be provided. In addition, even when the state in which the lowering movement is prohibited is cancelled, the same operations as that performed in the tenth embodiment may only have to be performed.

In place of the limit switch 924, any other switches may be used for detecting the distal end of the fork 911 being lifted up against the force of the spring 915 when an upward force F is applied to the distal end 911a of the fork 911.

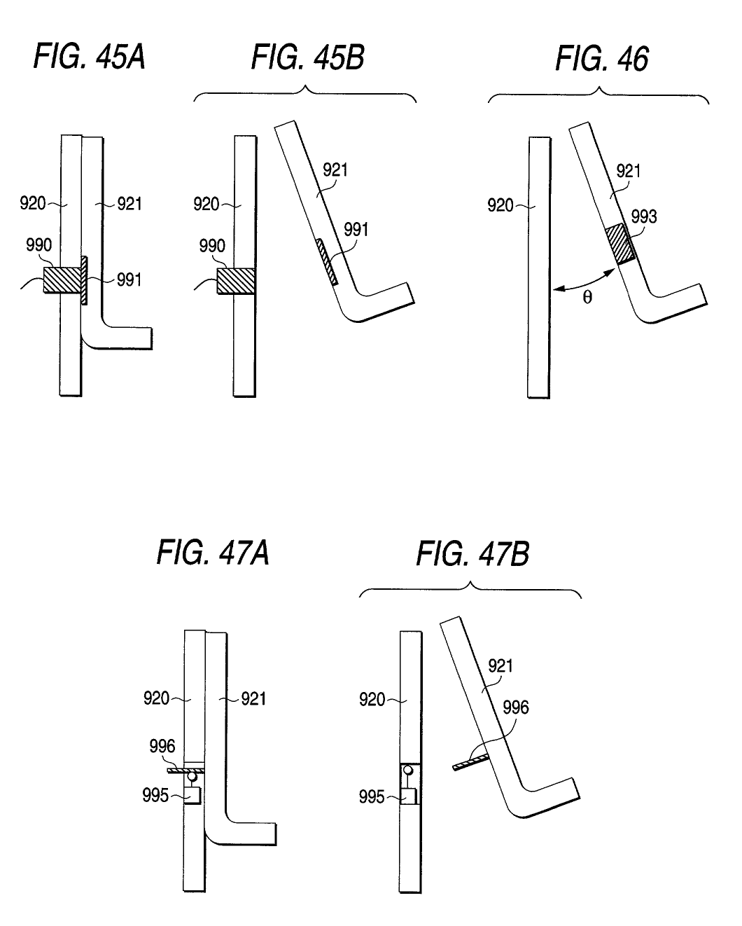

FIGS. 45A and 45B show an example in which a magnet sensor 990 is used. The magnet sensor 990 is disposed in the lift bracket 920 and a magnet 991 is disposed in the fork 921 to face to the magnet sensor 990 in a normal condition as shown in FIG. 45A. The magnet sensor 990 receives a magnetic force from the magnet 991 in the normal condition. When the force F is applied to the distal end of the fork 921, the magnet 991 is gotten away from the magnet sensor 990, as shown in FIG. 45B. Based on variation of the magnetic force received, the magnet sensor 990 detects the upward force F applied to the distal end of the fork 921, and outputs a signal to the controller 908. Then, the controller 908 prohibits the lowering movement of the lift bracket 920 (also the running movement of the vehicle main body 904, as required) based on the signal outputted from the magnet sensor 990.

In addition, as shown in FIG. 46 an inclination sensor 993 may be disposed in the fork 921 to detect the inclined angle of the fork 921 and output a signal containing the inclined angle of the fork 921. The controller 908 prohibits the lowering movement of the lift bracket 920 (also the running movement of the vehicle main body 904, as required) based on the signal outputted from the inclination sensor 993.

As shown in FIGS. 47A and 47B, another limit switch 995 maybe used. In a normal condition, a switch of the limit switch 995 is pressed down from an original position by a touch piece 996 attached to the fork 921 as shown in FIG. 47A. When the fork 921 is inclined by the applied force F, the touch piece 996 is gotten away from the switch of the limit switch 995 as shown in FIG. 47B. Then the switch of the limit switch 995 is returned to the original position, and detects the applied force F to the fork 921 as well as the other switches or sensors.

Note that in the aforesaid tenth and eleventh embodiments, the limit switches, magnet sensors, inclination switches and proximal switches are described as being provided as sensors for detecting the lift-up of the forks 911, 921, the invention is not limited to the utilization of these switches but any other sensors may be used provided that the sensors can detect that an upward force which is as great as or greater than a predetermined magnitude. In that case, the forks 911, 921 are not always required to be mounted rotatably with the pins 913, 923 or in such a manner as to be lifted up at the distal ends thereof.

As has been described heretofore, with the cargo handling vehicle according to the invention, the movement control to prohibit the lowering movement of the cargo carriers continues to be executed until the rearward distance which is covered by the vehicle main body which starts to move rearward in the state in which the vertical position of the raised cargo carriers exceeds the preset reference position becomes equal to or greater than the forward distance which is covered by the vehicle main body at the point in time of completion of the forward movement thereof. Due to this, the lowering movement of the forks is prohibited until the forks completely get out of the rack shelf in a loading or unloading operation, and as a result, in no case the forks which have started to lower come into contact with the rack shelf, thereby making it possible to securely and effectively prevent the occurrence of fall of the cargo from the cargo carriers.

As has been described heretofore, with the cargo handling vehicle according to the invention, the movement control to prohibit the lowering movement of the cargo carriers continues to be executed until the rearward distance which is being covered by the vehicle main body which starts to move forward after the cargo carriers start to rise and which starts to move rearward after it completes the forward movement becomes equal to or greater than the forward distance which is covered by the vehicle main body after the forward movement is completed. Due to this, the lowering movement of the forks is prohibited until the forks completely get out of the rack shelf in a loading or unloading operation, and as a result, in no case the forks which have started to lower come into contact with the rack shelf, thereby making it possible to securely and effectively prevent the occurrence of fall of the cargo from the cargo carriers.

As has been described heretofore, with the cargo handling vehicle according to the invention, the movement control to prohibit the lowering movement of the cargo carriers continues to be executed until the rearward distance which is being covered by the vehicle main body which has started to move rearward becomes equal to or greater than the forward distance which was covered by the vehicle main body in the state in which the vertical position of the raised cargo carriers exceeds the preset reference position, and in which the existence of the cargo on the cargo carriers is confirmed.

Due to this, the lowering movement of the cargo carriers continues to be prohibited until the cargo carriers completely get out of the rack shelf in a loading or unloading operation, and as a result, there is no risk of the cargo carriers which have started to lower being brought into contact with the rack shelf, an advantage being thereby provided that the occurrence of fall of a cargo from the cargo carriers can be prevented securely and effectively.

As has been described heretofore, with the cargo handling vehicle according to the invention, the control to prohibit the lowering movement of the cargo carriers continues to be executed until the rearward distance which is covered by the vehicle main body which starts to move forward after the cargo carriers are raised to a vertical position which is beyond a reference position and which starts to move rearward after the cargo carriers are raised and lowered within the preset upper and lower allowable limits becomes equal to or greater than the forward distance which is covered by the vehicle main body when the forward movement thereof is completed. Due to this, the lowering movement of the forks is prohibited until the forks completely get out of the rack shelf in a loading or unloading operation, and as a result, in no case the forks which have started to lower come into contact with the rack shelf, thereby making it possible to securely and effectively prevent the occurrence of fall of the cargo from the cargo carriers.

As has been described heretofore, with the cargo handling vehicle according to the invention, the control to prohibit the lowering movement of the cargo carriers continues to be executed until the rearward distance of the vehicle main body exceeds the set distance which is set by adding the surplus distance to the full length of the forks. Due to this, according to the invention, the lowering movement of the forks is prohibited until the forks get out of the rack shelf and reach a safety area where the surplus distance is secured, as a result of which there occurs in no case the contact between the forks which start to be lowered and the rack shelf, whereby an advantage can be provided that the fall of a cargo from the forks can securely be prevented.

As has been described heretofore, with the cargo handling vehicle according to the invention, since the control to prohibit the lowering movement of the cargo carriers continues to be executed until the rearward distance of the vehicle main body exceeds the set distance which is set by adding the surplus distance to the full length of the forks, the lowering movement of the forks is not started until the forks get out of the rack shelf and reach a safety area where the surplus distance is secured, as a result of which there occurs in no case the contact between the forks which start to be lowered and the rack shelf, whereby an advantage can be provided that the fall of a cargo from the forks can securely be prevented.

As has been described heretofore, with the cargo handling vehicle according to the invention, the lowering movement of the cargo carriers continues to be prohibited until the rearward distance of the vehicle main body exceeds the set distance which is set by adding the surplus distance to the full length of the forks, and the cargo carriers are allowed to be lowered at the point in time where the rearward distance of the vehicle main body exceeds the set distance. Consequently, the cargo carriers operated in loading or unloading work are allowed to be lowered without any delay after they get out of the rack shelf and reach a safety area, as a result of which there occurs in no case the contact between the forks which start to be lowered and the rack shelf or the fall of a cargo from the cargo carriers in association with the aforesaid contact, whereby an advantage can be provided that the occurrence of those inconveniences can be prevented securely and effectively.

As has been described heretofore, with the reach forklift truck according to the invention, the control is executed to prohibit the lowering movement of the forks 716 until the rearward distance of the forks and masts exceeds the set distance set by adding the overall length of the forks and the extra distance, or the total rearward distance calculated by adding the rearward distance of the forks and masts and the rearward distance of the vehicle body exceeds the set distance. Due to this, even when loading a cargo to a shelf of the rack located at a high lift height position or unloading the same cargo from the same rack shelf, the forks are prohibited from lowering until the forks get out of the rack completely to reach a safe place where the extra distance is secured, and as a result, there is caused no risk of the forks having started to lower coming into contact with the rack, whereby the occurrence of a risk of the cargo on the forks falling to pieces can be prevented assuredly and effectively.

With the cargo handling vehicle according to the invention, in the event that it is detected that the forks are being caused to tilt from a contact thereof with a foreign thing such as the rack, the control for prohibiting the lowering movement of the forks is executed. Due to this, when performing work in which a cargo is loaded to or unloaded from a shelf of the rack which is located a higher lift position, the forks are prohibited from being lowered until the forks have completely got out of the rack to reach a safe place where an extra distance is secured. As a result, a risk of the cargo falling to pieces can be prevented from occurring securely and effectively.

Thus, as has been described heretofore, according to the invention, since the safety operation is designed to be activated in which the lowering movement of at least the lift bracket is prohibited in the event that the cargo carriers ride on the rack or the cargo while the lift bracket is being lowered, and the sensors detect that the upward force which is as great as or greater than the predetermined magnitude is applied to the distal ends of the forks, not only can the failure of the rack or the cargo be minimized but also a risk can be eliminated that the cargo carriers abruptly drop immediately the cargo carriers are removed from the rack or the cargo, thereby making it possible to improve the safety.

According to the invention, since it is constructed to be determined that the cargo carriers ride on the rack or the cargo when the cargo carriers are lifted up by a minute amount against the deadweights thereof, the aforesaid safe operation can be activated as required with the simple construction in which the cargo carriers are mounted on the lift bracket in such a manner as to be lifted up by a minute magnitude relative to the lift bracket and the sensors are mounted for detecting the lift-up of the cargo carriers.

In addition, according to the invention, since the cargo carriers are mounted on the lift bracket with the pins in such a manner as to rotate in the vertical directions, the aforesaid safe operation can be activated only when the distal ends of the cargo carriers are caught on the rack or the cargo.

Moreover, according to the invention, since the horizontally extending cargo carriers are supported with the pins at the intermediate portions thereof, the aforesaid safe operation can be activated only when the cargo carriers ride on the rack or the cargo slightly.

Furthermore, according to the invention, since the limit switches are constructed so as to be switched on when the cargo carriers rotate against the force of the springs, the activating condition of the aforesaid safe operation can be changed by the way of setting the spring force.

In addition, according to the invention, since the mounting gap for the spring is designed to be changed, whereby the biasing force of the spring can be designed to be adjusted by changing the mounting gap, thereby making it possible to change the activating condition of the safe operation in any way without changing springs.

Moreover, according to the invention, since the lift bracket is designed to be prohibited from lowering when the sensors detect that the vertical portions of the L-shaped cargo carrier mounted rotatably with the pins are separated from the bearing portions located on the lift bracket side, the safe operation can be activated only when the distal ends of the horizontal portions of the cargo carriers ride on the rack or the cargo slightly.

What is claimed is:

1. A cargo handling vehicle comprising:
a cargo carrier for carrying a cargo thereon;
a lift unit for raising and/or lowering the cargo carrier;
a vehicle main body for moving the lift unit forward and backward;
a lift height detecting section for detecting the vertical position of the cargo carrier;
a traveling distance measuring section for measuring a forward distance moved by the vehicle main body;
a measurement start indication section for starting the measurement of the traveling distance measuring section when the lift unit moves in the forward direction after the height of the cargo carrier is not less than a predetermined height and the lift unit stops during a predetermined period; and
a movement control section for prohibiting the lowering movement of the cargo carrier until a rearward distance moved by the vehicle main body is not more than a predetermined value after the measurement start indication section starts the measurement.

2. The cargo handling vehicle as claimed in claim 1, wherein the traveling distance measuring section is an up-down counter for up-counting the forward distance moved by the lift unit, and down-counting the rearward distance moved thereby;
the traveling distance measuring section has a counter for indicating the traveling distance of the lift unit; and
the movement control section prohibits the lowering movement of the cargo carrier until the value of the counter is not more than 0.

3. The cargo handling vehicle as claimed in claim 1, wherein the movement control section allows lowering the cargo carrier by the lift unit within a predetermined range, and prohibits lowering the cargo carrier below the predetermined range.

4. A cargo handling vehicle comprising:
a cargo carrier for carrying a cargo thereon;
a lift unit for raising and/or lowering the cargo carrier;
a vehicle main body for moving the lift unit forward and backward;
a traveling distance measuring section for measuring a forward distance moved by the vehicle main body;
a measurement start indication section for starting the measurement of the traveling distance measuring section; and
a movement control section for prohibiting the lowering movement of the cargo carrier until the measured value of the traveling distance measuring section becomes an initial value after the measurement start indication section starts to operate.

5. The cargo handling vehicle as claimed in claim 4, wherein the traveling distance measuring section is an up-down counter for up-counting the forward distance moved by the lift unit, and down-counting the rearward distance moved thereby;
the traveling distance measuring section has a counter for indicating the traveling distance of the lift unit; and
the movement control section prohibits the lowering movement of the cargo carrier until the value of the counter is not more than 0.

6. The cargo handling vehicle as claimed in claim 4, wherein the movement control section allows lowering the cargo carrier by the lift unit within a predetermined range, and prohibits lowering the cargo carrier below the predetermined range.

7. The cargo handling vehicle as claimed in claim 4, wherein the movement control section forcibly stops lowering the cargo carrier.

8. A cargo handling vehicle comprising:
a cargo carrier for carrying a cargo thereon;
a lift unit for raising and/or lowering the cargo carrier;
a vehicle main body for moving the lift unit forward and backward;
a cargo detection section for detecting the cargo on the cargo carrier;
a lift height detecting section for detecting the vertical position of the cargo carrier;
a traveling distance measuring section for measuring a forward distance moved by the vehicle main body;
a measurement start indication section for starting the measurement of the traveling distance measuring section when the detection results of the cargo detection section is changed after the lift height detecting section detects that the height of the cargo carrier is not less than a predetermined height; and
a movement control section for prohibiting the lowering movement of the cargo carrier until the measured value of the traveling distance measuring section is not more than a predetermined value after the measurement start indication section starts the measurement.

9. The cargo handling vehicle as claimed in claim 8, wherein the movement control section allows lowering the cargo carrier by the lift unit within a predetermined range, and prohibits lowering the cargo carrier below the predetermined range.

10. The cargo handling vehicle as claimed in claim 8, wherein the movement control section forcibly stops lowering the cargo carrier.

11. A cargo handling vehicle comprising:
a cargo carrier for carrying a cargo thereon;
a lift unit for raising and/or lowering the cargo carrier;
a vehicle main body for moving the lift unit forward and backward;
a lift height detecting section for detecting the vertical position of the cargo carrier;
a traveling distance measuring section for measuring a forward distance moved by the vehicle main body;
a measurement start indication section for starting the measurement of the traveling distance measuring section when the lift unit moves in the forward direction not less than a predetermined distance after the height of the cargo carrier is not less than a predetermined height, and then the cargo carrier moves up and down with in a predetermined range, and then the lift unit starts to move backward; and
a movement control section for prohibiting the lowering movement of the cargo carrier until the measured value of the traveling distance measuring section is not more than a predetermined value after the measurement start indication section starts the measurement.

12. The cargo handling vehicle as claimed in claim 11, wherein the movement control section allows lowering the cargo carrier by the lift unit within the predetermined range, and prohibits lowering the cargo carrier below the predetermined range.

13. The cargo handling vehicle as claimed in claim 11, wherein the movement control section forcibly stops lowering the cargo carrier.

14. A cargo handling vehicle comprising:
a cargo carrier for carrying a cargo thereon;
a lift unit for raising and/or lowering the cargo carrier;
a vehicle main body for moving the lift unit forward and backward;
a cargo detection section for detecting the cargo on the cargo carrier;
a traveling distance measuring section for measuring a rearward distance of the lift unit moved by the vehicle main body;
a measurement start indication switch for starting the measurement of the traveling distance measuring section; and
a rearward movement control section for stopping the rearward movement of the vehicle main body when the measured value of the traveling distance measuring section reaches a predetermined value.

15. The cargo handling vehicle as claimed in claim 14, further comprising a movement control section for prohibiting lowering the cargo carrier by the lift unit until the measured value of the traveling distance measuring section reaches a predetermined value.

16. The cargo handling vehicle as claimed in claim 14, wherein the movement control section forcibly stops lowering the cargo carrier.

17. A cargo handling vehicle comprising:
a cargo carrier for carrying a cargo thereon;
a lift unit for raising and/or lowering the cargo carrier;
a vehicle main body for moving the lift unit forward and backward;
a cargo detection section for detecting the cargo on the cargo carrier;
a traveling distance measuring section for measuring a rearward distance of the lift unit moved by the vehicle main body;
a measurement start indication switch for starting the measurement of the traveling distance measuring section; and
an alarm section for put out an alarm when the measured value of the traveling distance measuring section reaches a predetermined value.

18. The cargo handling vehicle as claimed in claim 17, further comprising a movement control section for prohibiting lowering the cargo carrier by the lift unit until the measured value of the traveling distance measuring section reaches a predetermined value.

19. The cargo handling vehicle as claimed in claim 17, wherein the movement control section forcibly stops lowering the cargo carrier.

20. A cargo handling vehicle comprising:
a cargo carrier for carrying a cargo thereon;
a lift unit for raising and/or lowering the cargo carrier;
a vehicle main body for moving the lift unit forward and backward;
a cargo detection section for detecting the cargo on the cargo carrier;
a traveling distance measuring section for measuring a rearward distance of the lift unit moved by the vehicle main body;
a measurement start indication switch for starting the measurement of the traveling distance measuring section;
a rearward movement start section for automatically starting the lift unit to move backward by operating the measurement start indication switch; and
a rearward movement control section for stopping the rearward movement of the vehicle main body when the measured value of the traveling distance measuring section reaches a predetermined value.

21. The cargo handling vehicle as claimed in claim 20, further comprising a movement control section for prohibiting lowering the cargo carrier by the lift unit until the measured value of the traveling distance measuring section reaches a predetermined value.

22. The cargo handling vehicle as claimed in claim 20, wherein the movement control section forcibly stops lowering the cargo carrier.

23. A cargo handling vehicle comprising:
a cargo carrier for carrying a cargo thereon;
a lift unit for raising and/or lowering the cargo carrier;
a vehicle main body for moving the lift unit forward and backward;
a cargo detection section for detecting the cargo on the cargo carrier;
a traveling distance measuring section for measuring a rearward distance of the lift unit moved by the vehicle main body;
a measurement start indication switch for starting the measurement of the traveling distance measuring section;
a rearward movement start section for automatically starting the lift unit to move backward by operating the measurement start indication switch; and
an alarm section for put out an alarm when the measured value of the traveling distance measuring section reaches a predetermined value.

24. The cargo handling vehicle as claimed in claim 23, further comprising a movement control section for prohibiting lowering the cargo carrier by the lift unit until the measured value of the traveling distance measuring section reaches a predetermined value.

25. The cargo handling vehicle as claimed in claim 24, wherein the movement control section forcibly stops lowering the cargo carrier.

26. A cargo handling vehicle comprising:
a cargo carrier for carrying a cargo thereon;
a lift unit for raising and/or lowering the cargo carrier;
a vehicle main body for moving the lift unit forward and backward;
a traveling distance measuring section for measuring a rearward distance of the lift unit moved by the vehicle main body;
a measurement start indication switch for starting the measurement of the traveling distance measuring section;
a automatic lowering section for automatically lowering the cargo carrier by the lift unit when the measured value of the traveling distance measuring section reaches a predetermined value.

27. The cargo handling vehicle as claimed in claim 26, further comprising an operation lever for operating the lift unit to lift the cargo carrier up and down,
wherein the measurement start indication switch is provided on a knob of the operation lever.

28. The cargo handling vehicle as claimed in claim 26, wherein the vehicle main body is a forklift truck, and the cargo carrier is a fork supporting the cargo mounted on a pallet;
the lift unit comprises a mast for supporting the fork to be guided in the upper and lower directions, and a lift driving device for lifting the fork up and down along with the mast; and
the traveling distance measuring section is a measuring instrument for measuring the rearward distance that the forklift truck moves.

29. The cargo handling vehicle as claimed in claim 26, wherein the vehicle main body is a reach forklift truck, and the cargo carrier is a fork supporting the cargo mounted on a pallet;
the lift unit comprises a mast for supporting the fork to be guided in the upper and lower directions, and a lift driving device for lifting the fork up and down along with the mast;
the reach forklift truck comprises a straddle arm for supporting the mast to be guided in the forward and backward direction, and a reach drive unit for moving the mast in the forward and backward direction along with the straddle arm; and
the traveling distance measuring section is a measuring instrument for measuring the rearward distance of the mast along with the straddle arm.

30. A reach forklift truck comprising:
a mast;
a fork for carrying a cargo thereon;
a lift unit for raising and/or lowering the fork along with the mast;
a straddle arm;
a reach device moving the lift unit in the forward and rearward direction along with the straddle arm;
a vehicle main body having a tire for running the reach forklift truck;
a lift height detecting section for detecting the vertical position of the cargo carrier;
a lift unit traveling distance measuring section for measuring a forward distance of the lift unit moved by the reach device;
a measurement start indication switch for starting the measurement of the lift unit traveling distance measuring section; and
a movement control section for prohibiting the lowering movement of the cargo carrier until the measured value of the lift unit traveling distance measuring section is equal to or below a predetermined value when the height of the fork measured by the lift height detecting section is equal to or above a predetermined height.

31. The reach forklift truck as claimed in claim 30, wherein the movement control section allows lowering the cargo carrier by the lift unit within a predetermined range, and prohibits lowering the cargo carrier below the predetermined range.

32. A reach forklift truck comprising:
a mast;
a fork for carrying a cargo thereon;
a lift unit for raising and/or lowering the fork along with the mast;
a straddle arm;
a reach device moving the lift unit in the forward and rearward direction along with the straddle arm;
a vehicle main body having a tire for running the reach forklift truck;
a lift unit traveling distance measuring section for measuring a forward distance of the lift unit moved by the reach device;
a vehicle body traveling distance measuring section for measuring a forward distance of the vehicle main body moved;
a measurement start indication switch for starting the measurement of the lift unit traveling distance measuring section and the vehicle body traveling distance measuring section;
an adder for adding the measured distances of the lift unit raveling distance measuring section and the vehicle body traveling distance measuring section to output an added value; and
a movement control section for prohibiting the lowering movement of the cargo carrier until the added value of the lift unit traveling distance measuring section and the vehicle body traveling distance measuring section is equal to or below a predetermined value.

33. The reach forklift truck as claimed in claim 32, further comprising:
a lowering start indication section for controlling the lift unit to automatically lower the fork when the added value thereof is not more than the predetermined value; and
a lowering reservation switch for operating the lowering start indication section.

34. The reach forklift truck as claimed in claim 32, further comprising a vehicle automatic stop section for automatically stopping the rearward movement of the vehicle main body when the added value thereof is not more than the predetermined value.

35. A reach forklift truck comprising:
a mast;
a fork for carrying a cargo thereon;
a lift unit for raising and/or lowering the fork along with the mast;
a straddle arm;
a reach device moving the lift unit in the forward and rearward direction along with the straddle arm;
a vehicle main body having a tire for running the reach forklift truck;
a lift height detecting section for detecting the vertical position of the cargo carrier;
a lift unit traveling distance measuring section for measuring a forward distance of the lift unit moved by the reach device;
a vehicle body traveling distance measuring section for measuring a forward distance of the vehicle main body moved;
an adder for adding the measured distances of the lift unit traveling distance measuring section and the vehicle body traveling distance measuring section to output an added value;
a measurement start indication section for starting the measurement of the lift unit traveling distance measuring section and the vehicle body traveling distance measuring section when the lift unit starts to move backward after the reach device moves the lift unit forward under the condition that the height of the fork measured by the lift height detecting section is equal to or above the a predetermined height; and
a movement control section for prohibiting the lowering movement of the cargo carrier until the added value of the lift unit traveling distance measuring section and the vehicle body traveling distance measuring section is equal to or below a predetermined value.

36. The reach forklift truck as claimed in claim 35, further comprising:
a lowering start indication section for controlling the lift unit to automatically lower the fork when the added value thereof is not more than the predetermined value; and
a lowering reservation switch for operating the lowering start indication section.

37. The reach forklift truck as claimed in claim 35, further comprising a vehicle automatic stop section for automatically stopping the rearward movement of the vehicle main body when the added value thereof is not more than the predetermined value.

38. A forklift truck comprising:
a fork for carrying a cargo thereon;
a mast inclinably supporting the fork;
a lift unit for raising and/or lowering the fork;
a vehicle main body for moving the lift unit forward and backward;
an inclination detection unit for detecting an inclination of the fork; and
a lowering prohibiting section for prohibiting the lowering movement of the fork by the lift unit if the inclination detection unit detects the fork inclined more than a predetermined angle.

39. The forklift truck as claimed in claim 38, further comprising a lift height detecting section for detecting the vertical position of the cargo carrier,
wherein the lowering prohibiting section prohibits the lowering movement of the fork if the height of the fork is equal to or above a predetermined height.

40. The forklift truck as claimed in claim 38, further comprising a vehicle body stop section for stopping the forward or backward movement if the inclination detection unit detects the fork inclined more than the predetermined angle.
